(19) United States
(12) Patent Application Publication
(10) Pub. No.: US 2018/0048178 A1
(43) Pub. Date: Feb. 15, 2018

(54) SYSTEM AND METHODS OF USING ELECTROMAGNETIC WAVES TO WIRELESSLY DELIVER POWER TO ELECTRONIC DEVICES

(71) Applicant: Energous Corporation, San Jose, CA (US)

(72) Inventor: Michael A. Leabman, Pleasanton, CA (US)

(21) Appl. No.: 15/725,236

(22) Filed: Oct. 4, 2017

Related U.S. Application Data
(63) Continuation-in-part of application No. 13/926,055, filed on Jun. 25, 2013.
Application No. 13/926,055 is a continuation-in-part of application No. 14/585,506, filed on Dec. 30, 2014.
Application No. 14/585,506 is a continuation-in-part of application No. 13/926,055, filed on Jun. 25, 2013.
Application No. 13/926,055 is a continuation-in-part of application No. 14/585,387, filed on Dec. 30, 2014.
Application No. 14/585,387 is a continuation-in-part of application No. 13/939,506, filed on Jul. 11, 2013, now abandoned.
Application No. 13/939,506 is a continuation-in-part of application No. 14/585,370, filed on Dec. 30, 2014.
Application No. 14/585,370 is a continuation-in-part of application No. 13/939,655, filed on Jul. 11, 2013, now Pat. No. 9,130,397.
Application No. 13/939,655 is a continuation-in-part of application No. 14/732,140, filed on Jun. 5, 2015.
Application No. 14/732,140 is a continuation of application No. 13/939,655, filed on Jul. 11, 2013, now Pat. No. 9,130,397.
Application No. 13/939,655 is a continuation-in-part of application No. 14/585,324, filed on Dec. 30, 2014.
Application No. 14/585,324 is a continuation-in-part of application No. 13/946,128, filed on Jul. 19, 2013, now abandoned.
Application No. 13/946,128 is a continuation-in-part of application No. 14/585,362, filed on Dec. 30, 2014, now abandoned.
Application No. 14/585,362 is a continuation-in-part of application No. 13/950,536, filed on Jul. 25, 2013, now abandoned.
Application No. 13/950,536 is a continuation-in-part of application No. 14/586,137, filed on Dec. 30, 2014.
Application No. 14/586,137 is a continuation-in-part of application No. 14/026,747, filed on Sep. 13, 2013, now abandoned.
Application No. 14/026,747 is a continuation-in-part of application No. 14/586,266, filed on Dec. 30, 2014, now abandoned.
Application No. 14/586,266 is a continuation-in-part of application No. 14/026,852, filed on Sep. 13, 2013, now abandoned.
Application No. 14/026,852 is a continuation-in-part of application No. 14/586,539, filed on Dec. 30, 2014.
Application No. 14/586,539 is a continuation-in-part of application No. 14/027,446, filed on Sep. 16, 2013, now abandoned.
Application No. 14/027,446 is a continuation-in-part of application No. 14/586,603, filed on Dec. 30, 2014.
Application No. 14/586,603 is a continuation-in-part of application No. 14/027,468, filed on Sep. 16, 2013, now abandoned.
Application No. 14/027,468 is a continuation-in-part of application No. 14/051,054, filed on Oct. 10, 2013, now Pat. No. 9,824,815.
Application No. 14/051,054 is a continuation-in-part of application No. 14/586,160, filed on Dec. 30, 2014, now Pat. No. 9,847,677.
Application No. 14/586,160 is a continuation-in-part of application No. 14/051,054, filed on Oct. 10, 2013, now Pat. No. 9,824,815.
Application No. 14/051,054 is a continuation-in-part of application No. 14/585,797, filed on Dec. 30, 2014.
Application No. 14/585,797 is a continuation-in-part of application No. 14/051,128, filed on Oct. 10, 2013, now abandoned.
Application No. 14/051,128 is a continuation-in-part of application No. 14/585,844, filed on Dec. 30, 2014.
Application No. 14/585,844 is a continuation-in-part of application No. 14/051,170, filed on Oct. 10, 2013, now abandoned.
Application No. 14/051,170 is a continuation-in-part of application No. 14/069,983, filed on Nov. 1, 2013.
Application No. 14/069,983 is a continuation-in-part of application No. 14/586,197, filed on Dec. 30, 2014.
Application No. 14/586,197 is a continuation-in-part of application No. 14/069,983, filed on Nov. 1, 2013.
Application No. 14/069,983 is a continuation-in-part of application No. 14/586,243, filed on Dec. 30, 2014.
Application No. 14/586,243 is a continuation-in-part of application No. 14/095,358, filed on Dec. 3, 2013, now abandoned.
Application No. 14/095,358 is a continuation-in-part of application No. 14/586,370, filed on Dec. 30, 2014, now abandoned.
Application No. 14/586,370 is a continuation-in-part of application No. 14/103,528, filed on Dec. 11, 2013, now abandoned.
Application No. 14/103,528 is a continuation-in-part of application No. 14/586,400, filed on Dec. 30, 2014.
Application No. 14/586,400 is a continuation-in-part of application No. 14/104,503, filed on Dec. 12, 2013, now Pat. No. 9,252,628.
Application No. 14/104,503 is a continuation-in-part of application No. 15/010,127, filed on Jan. 29, 2016, now Pat. No. 9,847,669.
Application No. 15/010,127 is a continuation of application No. 14/104,503, filed on Dec. 12, 2013, now Pat. No. 9,252,628.
Application No. 14/104,503 is a continuation-in-part of application No. 15/181,242, filed on Jun. 13, 2016.
Application No. 15/181,242 is a continuation of application No. 14/586,448, filed on Dec. 30, 2014, now Pat. No. 9,368,020.
Application No. 14/586,448 is a continuation-in-part of application No. 14/330,926, filed on Jul. 14, 2014, now abandoned.
Application No. 14/330,926 is a continuation-in-part of application No. 14/585,585, filed on Dec. 30, 2014, now abandoned.
Application No. 14/585,585 is a continuation-in-part of application No. 13/950,492, filed on Jul. 25, 2013, now Pat. No. 9,831,718.
Application No. 13/950,492 is a continuation-in-part of application No. 14/584,752, filed on Dec. 29, 2014.
Application No. 14/584,752 is a continuation-in-part of application No. 13/950,492, filed on Jul. 25, 2013, now Pat. No. 9,831,718.
Application No. 13/950,492 is a continuation-in-part of application No. 14/584,800, filed on Dec. 29, 2014, now Pat. No. 9,859,757.
Application No. 14/584,800 is a continuation-in-part of application No. 13/950,492, filed on Jul. 25, 2013, now Pat. No. 9,831,718.
Application No. 13/950,492 is a continuation-in-part of application No. 14/587,294, filed on Dec. 31, 2014.
Application No. 14/587,294 is a continuation-in-part of application No. 14/587,308, filed on Dec. 31, 2014.
Application No. 14/587,308 is a continuation-in-part of application No. 14/069,934, filed on Nov. 1, 2013.
Application No. 14/069,934 is a continuation-in-part of application No. 14/585,484, filed on Dec. 30, 2014.
Application No. 14/585,484 is a continuation-in-part of application No. 13/926,055, filed on Jun. 25, 2013.
(60) Provisional application No. 61/978,031, filed on Apr. 10, 2014.
(60) Provisional application No. 61/978,031, filed on Apr. 10, 2014.
(60) Provisional application No. 61/978,031, filed on Apr. 10, 2014.
(60) Provisional application No. 61/978,031, filed on Apr. 10, 2014.
(60) Provisional application No. 61/978,301, filed on Apr. 11, 2014.
(60) Provisional application No. 61/978,031, filed on Apr. 10, 2014.
(60) Provisional application No. 61/978,031, filed on Apr. 10, 2014.
(60) Provisional application No. 61/978,031, filed on Apr. 10, 2014.
(60) Provisional application No. 61/978,031, filed on Apr. 10, 2014.

(51) Int. Cl. H02J 7/02; H02J 50/40; H04B 5/00; H02J 5/00; H04B 3/54; H04B 1/04; H02J 50/23

(52) U.S. Cl. CPC H02J 7/025; H02J 50/23; H02J 50/40; H04B 5/0037; H04B 3/54; H04B 1/04; H02J 5/005

(57) ABSTRACT

Wireless charging systems, and methods of use thereof, are disclosed herein. As an example, a method includes: (i) receiving, by a communications radio of a wireless power transmitter, a communication signal from a communications radio of a wireless power receiver, the communication signal including data used to determine a location of the wireless power receiver, and (ii) determining a location of the wireless power receiver based, at least in part, on the data included in the communication signal. The method further includes, in response to determining that the location of the wireless power receiver is within a wireless power transmission range defined by the transmitter, transmitting radio frequency (RF) power transmission waves towards the wireless power receiver, the RF power transmission waves converging to form controlled constructive interference patterns and destructive interference patterns in proximity to the location of the wireless power receiver.

### RELATED APPLICATIONS

This application is a continuation-in-part of the following applications: U.S. patent application Ser. No. 13/926,055, filed Jun. 25, 2013; U.S. patent application Ser. No. 14/585,484, filed Dec. 30, 2014, which is a continuation-in-part of U.S. patent application Ser. No. 13/926,055, filed Jun. 25, 2013; U.S. patent application Ser. No. 14/585,506, filed Dec. 30, 2014, which is a continuation-in-part of U.S. patent application Ser. No. 13/926,055, filed Jun. 25, 2013; U.S. patent application Ser. No. 14/585,387, filed Dec. 30, 2014, which is a continuation-in-part of U.S. patent application Ser. No. 13/939,506, filed on Jul. 11, 2013; U.S. patent application Ser. No. 14/585,370, filed Dec. 30, 2014, which is a continuation-in-part of U.S. patent application Ser. No. 13/939,655, filed on Jul. 11, 2013; U.S. patent application Ser. No. 14/732,140, filed Jun. 5, 2015, which is a continuation of U.S. patent application Ser. No. 13/939,655, filed Jul. 11, 2014; U.S. patent application Ser. No. 14/585,324, filed Dec. 30, 2014, which is a continuation-in-part of U.S. patent application Ser. No. 13/946,128, filed on Jul. 19, 2013; U.S. patent application Ser. No. 14/585,362, filed Dec. 30, 2014, which is a continuation-in-part of U.S. patent application Ser. No. 13/950,536, filed on Jul. 25, 2013; U.S. patent application Ser. No. 14/586,137, filed Dec. 30, 2014, which is a continuation-in-part of U.S. patent application Ser. No. 14/026,747, filed on Sep. 13, 2013; U.S. patent application Ser. No. 14/586,266, filed Dec. 30, 2014, which is a continuation-in-part of U.S. patent application Ser. No. 14/026,852, filed on Sep. 13, 2013; U.S. patent application Ser. No. 14/586,539, filed Dec. 30, 2014, which is a continuation-in-part of U.S. patent application Ser. No. 14/027,446, filed on Sep. 16, 2013; U.S. patent application Ser. No. 14/586,603, filed Dec. 30, 2014, which is a continuation-in-part of U.S. patent application Ser. No. 14/027,468, filed on Sep. 16, 2013; U.S. patent application Ser. No. 14/051,054, filed Oct. 10, 2013; U.S. patent application Ser. No. 14/586,160, filed Dec. 30, 2014, which is a continuation-in-part of U.S. patent application Ser. No. 14/051,054, filed Oct. 10, 2013; U.S. patent application Ser. No. 14/585,797, filed Dec. 30, 2014, which claims priority to U.S. Patent Provisional Application No. 61/978,031, filed on Apr. 10, 2014, and is a continuation-in-part of U.S. patent application Ser. No. 14/051,128, filed on Oct. 10, 2013; U.S. patent application Ser. No. 14/585,844, filed Dec. 30, 2014, which claims priority to U.S. Patent Provisional Application No. 61/978,031, filed on Apr. 10, 2014, and is a continuation-in-part of U.S. patent application Ser. No. 14/051,170, filed on Oct. 10, 2013; U.S. patent application Ser. No. 14/069,983, filed Nov. 1, 2013; U.S. patent application Ser. No. 14/586,197, filed Dec. 30, 2014, which is a continuation-in-part of U.S. patent application Ser. No. 14/069,983, filed Nov. 1, 2013; U.S. patent application Ser. No. 14/586,243, filed Dec. 30, 2014, which is a continuation-in-part of U.S. patent application Ser. No. 14/095,358, filed Dec. 3, 2013; U.S. patent application Ser. No. 14/586,370, filed Dec. 30, 2014, which claims priority to U.S. Patent Provisional Application No. 61/978,031, filed on Apr. 10, 2014, and is a continuation-in-part of U.S. patent application Ser. No. 14/103,528, filed on Dec. 11, 2013; U.S. patent application Ser. No. 14/586,400, filed Dec. 30, 2014, which claims priority to U.S. Patent Provisional Application No. 61/978,031, filed on Apr. 10, 2014, and is a continuation-in-part of U.S. patent application Ser. No. 14/104,503, filed on Dec. 12, 2013; U.S. patent application Ser. No. 15/010,127, filed Jan. 29, 2016, which is a continuation of U.S. patent application Ser. No. 14/104,503, filed on Dec. 12, 2013; U.S. patent application Ser. No. 15/181,242, filed Jun. 13, 2016, which is a continuation of U.S. patent application Ser. No. 14/586,448, filed Dec. 30, 2014, which is a continuation-in-part of U.S. patent application Ser. No. 14/330,926, filed on Jul. 14, 2014; U.S. patent application Ser. No. 14/585,585, filed Dec. 30, 2014, which claims priority to U.S. Patent Provisional Application No. 61/978,031, filed on Apr. 10, 2014, and is a continuation-in-part of U.S. patent application Ser. No. 13/950,492, filed on Jul. 25, 2013; U.S. patent application Ser. No. 14/584,752, filed Dec. 29, 2014, which claims priority to U.S. Patent Provisional Application No. 61/978,031, filed on Apr. 10, 2014, and is a continuation-in-part of U.S. patent application Ser. No. 13/950,492, filed on Jul. 25, 2013; U.S. patent application Ser. No. 14/584,800, filed Dec. 29, 2014, which claims priority to U.S. Patent Provisional Application No. 61/978,031, filed on Apr. 10, 2014, and is a continuation-in-part of U.S. patent application Ser. No. 13/950,492, filed on Jul. 25, 2013; U.S. patent application Ser. No. 14/587,294, filed Dec. 31, 2014, which claims priority to U.S. Patent Provisional Application No. 61/978,031, filed on Apr. 10, 2014; U.S. patent application Ser. No. 14/587,308, filed Dec. 31, 2014, which claims priority to U.S. Patent Provisional Application No. 61/978,031, filed on Apr. 10, 2014; and U.S. patent application Ser. No. 14/069,934, filed Nov. 1, 2013. Each of these applications is hereby incorporated by reference in its entirety.

### TECHNICAL FIELD

The disclosed embodiments relate generally to wireless power transmission systems and, in particular, to wireless power transmitters, wireless power receivers, and other devices that are used in wireless power transmission systems to wirelessly deliver power to an electronic device.

### BACKGROUND

Portable electronic devices, such as laptop computers, mobile phones, tablets, and other electronic devices, require frequent charging of a power-storing component (e.g., a battery) to operate. Many electronic devices require charging one or more times per day. Often, charging an electronic device requires manually connecting an electronic device to an outlet or other power source using a wired charging cable. In some cases, the power-storing component is removed from an electronic device and inserted into charging equipment. Accordingly, charging is time consuming, burdensome, and inefficient because users must carry around multiple charging cables and/or other charging devices, and frequently must locate appropriate power sources to charge their electronic devices. Additionally, conventional charging techniques potentially deprive a user of the ability to use the device while it is charging, and/or require the user to remain next to a wall outlet or other power source to which their electronic device or other charging equipment is connected.

Some other conventional charging systems utilize inductive coils to generate a magnetic field that is used to charge a device. However, such inductive coupling has a limited short range, such as a few inches or less. Users typically must place the device at a specific position on a charging pad and are unable to move the device to different positions on the pad, without interrupting or terminating the charging of the device. This results in a frustrating experience for many users as they may be unable to locate the device at the exact right position on the pad to start charging their device.

### SUMMARY

There is a need for systems and methods for wirelessly delivering power to electronic devices that address the drawbacks of conventional systems discussed above.

In some embodiments, a method of wirelessly transmitting power is provided. The method includes: (i) receiving, by a communications radio of a wireless power transmitter, a communication signal from a communications radio of a wireless power receiver, the communication signal including data used to determine a location of the wireless power receiver, and (ii) determining, by a processor of the wireless power transmitter, a location of the wireless power receiver based, at least in part, on the data included in the communication signal. The method further includes, in response to determining that the location of the wireless power receiver is within a wireless power transmission range defined by the transmitter, transmitting, by antennas of the wireless power transmitter, radio frequency (RF) power transmission waves towards the wireless power receiver, the RF power transmission waves converging to form controlled constructive interference patterns and destructive interference patterns in proximity to the location of the wireless power receiver, and the destructive interference patterns form a null space that surrounds the controlled constructive interference patterns and the controlled constructive interference patterns are received by an antenna of the wireless power receiver.

In accordance with some implementations, a wireless power transmitter includes one or more processors/cores, memory, and one or more programs; the one or more programs are stored in the memory and configured to be executed by the one or more processors/cores and the one or more programs include instructions for performing the operations of the method described above (and/or any of the other methods described in more detail below). In accordance with some implementations, a computer-readable storage medium has stored therein instructions which when executed by one or more processors/cores of a wireless power transmitter, cause the wireless power transmitter to perform the operations of the method described above (and/or any of the other methods described in more detail below).

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

So that the present disclosure can be understood in greater detail, a more particular description may be had by reference to the features of various embodiments, some of which are illustrated in the appended drawings. The appended drawings, however, merely illustrate pertinent features of the present disclosure and are therefore not to be considered limiting, for the description may admit to other effective features.

FIG. 1 is a block diagram showing components of a wireless power transmission system, in accordance with some embodiments.

FIG. 2 illustrates steps of wireless power transmission, in accordance with some embodiments.

FIG. 3 illustrates steps of powering a plurality of receiver devices, in accordance with some embodiments.

FIG. 4A illustrates a wireless power transmission system used for charging or powering one or more electronic devices inside a vehicle, in accordance with some embodiments.

FIG. 4B illustrates a wireless power transmission system used for charging or powering one or more electronic devices inside a vehicle, in accordance with some embodiments.

FIG. 4C illustrates a wireless power transmission system used for charging or powering one or more electronic devices inside a vehicle, in accordance with some embodiments.

FIG. 4D is a flow diagram of wirelessly charging or powering one or more electronic devices inside a vehicle, in accordance with some embodiments.

FIG. 5A illustrates a wireless power transmission system used for providing power to sensors on a bottom portion of a vehicle, in accordance with some embodiments.

FIG. 5B illustrates a wireless power transmission system used for providing power to sensors located in an engine compartment of a vehicle, in accordance with some embodiments.

FIG. 5C illustrates a wireless power transmission system used for providing power to sensors located in a passenger compartment of a vehicle, in accordance with some embodiments.

FIG. 5D illustrates a wireless power transmission system used for providing power to devices located in a passenger compartment of a vehicle, in accordance with some embodiments.

FIGS. 6A-6C illustrate wireless power transmission systems, including a toolbox with an embedded transmitter, used for providing power to cordless power tools, in accordance with some embodiments.

FIG. 6D is a flow diagram of wirelessly charging or powering one or more cordless power tools, in accordance with some embodiments.

FIG. 7A illustrates a wireless power transmission system having a transmitter attached to a mast of a rescue vehicle, in accordance with some embodiments.

FIG. 7B illustrates a rescue vehicle with a transmitter operating in a disaster zone, in accordance with some embodiments.

FIG. 8A illustrates an example multi-mode transmitter, in accordance with some embodiments.

FIG. 8B illustrates a multi-mode transmitter defining a pocket of energy and providing a network signal, in accordance with some embodiments.

FIG. 8C is a block diagram of an example multi-mode transmitter.

FIG. 9A illustrates a transmitter having a screw cap for power coupling, in accordance with some embodiments.

FIG. 9B illustrates a transmitter having bare wires for power coupling, in accordance with some embodiments.

FIG. 9C illustrates a transmitter having a power plug for power coupling, in accordance with some embodiments.

FIGS. 10A-10C illustrate wireless power transmission systems used in military applications, in accordance with some embodiments.

FIG. 11A illustrates a law enforcement officer wearing a uniform with an integrated wireless power receiver, in accordance with some embodiments.

FIGS. 11B-11D illustrate wireless power transmitters integrated with various types of mobile law enforcement equipment (e.g., a police squad car and a SWAT team vehicle) for use in conjunction with law enforcement operations, in accordance with some embodiments.

FIGS. 12A-12D illustrate tracking systems that upload to a cloud-based service for use in conjunction with wireless power transmission systems, in accordance with some embodiments.

FIGS. 13A-13D illustrate various renewable energy sources for use in conjunction with wireless power transmission systems, in accordance with some embodiments.

FIGS. 14A-14B illustrate wireless power transmission systems used in logistic services, in accordance with some embodiments.

FIG. 15A illustrates a wireless power transmission system used for charging one or more peripheral devices via a transmitter associated with a laptop computer, in accordance with some embodiments.

FIG. 15B is an exploded view of a laptop screen, showing components including an embedded wireless power transmitter, in accordance with some embodiments.

FIG. 15C is an exploded view of a laptop screen, showing components including an embedded wireless power transmitter and an embedded wireless power receiver, in accordance with some embodiments.

FIG. 15D illustrates a wireless power transmission system in which a laptop computer may receive and transmit radio frequency waves in a substantially simultaneous fashion, in accordance with some embodiments.

FIG. 15E is a flow diagram of a wireless power transmission process that may be implemented for charging one or more peripheral devices using a laptop computer, in accordance with some embodiments.

FIGS. 16A-16B are illustrations of game controllers that are coupled with wireless power receivers, in accordance with some embodiments.

FIGS. 16C-16G illustrate various wireless power transmission systems in which power is wirelessly delivered to electronic devices, in accordance with some embodiments.

FIG. 16H illustrates an improved roll-able electronic paper display used to explain certain advantages of wireless power transmission systems, in accordance with some embodiments.

FIGS. 17A-17G illustrate various articles (e.g., heating blanket, heating sock, heating glove, warming jacket, shirt, cap, and cooling shirt) with embedded wireless power receivers, in accordance with some embodiments.

FIGS. 18A-18B are illustrations of medical devices with wireless power receivers coupled thereto, in accordance with some embodiments.

FIGS. 18C-18E are illustrations of wireless power transmission systems for wirelessly delivering power to medical devices, in accordance with some embodiments.

FIG. 19A is an illustration of a house configured with a number of wireless power transmitters and receivers, in accordance with some embodiments.

FIG. 19B is a flow diagram of a wireless power transmission process that may be implemented for charging one or more devices located within a house configured with a number of wireless power transmitters and receivers, in accordance with some embodiments.

FIG. 20A illustrates a system architecture for a wireless power network, in accordance with some embodiments.

FIG. 20B is a flow diagram for an off-premises alert method for wireless power receivers in a wireless power network, in accordance with some embodiments.

FIG. 21A illustrates a diagram of architecture for incorporating a transmitter into different devices, in accordance with some embodiments.

FIG. 21B illustrates an example embodiment of a television (TV) system outputting wireless power, in accordance with some embodiments.

FIG. 21C illustrates an example embodiment of an internal structure of a TV system, in accordance with some embodiments.

FIG. 21D illustrates an example embodiment of a tile architecture, in accordance with some embodiments.

FIGS. 22-24 illustrate transmitters integrated with various devices, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Numerous details are described herein in order to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not been described in exhaustive detail so as not to unnecessarily obscure pertinent aspects of the embodiments described herein.

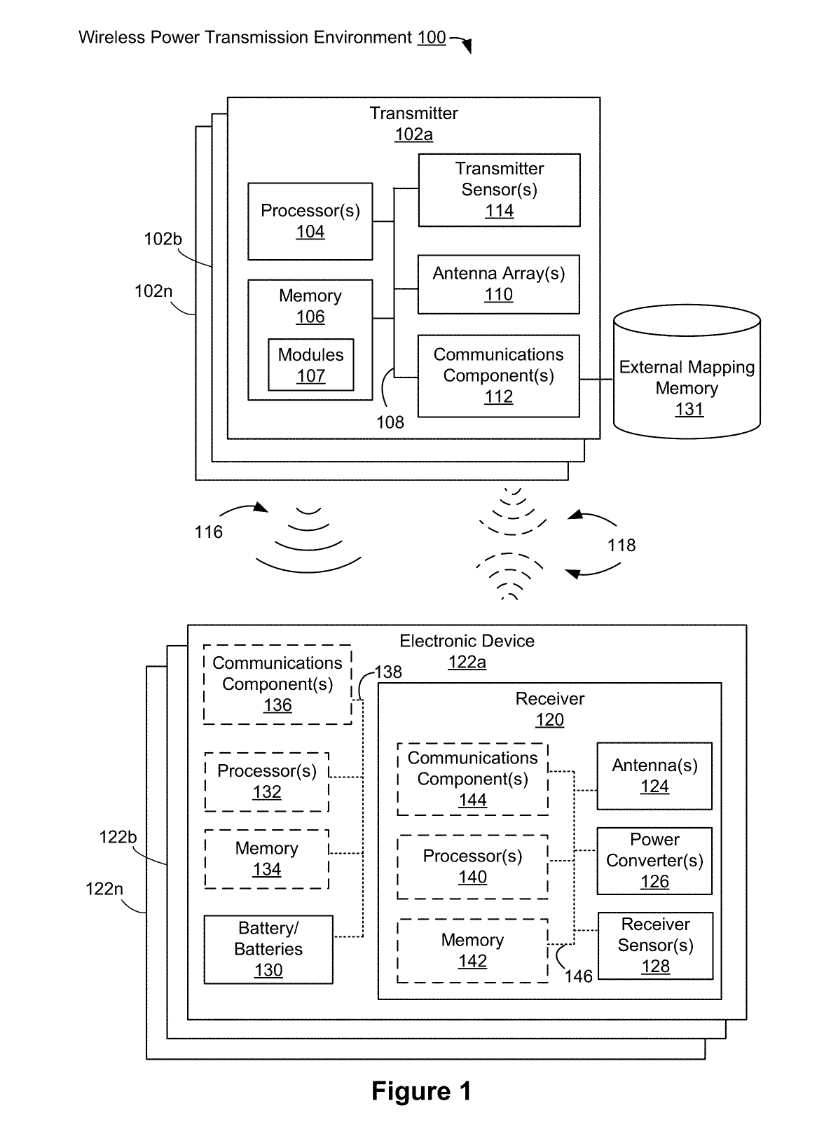

FIG. 1 is a block diagram of components of wireless power transmission environment 100, in accordance with some embodiments. Wireless power transmission environment 100 includes, for example, transmitters 102 (e.g., transmitters 102a, 102b . . . 102n) and one or more receivers 120 (e.g., receivers 120a, 120b 120n). In some embodiments, each respective wireless power transmission environment 100 includes a number of receivers 120, each of which is associated with a respective electronic device 122.

An example transmitter 102 (e.g., transmitter 102a) includes, for example, one or more processor(s) 104, a memory 106, one or more antenna arrays 110, one or more communications components 112 (also referred to herein as a communications radio), and/or one or more transmitter sensors 114. In some embodiments, these components are interconnected by way of a communications bus 108. References to these components of transmitters 102 cover embodiments in which one or more of these components (and combinations thereof) are included.

In some embodiments, the memory 106 stores one or more programs (e.g., sets of instructions) and/or data structures, collectively referred to as “modules 107” herein. In some embodiments, the memory 106, or the non-transitory computer readable storage medium of the memory 106 stores the following programs, modules, and data structures, or a subset or superset thereof:
information received from receiver 120 (e.g., generated by receiver sensor 128 and then transmitted to the transmitter 102a);
information received from transmitter sensor 114;
an adaptive pocket-forming module that adjusts one or more power waves transmitted by one or more transmitters 102; and/or
a beacon transmitting module that transmits a communication signal 118 for detecting a receiver 120 (e.g., within a transmission field of the transmitter 102).

The above-identified modules (e.g., data structures and/or programs including sets of instructions) need not be implemented as separate software programs, procedures, or modules, and thus various subsets of these modules may be combined or otherwise re-arranged in various embodiments. In some embodiments, the memory 106 stores a subset of the modules identified above. In some embodiments, an external mapping memory 132 that is communicatively connected to communications component 112 stores one or more modules identified above. Furthermore, the memory 106 and/or external mapping memory 132 may store additional modules not described above. In some embodiments, the modules stored in the memory 106, or a non-transitory computer readable storage medium of memory 106, provide instructions for implementing respective operations in the methods described below. In some embodiments, some or all of these modules may be implemented with specialized hardware circuits that subsume part or all of the module functionality. One or more of the above-identified elements may be executed by one or more of processor(s) 104. In some embodiments, one or more of the modules described with regard to the memory 106 is implemented on the memory 104 of a server (not shown) that is communicatively coupled to one or more transmitters 102 and/or by a memory of electronic device 122 and/or receiver 120.

In some embodiments, a single processor 104 (e.g., processor 104 of transmitter 102a) executes software modules for controlling multiple transmitters 102 (e.g., transmitters 102b . . . 102n). In some embodiments, a single transmitter 102 (e.g., transmitter 102a) includes multiple processors 104, such as one or more transmitter processors (configured to, e.g., control transmission of signals 116 by antenna array 110), one or more communications component processors (configured to, e.g., control communications transmitted by communications component 112 and/or receive communications by way of communications component 112) and/or one or more sensor processors (configured to, e.g., control operation of transmitter sensor 114 and/or receive output from transmitter sensor 114).

Wireless power receiver 120 (also referred to as a receiver 120, e.g., a receiver of electronic device 122) receives power transmission signals 116 and/or communications 118 transmitted by transmitters 102. In some embodiments, receiver 120 includes one or more antennas 124 (e.g., an antenna array including multiple antenna elements), power converter 126, receiver sensor 128, and/or other components or circuitry (e.g., processor(s) 140, memory 142, and/or communication component(s) 144). In some embodiments, these components are interconnected by way of a communications bus 146. References to these components of receiver 120 cover embodiments in which one or more of these components (and combinations thereof) are included.

Receiver 120 converts energy from received signals 116 (also referred to herein as RF power transmission signals, or simply, RF signals, RF waves, power waves, or power transmission signals) into electrical energy to power and/or charge electronic device 122. For example, receiver 120 uses power converter 126 to convert captured energy from power waves 116 to alternating current (AC) electricity or direct current (DC) electricity usable to power and/or charge electronic device 122. Non-limiting examples of power converter 126 include rectifiers, rectifying circuits, voltage conditioners, among suitable circuitry and devices.

In some embodiments, receiver 120 is a standalone device that is detachably coupled to one or more electronic devices 122. For example, electronic device 122 has processor(s) 132 for controlling one or more functions of electronic device 122, and receiver 120 has processor(s) 140 for controlling one or more functions of receiver 120.

In some embodiments, receiver 120 is a component of electronic device 122. For example, processor(s) 132 controls functions of electronic device 122 and receiver 120. In addition, in some embodiments, receiver 120 includes processor(s) 140, which communicate(s) with processor(s) 132 of the electronic device 122.

In some embodiments, electronic device 122 includes processor(s) 132, memory 134, communication component(s) 136, and/or battery/batteries 130. In some embodiments, these components are interconnected by way of a communications bus 138. In some embodiments, communications between electronic device 122 and receiver 120 occur via communications component(s) 136 and/or 144. In some embodiments, communications between electronic device 122 and receiver 120 occur via a wired connection between communications bus 138 and communications bus 146. In some embodiments, electronic device 122 and receiver 120 share a single communications bus.

In some embodiments, receiver 120 receives one or more power waves 116 directly from transmitter 102 (e.g., via one or more antennas 124). In some embodiments, receiver 120 harvests power waves from one or more pockets of energy created by one or more power waves 116 transmitted by transmitter 102. In some embodiments, the transmitter 102 is a near-field transmitter that transmits the one or more power waves 116 within a near-field distance (e.g., less than approximately six inches away from the transmitter 102). In some embodiments, the transmitter 102 is a far-field transmitter that transmits the one or more power waves 116 within a far-field distance (e.g., more than approximately six inches to approximately fifteen feet or more away from the transmitter 102).

In some embodiments, after the power waves 116 are received and/or energy is harvested from a pocket of energy, circuitry (e.g., integrated circuits, amplifiers, rectifiers, and/or voltage conditioner) of the receiver 120 converts the energy of the power waves (e.g., radio frequency electromagnetic radiation) to usable power (i.e., electricity), which powers electronic device 122 and/or is stored to battery 130 of electronic device 122. In some embodiments, a rectifying circuit of the receiver 120 translates the electrical energy from AC to DC for use by electronic device 122. In some embodiments, a voltage conditioning circuit increases or decreases the voltage of the electrical energy as required by the electronic device 122. In some embodiments, an electrical relay conveys electrical energy from the receiver 120 to the electronic device 122.

In some embodiments, electronic device 122 obtains power from multiple transmitters 102 and/or using multiple receivers 120. In some embodiments, the wireless power transmission environment 100 includes a plurality of electronic devices 122, each having at least one respective receiver 120 that is used to harvest power waves from the transmitters 102 into usable power for charging the electronic devices 122.

In some embodiments, the one or more transmitters 102 adjust one or more characteristics (e.g., waveform characteristics, such as phase, gain, direction, amplitude, polarization, and/or frequency) of power waves 116. For example, a transmitter 102 selects a subset of one or more antenna elements of antenna array 110 to initiate transmission of power waves 116, cease transmission of power waves 116, and/or adjust one or more characteristics used to transmit power waves 116. In some embodiments, the one or more transmitters 102 adjust power waves 116 such that trajectories of power waves 116 converge at a predetermined location within a transmission field (e.g., a location or region in space), resulting in controlled constructive or destructive interference patterns. The transmitter 102 may adjust sets of characteristics for transmitting the power waves 116 to account for changes at the wireless power receiver that may negatively impact transmission of the power waves 116.

In some embodiments, respective antenna arrays 110 of the one or more transmitters 102 may include antennas having one or more polarizations. For example, a respective antenna array 110 may include vertical or horizontal polarization, right hand or left hand circular polarization, elliptical polarization, or other polarizations, as well as any number of polarization combinations. In some embodiments, antenna array 110 is capable of dynamically varying the antenna polarization (or any other characteristic) to optimize wireless power transmission.

In some embodiments, respective antenna arrays 110 of the one or more transmitters 102 may include a set of one or more antennas configured to transmit the power waves 116 into respective transmission fields of the one or more transmitters 102. Integrated circuits (not shown) of the respective transmitter 102, such as a controller circuit (e.g., a radio frequency integrated circuit (RFIC)) and/or waveform generator, may control the behavior of the antennas. For example, based on the information received from the receiver by way of the communication signal 118, a controller circuit (e.g., processor 104 of the transmitter 102, FIG. 1) may determine a set of one or more waveform characteristics (e.g., amplitude, frequency, trajectory, direction, phase, polarization, among other characteristics) used for transmitting the power waves 116 that would effectively provide power to the receiver 102 and electronic device 122. The controller circuit may also identify a subset of antennas from the antenna arrays 110 that would be effective in transmitting the power waves 116. In some embodiments, a waveform generator circuit (not shown in FIG. 1) of the respective transmitter 102 coupled to the processor 104 may convert energy and generate the power waves 116 having the waveform characteristics identified by the processor 104/controller circuit, and then provide the power waves to the antenna arrays 110 for transmission.

In some embodiments, constructive interference of power waves occurs when two or more power waves 116 (e.g., RF power transmission signals) are in phase with each other and converge into a combined wave such that an amplitude of the combined wave is greater than amplitude of a single one of the power waves. For example, the positive and negative peaks of sinusoidal waveforms arriving at a location from multiple antennas “add together” to create larger positive and negative peaks. In some embodiments, a pocket of energy is formed at a location in a transmission field where constructive interference of power waves occurs.

In some embodiments, destructive interference of power waves occurs when two or more power waves are out of phase and converge into a combined wave such that the amplitude of the combined wave is less than the amplitude of a single one of the power waves. For example, the power waves “cancel each other out,” thereby diminishing the amount of energy concentrated at a location in the transmission field. In some embodiments, destructive interference is used to generate a negligible amount of energy or “null” at a location within the transmission field where the power waves converge.

In some embodiments, the one or more transmitters 102 transmit power waves 116 that create two or more discrete transmission fields (e.g., overlapping and/or non-overlapping discrete transmission fields). In some embodiments, a first transmission field (i.e., an area of physical space into which a first set of power waves is transmitted) is managed by a first processor 104 of a first transmitter (e.g., transmitter 102a) and a second transmission field (i.e., another area of physical space into which a second set of power waves is transmitted) is managed by a second processor 104 of a second transmitter (e.g., transmitter 102b). In some embodiments, the two or more discrete transmission fields (e.g., overlapping and/or non-overlapping) are managed by the transmitter processors 104 as a single transmission field. Moreover, in some embodiments, a single processor 104 manages the first and second transmission fields.

In some embodiments, communications component 112 transmits communication signals 118 by way of a wired and/or wireless communication connection to receiver 120. In some embodiments, communications component 112 generates communication signals 118 used for triangulation of receiver 120. In some embodiments, communication signals 118 are used to convey information between transmitter 102 and receiver 120 for adjusting one or more characteristics used to transmit the power waves 116. In some embodiments, communication signals 118 include information related to status, efficiency, user data, power consumption, billing, geo-location, and other types of information.

In some embodiments, communications component 112 transmits communication signals 118 to receiver 120 by way of the electronic device 122a. For example, communications component 112 may convey information to communications component 136 of the electronic device 122a, which the electronic device 122a may in turn convey to the receiver 120 (e.g., via bus 138).

In some embodiments, communications component 112 includes a communications component antenna for communicating with receiver 120 and/or other transmitters 102 (e.g., transmitters 102b through 102n). In some embodiments, these communication signals 118 are sent using a first channel (e.g., a first frequency band) that is independent and distinct from a second channel (e.g., a second frequency band distinct from the first frequency band) used for transmission of the power waves 116.

In some embodiments, the receiver 120 includes a receiver-side communications component 144 (also referred to herein as a communications radio) configured to communicate various types of data with one or more of the transmitters 102, through a respective communication signal 118 generated by the receiver-side communications component (in some embodiments, a respective communication signal 118 is referred to as an advertising signal). The data may include location indicators for the receiver 102 and/or electronic device 122, a power status of the device 122, status information for the receiver 102, status information for the electronic device 122, status information about the power waves 116, and/or status information for pockets of energy. In other words, the receiver 120 may provide data to the transmitter 102, by way of the communication signal 118, regarding the current operation of the system 100, including: information identifying a present location of the receiver 120 or the device 122, an amount of energy (i.e., usable power) received by the receiver 120, and an amount of usable power received and/or used by the electronic device 122, among other possible data points containing other types of information.

In some embodiments, the data contained within communication signals 118 is used by electronic device 122, receiver 120, and/or transmitters 102 for determining adjustments of the one or more characteristics used by the antenna array 110 to transmit the power waves 116. Using a communication signal 118, the transmitter 102 communicates data that is used, e.g., to identify receivers 120 within a transmission field, identify electronic devices 122, determine safe and effective waveform characteristics for power waves, and/or hone the placement of pockets of energy. In some embodiments, receiver 120 uses a communication signal 118 to communicate data for, e.g., alerting transmitters 102 that the receiver 120 has entered or is about to enter a transmission field, provide information about electronic device 122, provide user information that corresponds to electronic device 122, indicate the effectiveness of received power waves 116, and/or provide updated characteristics or transmission parameters that the one or more transmitters 102 use to adjust transmission of the power waves 116.

In some embodiments, transmitter sensor 114 and/or receiver sensor 128 detect and/or identify conditions of electronic device 122, receiver 120, transmitter 102, and/or a transmission field. In some embodiments, data generated by transmitter sensor 114 and/or receiver sensor 128 is used by transmitter 102 to determine appropriate adjustments to the one or more characteristics used to transmit the power waves 106. Data from transmitter sensor 114 and/or receiver sensor 128 received by transmitter 102 includes, e.g., raw sensor data and/or sensor data processed by a processor 104, such as a sensor processor. Processed sensor data includes, e.g., determinations based upon sensor data output. In some embodiments, sensor data received from sensors that are external to the receiver 120 and the transmitters 102 is also used (such as thermal imaging data, information from optical sensors, and others).

In some embodiments, receiver sensor 128 is a gyroscope that provides raw data such as orientation data (e.g., tri-axial orientation data), and processing this raw data may include determining a location of receiver 120 and/or or a location of receiver antenna 124 using the orientation data.

In some embodiments, receiver sensor 128 includes one or more infrared sensors (e.g., that output thermal imaging information), and processing this infrared sensor data includes identifying a person (e.g., indicating presence of the person and/or indicating an identification of the person) or other sensitive object based upon the thermal imaging information.

In some embodiments, receiver sensor 128 includes a gyroscope and/or an accelerometer that indicates an orientation of receiver 120 and/or electronic device 122. As one example, transmitters 102 receive orientation information from receiver sensor 128 and the transmitters 102 (or a component thereof, such as the processor 104) use the received orientation information to determine whether electronic device 122 is flat on a table, in motion, and/or in use (e.g., next to a user's head).

In some embodiments, receiver sensor 128 is a sensor of electronic device 122 (e.g., an electronic device 122 that is remote from receiver 102). In some embodiments, receiver 120 and/or electronic device 122 includes a communication system for transmitting signals (e.g., sensor signals output by receiver sensor 128) to transmitter 102.

Non-limiting examples of transmitter sensor 114 and/or receiver sensor 128 include, e.g., infrared, pyroelectric, ultrasonic, laser, optical, Doppler, gyro, accelerometer, microwave, millimeter, RF standing-wave sensors, resonant LC sensors, capacitive sensors, and/or inductive sensors. In some embodiments, technologies for transmitter sensor 114 and/or receiver sensor 128 include binary sensors that acquire stereoscopic sensor data, such as the location of a human or other sensitive object.

In some embodiments, transmitter sensor 114 and/or receiver sensor 128 is configured for human recognition (e.g., capable of distinguishing between a person and other objects, such as furniture). Examples of sensor data output by human recognition-enabled sensors include: body temperature data, infrared range-finder data, motion data, activity recognition data, silhouette detection and recognition data, gesture data, heart rate data, portable devices data, and wearable device data (e.g., biometric readings and output, accelerometer data).

In some embodiments, transmitters 102 adjust one or more characteristics used to transmit the power waves 116 to ensure compliance with electromagnetic field (EMF) exposure protection standards for human subjects. Maximum exposure limits are defined by US and European standards in terms of power density limits and electric field limits (as well as magnetic field limits). These include, for example, limits established by the Federal Communications Commission (FCC) for maximum permissible exposure (MPE), and limits established by European regulators for radiation exposure. Limits established by the FCC for MPE are codified at 47 C.F.R. § 1.1310. For electromagnetic field (EMF) frequencies in the microwave range, power density can be used to express an intensity of exposure. Power density is defined as power per unit area. For example, power density can be commonly expressed in terms of watts per square meter (W/m²), milliwatts per square centimeter (mW/cm²), or microwatts per square centimeter (μW/cm²). In some embodiments, output from transmitter sensor 114 and/or receiver sensor 128 is used by transmitter 102 to detect whether a person or other sensitive object enters a power transmission region (e.g., a location within a predetermined distance of a transmitter 102, power waves generated by transmitter 102, and/or a pocket of energy). In some embodiments, in response to detecting that a person or other sensitive object has entered the power transmission region, the transmitter 102 adjusts one or more power waves 116 (e.g., by ceasing power wave transmission, reducing power wave transmission, and/or adjusting the one or more characteristics of the power waves). In some embodiments, in response to detecting that a person or other sensitive object has entered the power transmission region, the transmitter 102 activates an alarm (e.g., by transmitting a signal to a loudspeaker that is a component of transmitter 102 or to an alarm device that is remote from transmitter 102). In some embodiments, in response to detecting that a person or other sensitive object has entered a power transmission region, the transmitter 102 transmits a digital message to a system log or administrative computing device. These techniques for ensuring compliance with EMF exposure standards.

In some embodiments, antenna array 110 includes multiple antenna elements (e.g., configurable “tiles”) collectively forming an antenna array. Antenna array 110 generates power transmission signals, e.g., RF power waves, ultrasonic power waves, infrared power waves, and/or magnetic resonance power waves. In some embodiments, the antennas of an antenna array 110 (e.g., of a single transmitter, such as transmitter 102a, and/or of multiple transmitters, such as transmitters 102a, 102b, . . . , 102n) transmit two or more power waves that intersect at a defined location (e.g., a location corresponding to a detected location of a receiver 120), thereby forming a pocket of energy (e.g., a concentration of energy) at the defined location.

In some embodiments, transmitter 102 assigns a first task to a first subset of antenna elements of antenna array 110, a second task to a second subset of antenna elements of antenna array 110, and so on, such that the constituent antennas of antenna array 110 perform different tasks (e.g., determining locations of previously undetected receivers 120 and/or transmitting power waves 116 to one or more receivers 120). As one example, in an antenna array 110 with ten antennas, nine antennas transmit power waves 116 that form a pocket of energy and the tenth antenna operates in conjunction with communications component 112 to identify new receivers in the transmission field. In another example, an antenna array 110 having ten antenna elements is split into two groups of five antenna elements, each of which transmits power waves 116 to two different receivers 120 in the transmission field.

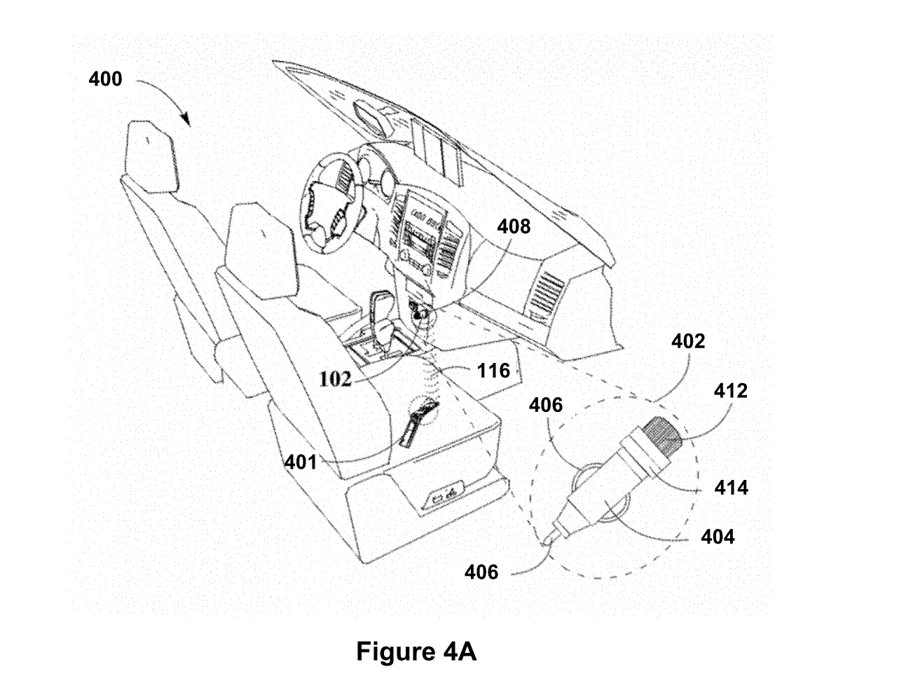

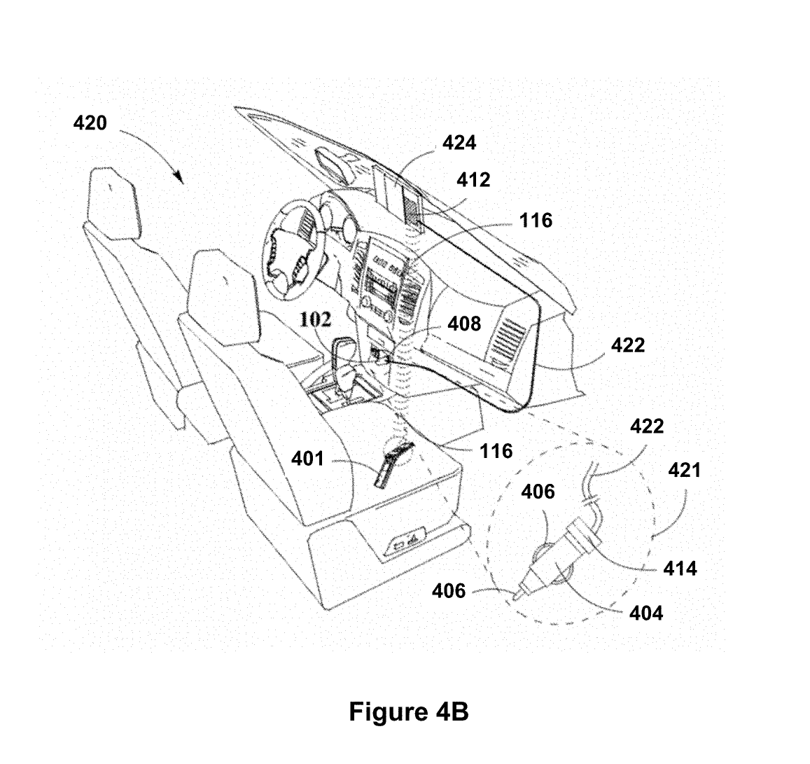

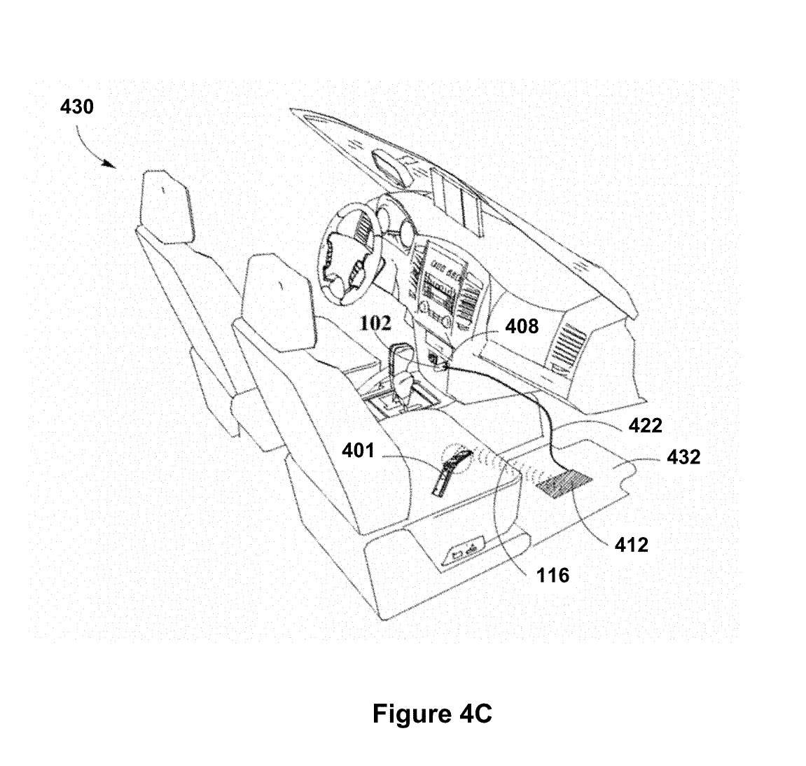

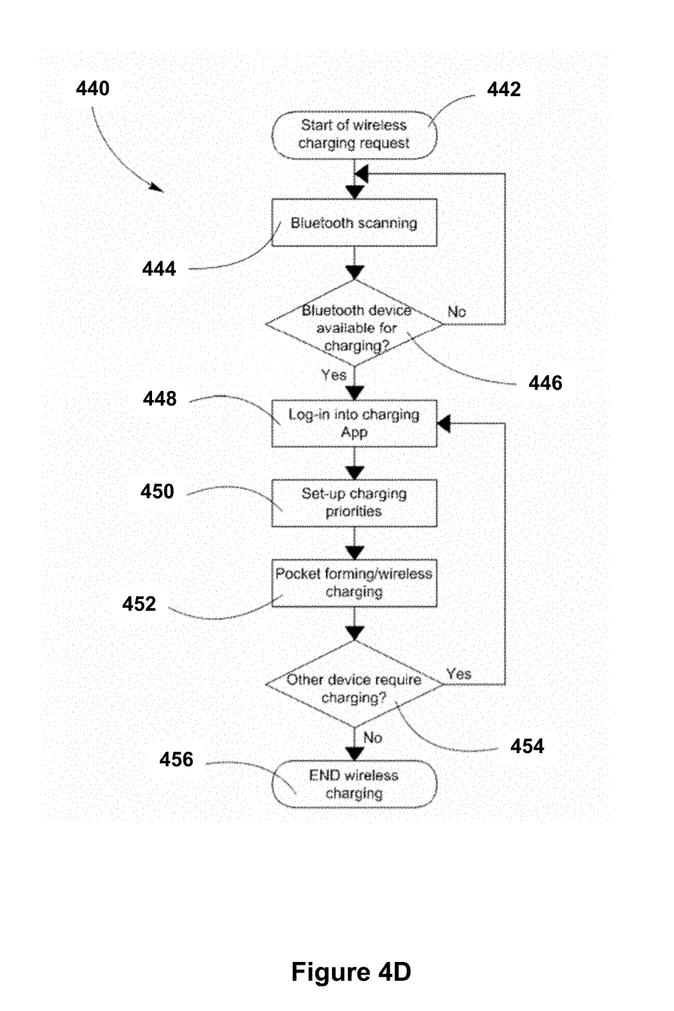

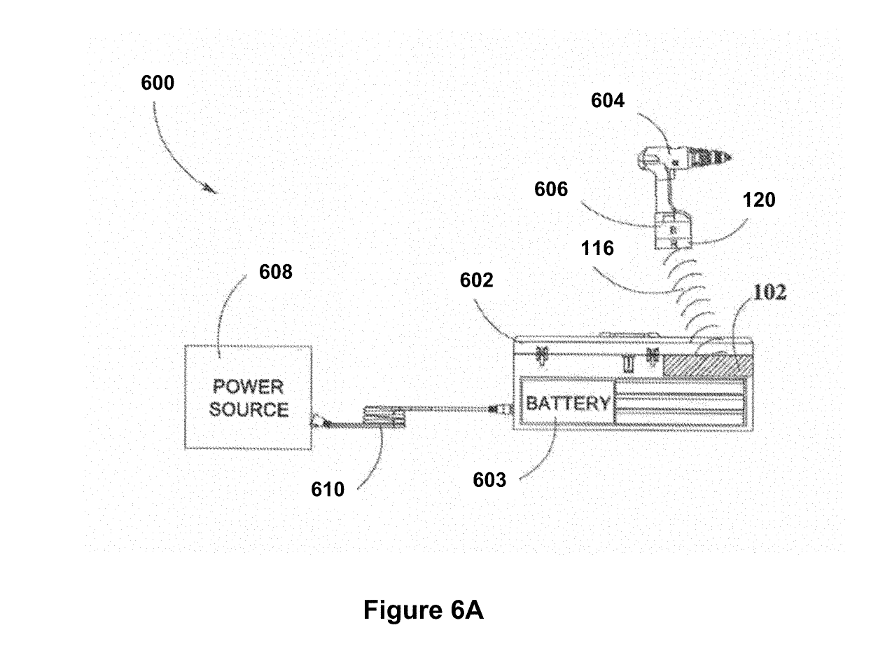

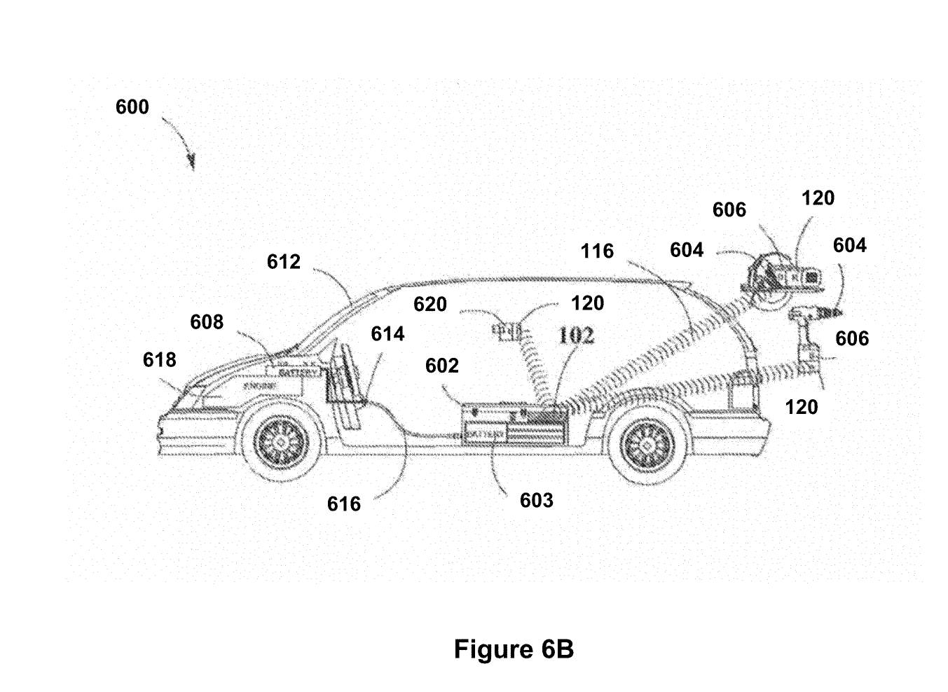

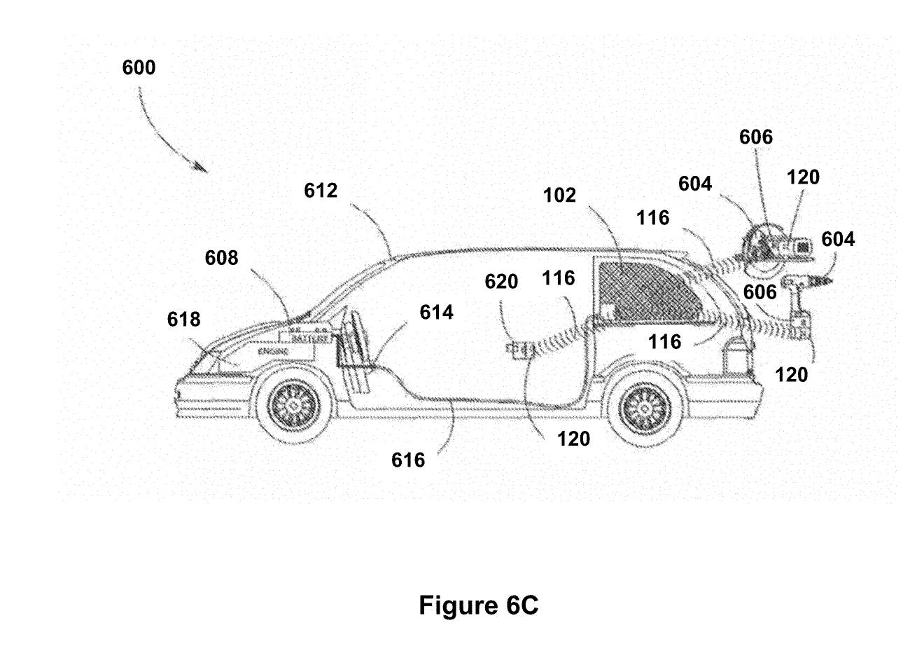

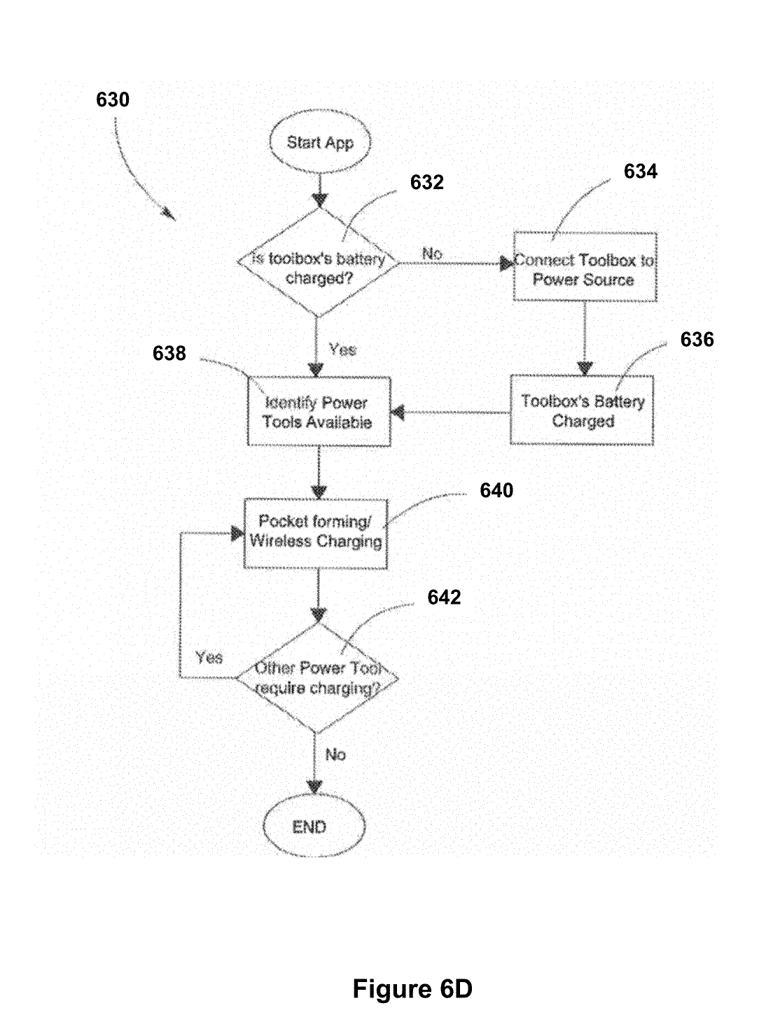

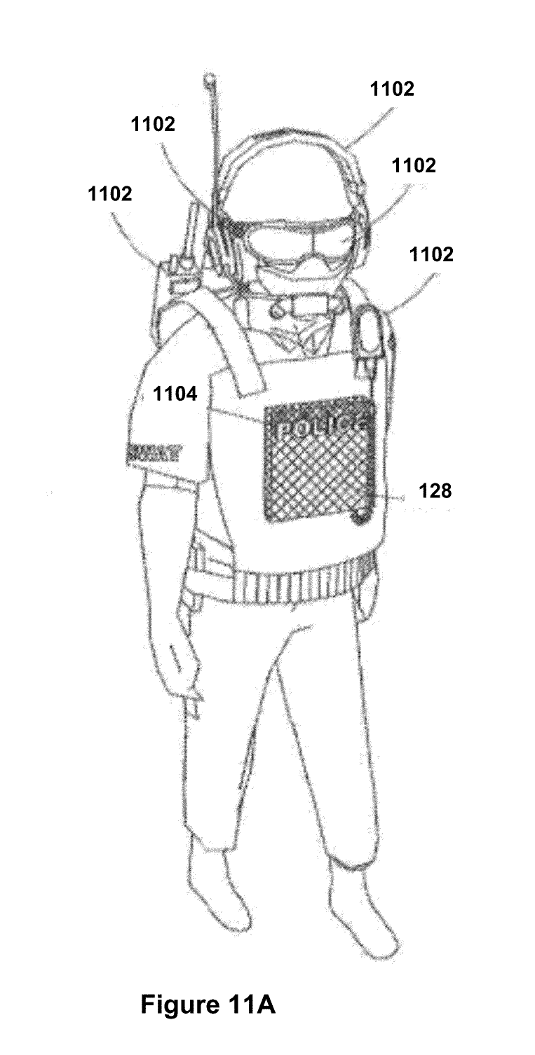

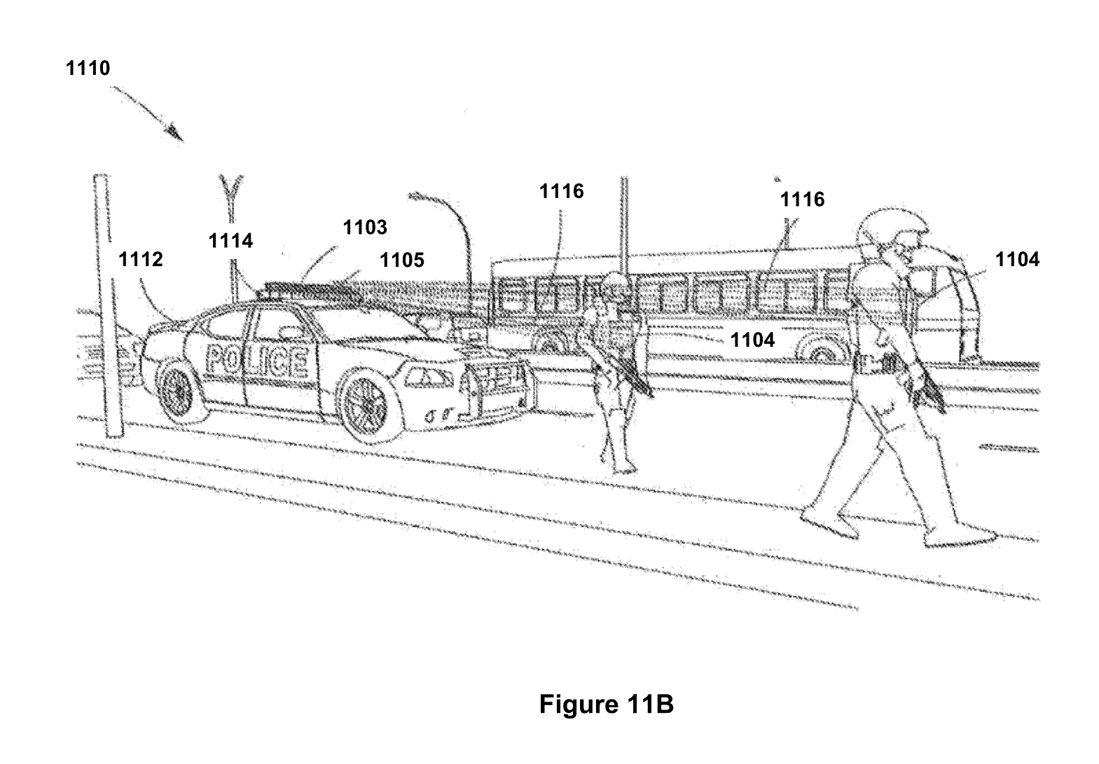

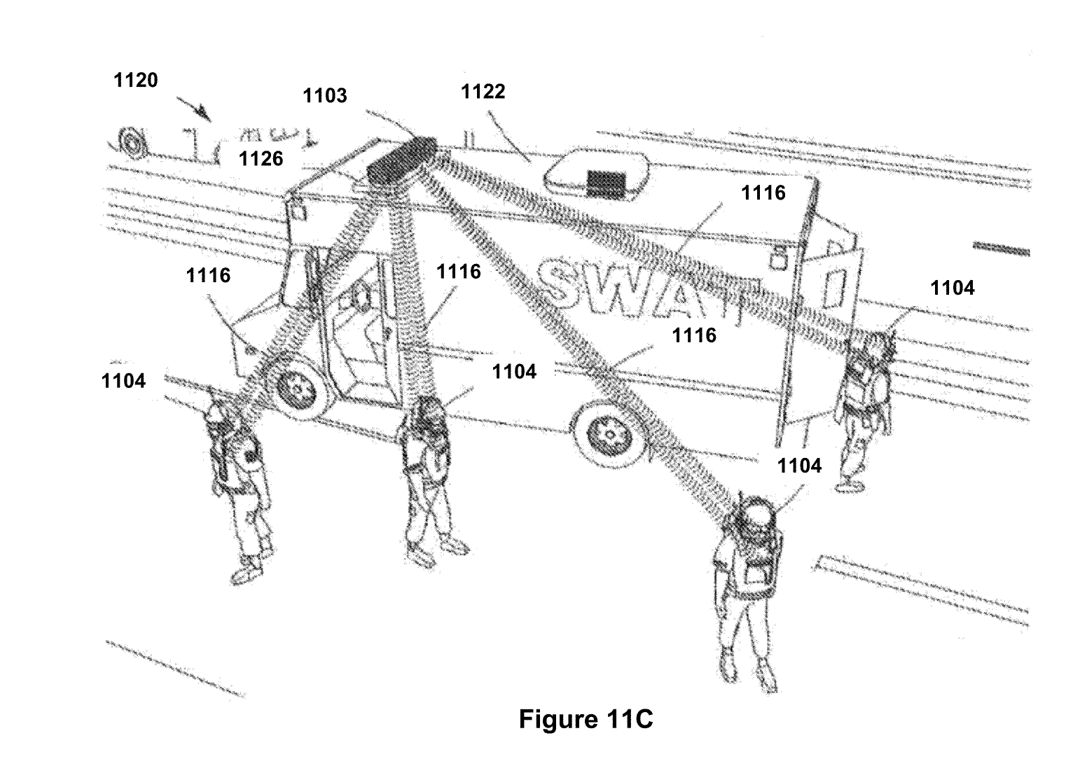

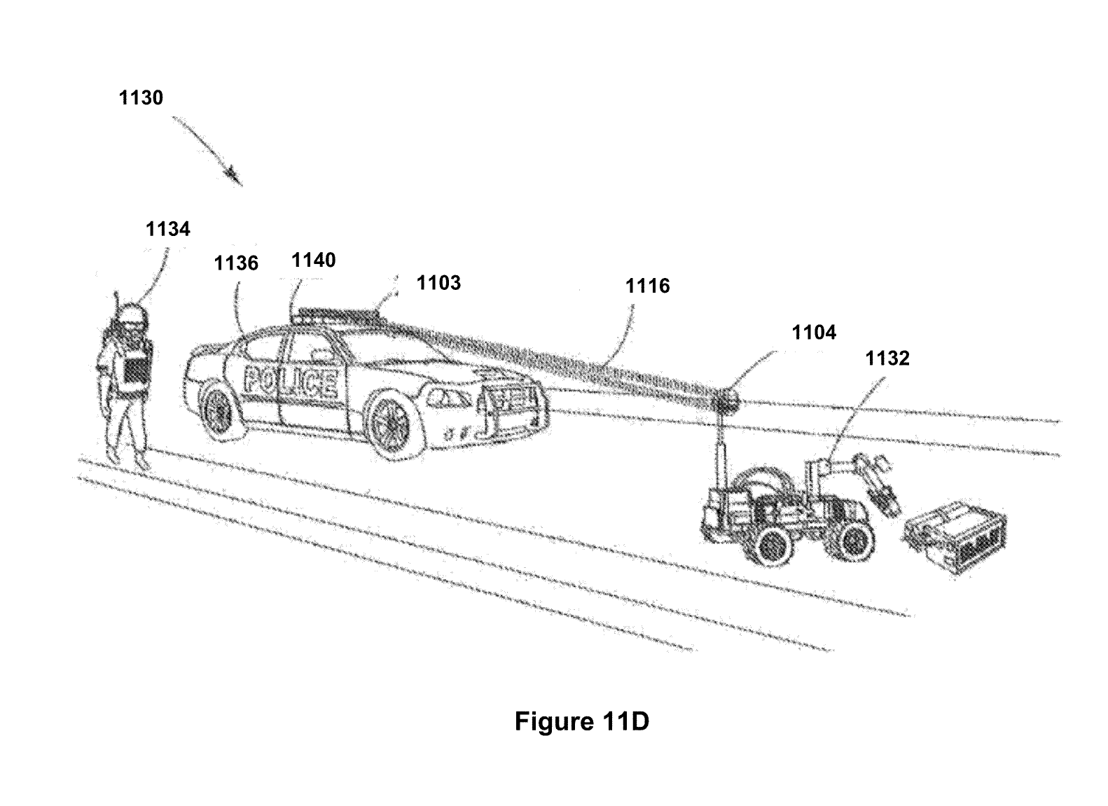

Various embodiments of the transmitter 102 are illustrated and described herein. For example, an embodiment of the transmitter 102 is connected to a power source inside a vehicle (e.g., as shown in FIGS. 4A-4C and described below), another embodiment of the transmitter 102 is embedded in a toolbox (e.g., as shown in FIGS. 6A-6B and described below), and another embodiment of the transmitter 102 is placed on a police vehicle (e.g., as shown in FIGS. 11B-11D and described below).

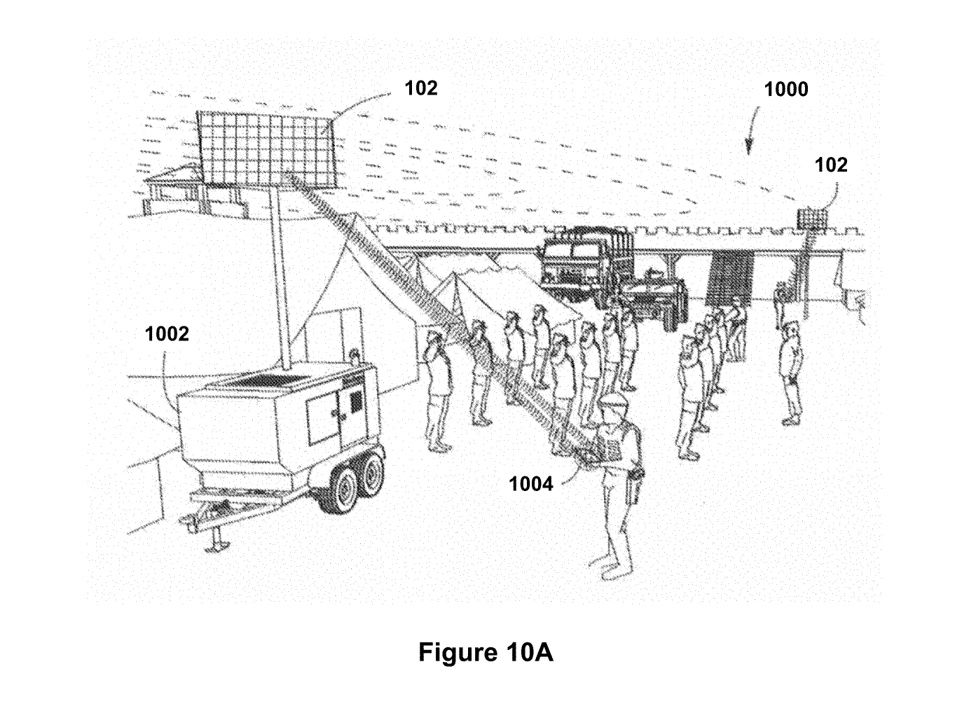

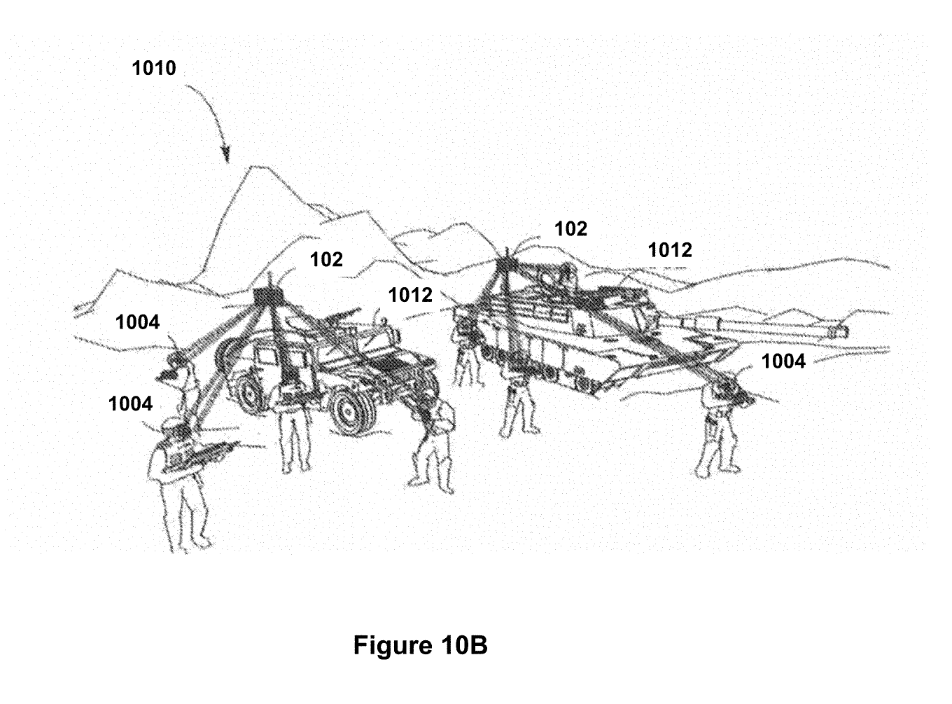

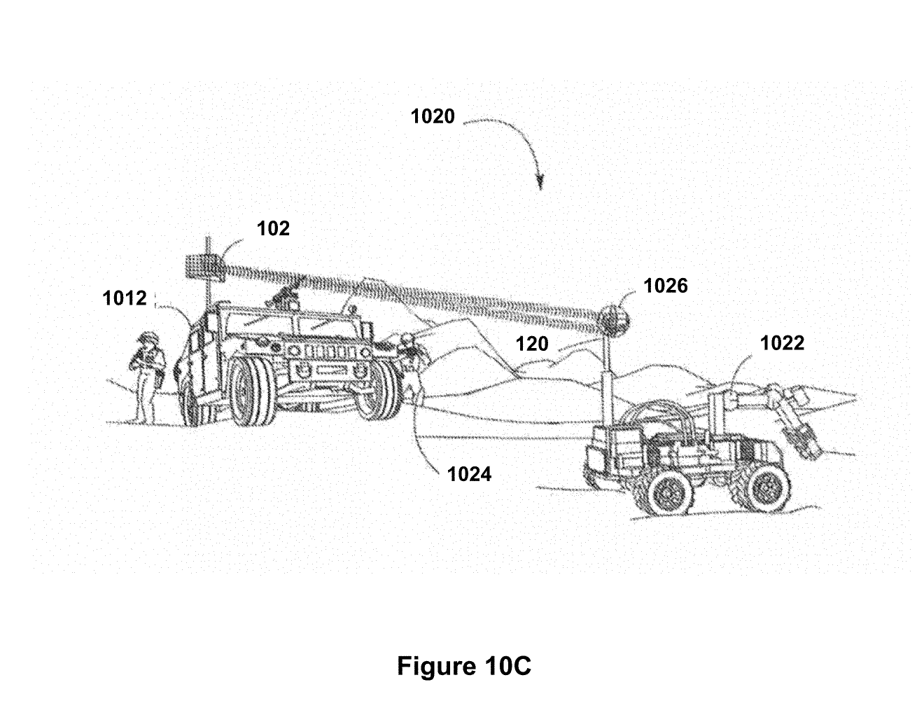

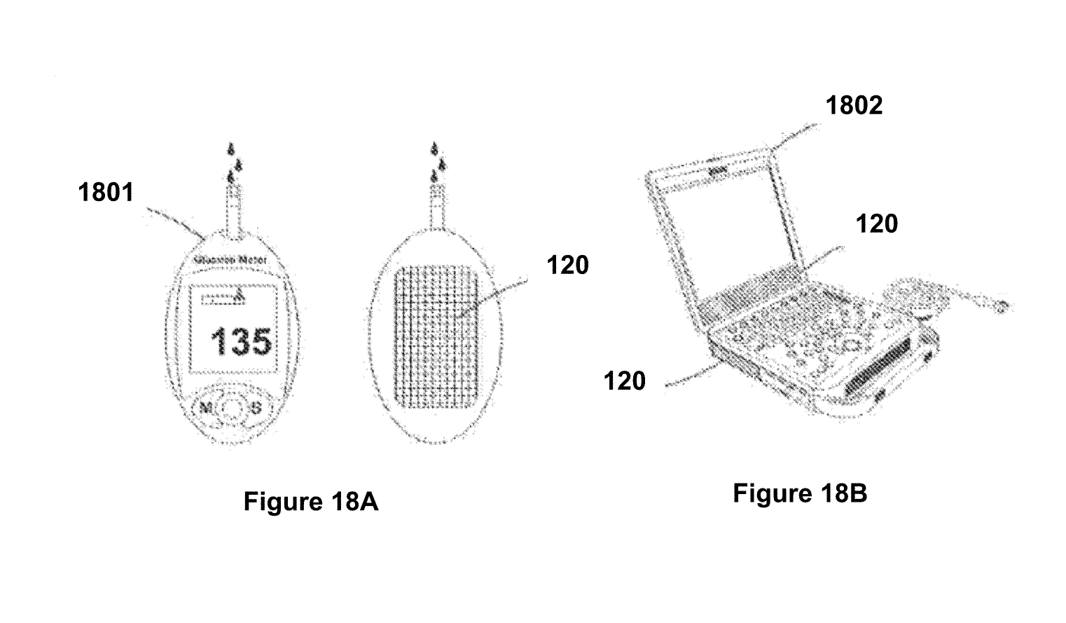

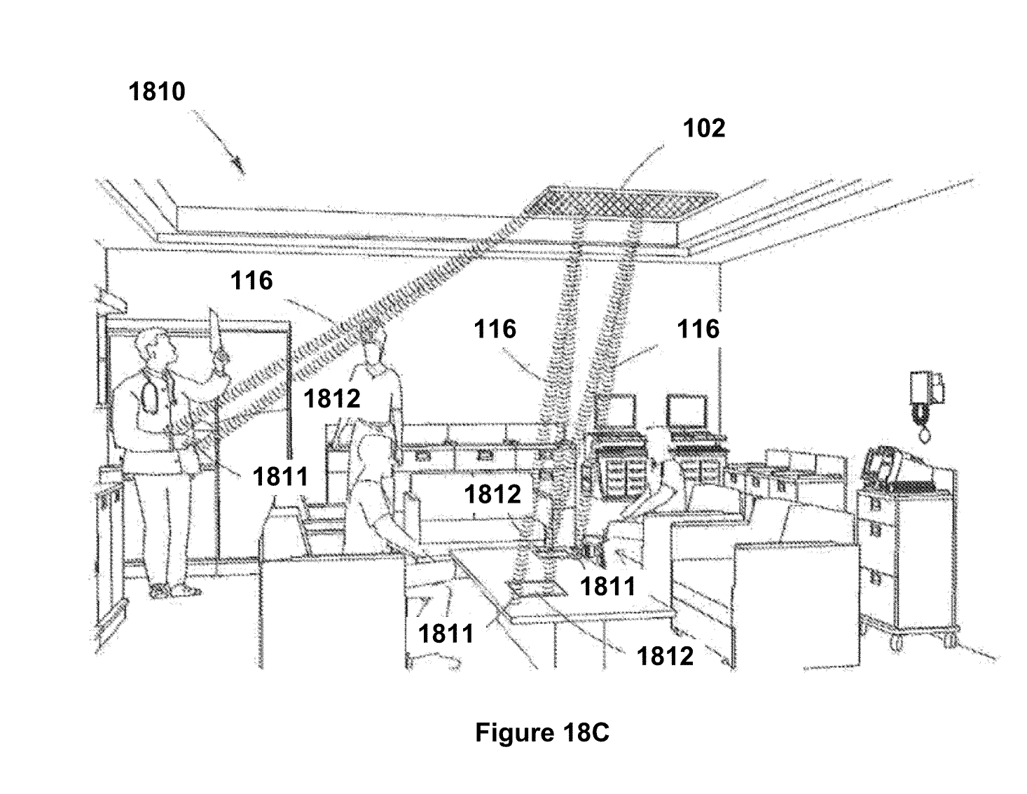

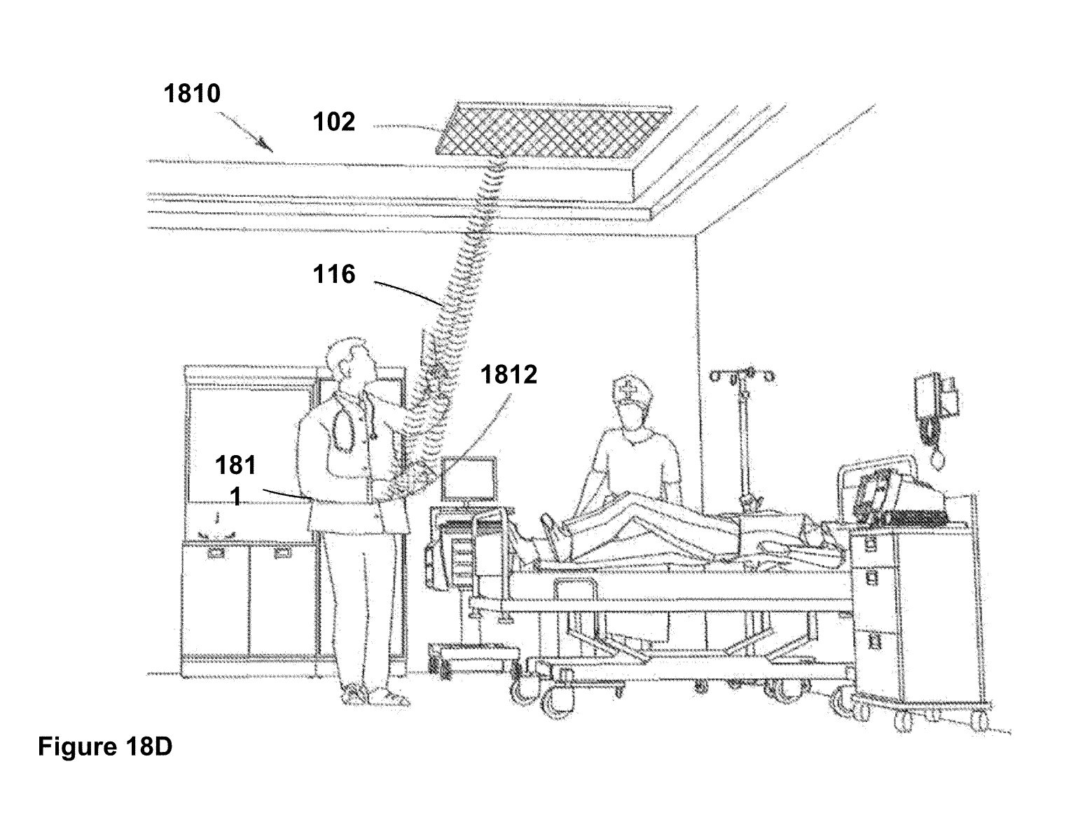

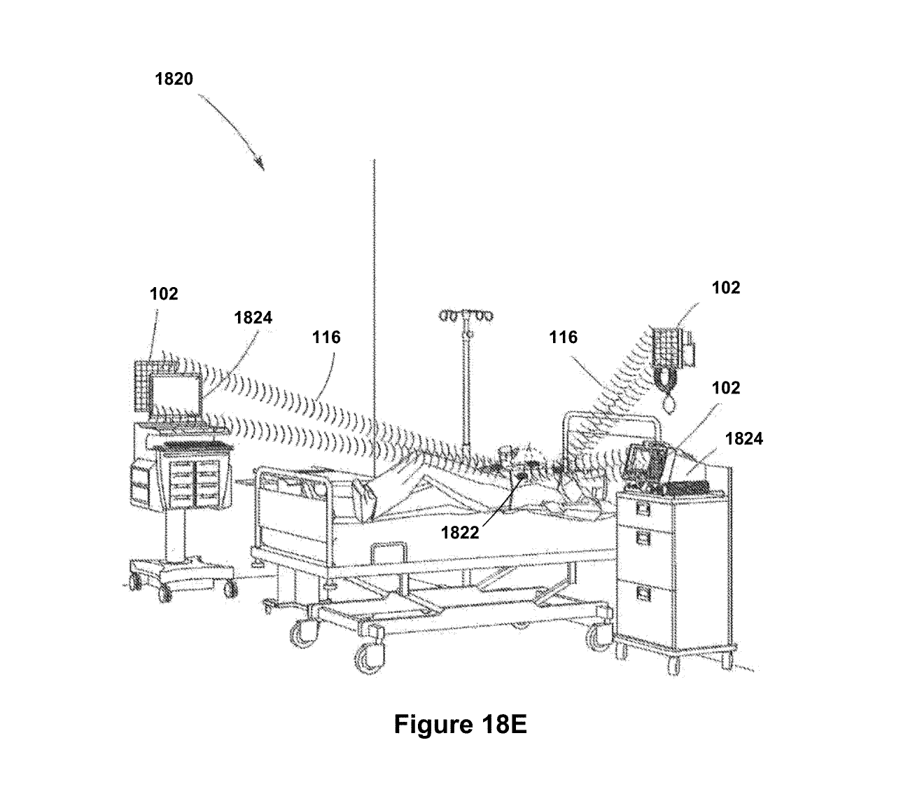

Various embodiments of the receiver 120 are also illustrated and described herein. For example, an embodiment of the receiver 120 is connected to a wireless power tool (e.g., as shown in FIGS. 6A-6C and described below), another embodiment of the receiver 120 is embedded in a military uniform (e.g., as shown in FIGS. 10A-10B and described below), and yet another embodiment of the receiver 120 is embedded in medical devices (e.g., as shown in FIGS. 18A-18C and described below).

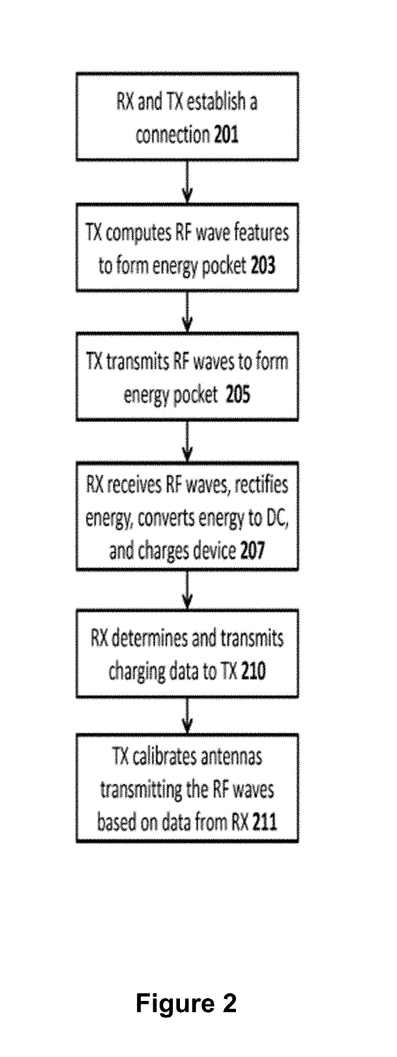

FIG. 2 provides an example flowchart of a process for wireless power transmission, in accordance with some embodiments.

In a first step 201, a transmitter 102 (TX) establishes a connection or otherwise associates with a receiver 120 (RX). That is, in some embodiments, transmitters and receivers may communicate with one another over a wireless communication protocol capable of transmitting information between two processors of electrical devices (e.g., BLUETOOTH, BLUETOOTH Low Energy (BLE), WI-FI, NFC, ZIGBEE). For example, in embodiments implementing BLUETOOTH or BLUETOOTH variants, the transmitter may scan for receivers broadcasting advertisement signals or a receiver may transmit an advertisement signal to the transmitter. The advertisement signal may announce the receiver's presence to the transmitter, and may trigger an association between the transmitter and the receiver. As described herein, in some embodiments, the advertisement signal may communicate information that may be used by various devices (e.g., transmitters, client devices, server computers, other receivers) to execute and manage pocket-forming procedures. Information contained within the advertisement signal may include a device identifier (e.g., MAC address, IP address, UUID), the voltage of electrical energy received, client device power consumption, and other types of data related to power transmission. The transmitter may use the advertisement signal transmitted to identify the receiver and, in some cases, locate the receiver in a two-dimensional space or in a three-dimensional space. Once the transmitter identifies the receiver, the transmitter may establish the connection associated in the transmitter with the receiver, allowing the transmitter and receiver to communicate control signals over a second channel. The advertising signal is an example of the communication signal 118 (FIG. 1).

In a next step 203, the transmitter may use the advertisement signal to determine waveform characteristics (discussed above) for transmitting the power transmission signals, to then establish the pockets of energy. The transmitter may use information contained in the receiver's advertisement signal, or in subsequent control/feedback signals received from the receiver, to determine how to produce and transmit the power transmission signals so that the receiver may receive the power transmission signals. In some cases, the transmitter may transmit power transmission signals in a way that establishes a pocket of energy, from which the receiver may harvest electrical energy. In some embodiments, the transmitter may include a processor 104 executing software modules capable of automatically identifying the power transmission signal features needed to establish a pocket of energy based on information received from the receiver, such as the voltage of the electrical energy harvested by the receiver from the power transmission signals. It should be appreciated that in some embodiments, the functions of the processor and/or the software modules may be implemented in an Application Specific Integrated Circuit (ASIC).

Additionally or alternatively, in some embodiments, the advertisement signal or a subsequent signal transmitted by the receiver over a second communications channel may indicate one or more waveform characteristics (also referred to herein as power transmission signals features), which the transmitter may then use to produce and transmit power transmission signals to establish a pocket of energy. For example, in some cases the transmitter may automatically identify the phase and gain necessary for transmitting the power transmission signals based on the location of the device and the type of device or receiver; and, in some cases, the receiver may inform the transmitter of the phase and gain for effectively transmitting the power transmission signals.

In a next step 205, after the transmitter determines the appropriate waveform characteristics to use when transmitting the power transmission signals, the transmitter may begin transmitting power transmission signals, over a separate channel from the signals (e.g., power waves 116 are distinct from the communication signals 118, FIG. 1). Power transmission signals may be transmitted to establish a pocket of energy. The transmitter's antenna elements may transmit the power transmission signals such that the power transmission signals converge in a two-dimensional or three-dimensional space around the receiver. The resulting field around the receiver forms a pocket of energy from which the receiver may harvest electrical energy. One antenna element may be used to transmit power transmission signals to establish two-dimensional energy transmissions; and in some cases, a second or additional antenna element may be used to transmit power transmission signals in order to establish a three-dimensional pocket of energy. In some cases, a plurality of antenna elements may be used to transmit power transmission signals in order to establish the pocket of energy. Moreover, in some cases, the plurality of antennas may include all of the antennas in the transmitter; and, in some cases, the plurality of antennas may include a number of the antennas in the transmitter, but fewer than all of the antennas of the transmitter. Various techniques for transmitting power transmission signals are discussed in further detail above with reference to FIG. 1.

As previously mentioned, the transmitter 102 may produce and transmit power transmission signals, according to a determined set of power transmission signal features. In some embodiments, the power transmission signals are produced and transmitted using an external power source and a local oscillator chip comprising a piezoelectric material. The transmitter may include a controller circuit (e.g., an RFIC) that controls production and transmission of the power transmission signals based on information related to power transmission and pocket-forming received from the receiver. This control data may be communicated over a different channel from the power transmission signals, using wireless communications protocols, such as BLE, NFC, or ZIGBEE®. The RFIC of the transmitter may automatically adjust the phase and/or relative magnitudes of the power transmission signals as needed. Pocket-forming is accomplished by the transmitter transmitting the power transmission signals in a manner that forms constructive interference patterns.

In a next step 207, the receiver may harvest or otherwise receive electrical energy from the power transmission signals of a single beam or a pocket of energy. The receiver may include a rectifier and AC/DC converter (e.g., power converters 126, FIG. 1), which may convert the electrical energy from AC current to DC current, and the rectifier of the receiver may then rectify the electrical energy, resulting in useable electrical energy for a client device associated with the receiver, such as a laptop computer, smartphone, battery, toy, or other electrical device. The receiver may utilize the pocket of energy produced by the transmitter during pocket-forming to charge or otherwise power the electronic device. Receiving the power transmission signals is discussed in further detail above with reference to FIG. 1.

In next step 210, the receiver may generate data containing information indicating the effectiveness of the single beam or energy pockets providing the receiver power transmission signals. The receiver may then transmit control/feedback signals containing the data to the transmitter. The control/feedback signal is an example of the communication signals 118. The control signals may be transmitted intermittently, depending on whether the transmitter and receiver are communicating synchronously (i.e., the transmitter is expecting to receive control data from the receiver). Additionally, the transmitter may continuously transmit the power transmission signals to the receiver, irrespective of whether the transmitter and receiver are communicating control signals. The data may contain information related to transmitting power transmission signals and/or establishing effective pockets of energy. Some of the information in the control data may inform the transmitter how to effectively produce and transmit, and in some cases adjust, the features of the power transmission signals. The control signals may be transmitted and received over a second channel, independent from the power transmission signals, using a wireless protocol capable of transmitting control data related to power transmission signals and/or pocket-forming, such as BLE, NFC, WI-FI, or the like.

As mentioned, the data may contain information indicating the effectiveness of the power transmission signals of the single beam or establishing the pocket of energy. The data may be generated by a processor of the receiver monitoring various aspects of the receiver and/or the client device associated with the receiver. The data may be based on various types of information, such as the voltage of electrical energy received from the power transmission signals, the quality of the power transmission signals reception, the quality of the battery charge or quality of the power reception, and location or motion of the receiver, among other types of information useful for adjusting the power transmission signals and/or pocket-forming.

In some embodiments, a receiver may determine the amount of power being received from power transmission signals transmitted from the transmitter and may then indicate that the transmitter should “split” or segment the power transmission signals into less-powerful power transmission signals. The less-powerful power transmission signals may be bounced off objects or walls nearby the device, thereby reducing the amount of power being transmitted directly from the transmitter to the receiver.

In a next step 211, the transmitter may calibrate the antennas transmitting the power transmission signals, so that the antennas transmit power transmission signals having a more effective set of features (e.g., direction, phase, gain, amplitude). In some embodiments, a processor of the transmitter may automatically determine more effective features for producing and transmitting the power transmission signals based on the signal(s) received from the receiver. The transmitter may then automatically reconfigure the antennas to transmit recalibrated power transmission signals according to the newly determined more-effective features. For example, the processor of the transmitter may adjust gain and/or phase of the power transmission signals, among other features of power transmission feature, to adjust for a change in location of the receiver, after a user moved the receiver outside of the three-dimensional space where the pocket of energy is established.

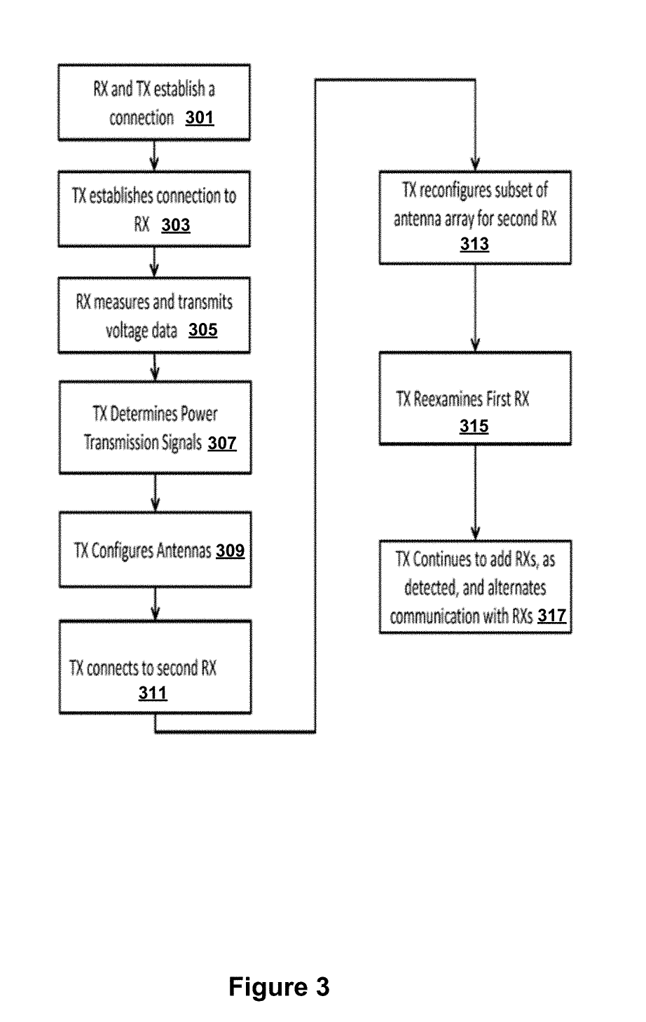

FIG. 3 provides an example flowchart of a process for wirelessly powering a plurality of receivers, in accordance with some embodiments. For the sake of brevity, features already described above with reference to FIGS. 1 and 2 are not repeated here.

In a first step 301, a transmitter 102 (TX) establishes a connection or otherwise associates with a receiver 120 (RX), as discussed above. The transmitter may scan for receivers broadcasting advertisement signals or a receiver may transmit an advertisement signal to the transmitter. The advertisement signal may announce the receiver's presence to the transmitter, and may trigger an association between the transmitter and the receiver.

Next, in step 303, when the transmitter detects the advertisement signal, the transmitter may automatically form a communication connection with that receiver, which may allow the transmitter and receiver to communicate control signals and power transmission signals. The transmitter may then command that receiver to begin transmitting real-time sample data or other data. The transmitter may also begin transmitting power transmission signals from antennas of the transmitter's antenna array.

In a next step 305, the receiver may then measure the voltage, among other metrics related to effectiveness of the power transmission signals, based on the electrical energy received by the receiver's antennas. The receiver may generate data containing the measured information, and then transmit control signals (e.g., communication signals 118, FIG. 1) containing the data to the transmitter. For example, the receiver may sample the voltage measurements of received electrical energy, for example, at a rate of 100 times per second. The receiver may transmit the voltage sample measurement back to the transmitter, 100 times a second, in the form of control signals.

In a next step 307, the transmitter may execute one or more software modules monitoring the metrics, such as voltage measurements, received from the receiver. Algorithms may vary production and transmission of power transmission signals by the transmitter's antennas, to maximize the effectiveness of the pockets of energy around the receiver. For example, the transmitter may adjust the phase at which the transmitter's antennas transmit the power transmission signals, until that power received by the receiver indicates establishment of a pocket of energy around the receiver. When an optimal configuration for the antennas is identified, memory 106 of the transmitter may store the configurations to keep the transmitter broadcasting at that highest level.

In a next step 309, algorithms of the transmitter may determine when it is necessary to adjust the power transmission signals and may also vary the configuration of the transmit antennas, in response to determining such adjustments are necessary. For example, the transmitter may determine the power received at a receiver is less than maximal, based on the data received from the receiver. The transmitter may then automatically adjust the phase of the power transmission signals, but may also simultaneously continue to receive and monitor the voltage being reported back from receiver.

In a next step 311, after a determined period of time for communicating with a particular receiver, the transmitter may scan and/or automatically detect advertisements from other receivers that may be in range of the transmitter. The transmitter may establish a connection to the second receiver responsive to, e.g., BLUETOOTH advertisements, from a second receiver.

In a next step 313, after establishing a second communication connection with the second receiver, the transmitter may proceed to adjust one or more antennas in the transmitter's antenna array. In some embodiments, the transmitter may identify a subset of antennas to service the second receiver, thereby parsing the array into subsets of arrays that are associated with a respective receiver. In some embodiments, the entire antenna array may service a first receiver for a given period of time, and then the entire array may service the second receiver for that period of time.

Manual or automated processes performed by the transmitter may select a subset of arrays to service the second receiver. In this example, the transmitter's array may be split in half, forming two subsets. As a result, half of the antennas may be configured to transmit power transmission signals to the first receiver, and half of the antennas may be configured for the second receiver. In the current step 313, the transmitter may apply similar techniques discussed above to configure or optimize the subset of antennas for the second receiver. While selecting a subset of an array for transmitting power transmission signals, the transmitter and second receiver may be transmitting and receiving data. As a result, by the time that the transmitter alternates back to communicating with the first receiver and/or scan for new receivers, the transmitter has already received a sufficient amount of sample data to adjust the phases of the waves transmitted by the second subset of the transmitter's antenna array to transmit power transmission waves to the second receiver effectively.

In a next step 315, after adjusting the second subset to transmit power transmission signals to the second receiver, the transmitter may alternate back to communicating data with the first receiver, or scanning for additional receivers. The transmitter may reconfigure the antennas of the first subset, and then alternate between the first and second receivers at a predetermined interval.

In a next step 317, the transmitter may continue to alternate between receivers and scanning for new receivers, at a predetermined interval. As each new receiver is detected, the transmitter may establish a connection and begin transmitting power transmission signals, accordingly.

In one example embodiment, the receiver may be electrically connected to a device like a smart phone. The transmitter's processor would scan for any BLUETOOTH devices. The receiver may begin advertising that it's a BLUETOOTH device through the BLUETOOTH chip (e.g., broadcasting advertising signals). The advertising signal may include unique identifiers so that the transmitter, when it scanned that advertisement, could distinguish that advertisement and ultimately that receiver from all the other BLUETOOTH devices nearby within range. When the transmitter detects that advertisement and notices it is a receiver, then the transmitter may immediately form a communication connection with that receiver and command that receiver to begin sending real time sample data.

The receiver would then measure the voltage at its receiving antennas, and send that voltage sample measurement back to the transmitter (e.g., 100 times a second). The transmitter may start to vary the configuration of the transmit antennas by adjusting the phase. As the transmitter adjusts the phase, the transmitter monitors the voltage being sent back from the receiver. In some implementations, the higher the voltage, the more energy may be in the pocket. The antenna phases may be altered until the voltage is at the highest level and there is a maximum pocket of energy around the receiver. The transmitter may keep the antennas at the particular phase so the voltage is at the highest level.

The transmitter may vary each individual antenna, one at a time. For example, if there are 32 antennas in the transmitter, and each antenna has 8 phases, the transmitter may begin with the first antenna and would step the first antenna through all 8 phases. The receiver may then send back the power level for each of the 8 phases of the first antenna. The transmitter may then store the highest phase for the first antenna. The transmitter may repeat this process for the second antenna, and step it through 8 phases. The receiver may again send back the power levels from each phase, and the transmitter may store the highest level. Next the transmitter may repeat the process for the third antenna and continue to repeat the process until all 32 antennas have stepped through the 8 phases. At the end of the process, the transmitter may transmit the maximum voltage in the most efficient manner to the receiver.

In another example embodiment, the transmitter may detect a second receiver's advertisement and form a communication connection with the second receiver. When the transmitter forms the communication with the second receiver, the transmitter may aim the original 32 antennas towards the second receiver and repeat the phase process for each of the 32 antennas aimed at the second receiver. Once the process is completed, the second receiver may receive as much power as possible from the transmitter. The transmitter may communicate with the second receiver for a period of time (e.g., a second), and then alternate back to the first receiver for a period of time (e.g., a second), and the transmitter may continue to alternate back and forth between the first receiver and the second receiver at the time period intervals.

In yet another implementation, the transmitter may detect a second receiver's advertisement and form a communication connection with the second receiver. First, the transmitter may communicate with the first receiver and re-assign half of the example 32 the antennas aimed at the first receiver, dedicating only 16 towards the first receiver. The transmitter may then assign the second half of the antennas to the second receiver, dedicating 16 antennas to the second receiver. The transmitter may adjust the phases for the second half of the antennas. Once the 16 antennas have gone through each of the 8 phases, the second receiver may be receiving the maximum voltage in the most efficient manner.

FIGS. 4A-4D illustrate in-vehicle wireless power transmission systems, in accordance with some embodiments.

Referring to FIG. 4A, a wireless power transmitter system 400 can be implemented in order to charge or power one or more electronic devices 401 (e.g., an embodiment of the electronic device 122, FIG. 1) inside a vehicle. According to some aspects of this embodiment, transmitter 102 can be configured within a cylindrical shape, exhibiting a longitude between about 2 and 3 inches, and a diameter ranging from about 0.5 inch to about 1 inch. As illustrated in close-up view 402, transmitter 102 can include a suitable connector 404 with pins 406 that can be inserted into car lighter socket 408 for powering transmitter 102. Transmitter 102 can function as a standalone, self-contained device that can integrate circuitry module 414 and antenna array 412 (e.g., an embodiment of the antenna array 110, FIG. 1), along with connector 404 and pins 406.

Car lighter socket 408 can supply 12 or 24 DC volts for powering transmitter 102, which may be sufficient power for most portable electronic devices 401 such as smartphones, DVD players, portable gaming systems, tablets, laptops computers, and the like. In some embodiments, circuitry module 414 of transmitter 102 can include a DC-to-DC converter or a DC-to-AC converter, depending on the electrical charging requirements of electronic device 401. Yet in other embodiments, circuitry module 414 can include a switchable power converter that can be configured according to the charging requirements of electronic device 401.

Operation of transmitter 102 in FIG. 4A can be driven by a power source, in this case, car lighter socket 308. Transmitter 102 can use communication component 112 (not shown in FIG. 4A) in circuitry module 414 to locate a receiver 120 (not shown in FIG. 4A) embedded in electronic device 401. Processor(s) 104 (not shown in FIG. 4A) which may be included in circuitry module 414 of the transmitter 102 may determine the optimum path for the generation of pocket-forming, according to the location of electronic device 401 within the vehicle. As depicted in FIG. 4A, electronic device 401 can be located in the passenger seat, right beside the driver seat. Processors 104 may communicate with a radio frequency integrated circuit in circuitry module 414 so as to control the generation and transmission of RF waves 116 through antenna array 412 which may include two or more antenna elements. Transmission of RF waves 116 can be aimed at electronic device 401 in the passenger seat for the generation of pocket-forming suitable for charging or powering electronic device 401.

The wireless power transmission system 400 can also be used for powering or charging an electronic device 401 located in the backseats of the vehicle, or any other locations inside vehicle. In this case, transmitter 102 can use any suitable reflecting surface of the vehicle, preferably metallic, in order to transmit RF waves 116 and redirect the formation of pockets of energy towards electronic device 401, with minimal or no power loss. For example, transmitter 102 can use the vehicle ceiling to bounce off transmitted RF waves 116 towards electronic device 401 for the generation of pockets of energy capable of providing suitable charging or powering to electronic device 401.

In some embodiments, the wireless power transmission 400 powers or charges two or more electronic devices 401 inside vehicle, where transmitter 102 can be capable of producing multiple pocket forming. In such case, transmitter 102 can generate multiple RF waves 116 directly aimed at or reflected towards electronic devices 401 through the use of suitable reflecting surfaces of the vehicle, thereby powering or charging one or more electronic devices 401 at the same time.

FIG. 4B illustrates a wireless power transmission system 420 where transmitter 102 includes a cable 422 for positioning antenna array 412 in different areas inside a vehicle. As seen in close-up view 421, transmitter 102, through the use of connector 404 and pins 406, can be connected to car lighter socket 408 to receive power necessary for operation. According to some aspects of this embodiment, circuitry module 414 of transmitter 102 can be operatively coupled with car lighter socket 408, while antenna array 412 can be operatively connected with circuitry module 414 through cable 422, thereby allowing antenna array 412 to be separately positioned across vehicle, as required by the application or according to the relative position of one or more electronic devices 401. For example, as shown in FIG. 4B, cable 422 can be run from circuitry module 414 to antenna array 412 which can be slipped in one of the vehicle's sun visor 424. In this way, antenna array 412 can emit RF waves 116 from a high-up position down to one or more electronic devices 401 for the generation of pockets of energy that may provide suitable charging or powering. This configuration may be particularly beneficial for charging or powering electronic devices 401 in the vehicle's backseats.

Antenna array 412 in FIG. 4B can exhibit a flat rectangular shape, with dimensions between about 4×2 inches to about 8×4 inches, depending on the number and configuration of antenna elements 412. Cable 422 can include a suitable conductor covered by an insulating material, it may be flexible and may exhibit a suitable length as required by the application. Preferably, cable 422 can be positioned between circuitry module 414 of transmitter 102 and antenna array 412 in such a way as to not obstruct the visibility of the windshield, as illustrated in FIG. 4B.

Referring now to FIG. 4C, a wireless power transmission system 430 includes a transmitter 102 with its circuitry module 414 connected to car lighter socket 408, while its antenna array 412 can be positioned on the vehicle's floor 432. Similarly as in FIG. 4B, antenna array 412 may exhibit a flat rectangular shape with dimensions between about 4×2 inches to about 8×4 inches, depending on the number and configuration of antenna elements. According to some aspects of this embodiment, antenna array 412 can be covered by the vehicle floor mats (not shown in FIG. 4C), where this antenna array 412 can emit RF waves 116 from the bottom of the vehicle floor 432 upwards to one or more electronic devices 401 that may be positioned in the passenger seat, as illustrated in FIG. 4C, or in any another suitable location within the vehicle.

Similarly as in FIG. 4B, cable 422 can operatively connect circuitry module 414 (not shown in FIG. 4C) to antenna array 412 for the transmission of RF waves 116 that may produce pockets of energy suitable for charging or powering one or more electronic devices 401 inside the vehicle. In this particular embodiment, antenna array 412 may include a suitable combination of flexible and conducting materials that may allow transmission of RF waves 116, while avoiding fractures or breakdown when a passenger steps on antenna array 412 placed underneath the vehicle's floor 432 mats.

Although these example embodiments of wireless power transmission may describe transmitter 102 as a standalone device that may be connected to a car lighter socket 408, including the different configurations and positions for its antenna array 412, other transmitter 102 configurations and features may be contemplated as well. For example, antenna array 412 of transmitter 102 may be positioned in any suitable areas inside the vehicle such as passenger seats and backseats, storage compartments, and center console among others. In other embodiments, transmitter 102 may be configured as a built-in device that may be factory-integrated in suitable areas or parts of the vehicle such as sun-visors, sunroofs, sound speakers, dashboards, and the like.

FIG. 4D shows a simplified flowchart of a wireless power transmission process 440 that may be implemented for charging one or more electronic devices 401 inside a vehicle. This process may be applicable in the embodiments of the wireless power transmission systems 400, 420, and 430.

The wireless power transmission process 440 may begin with a wireless charging request, at block 442. Subsequently, transmitter 102 may perform a BLUETOOTH scanning for identifying any suitable electronic device 401 that may require wireless charging or powering, at block 444. Specifically, this BLUETOOTH scanning may be carried out by a communication component integrated in circuitry module 414 of transmitter 102.

Using BLUETOOTH scanning, transmitter 102 may determine if there are one or more electronic devices 401 available for charging or powering, at block 446. Basically, any suitable electronic device 401 operatively coupled with a receiver 120 and capable of BLUETOOTH communication may be considered “available” for wireless charging or powering. If there are no available electronic devices 401 for wireless charging or powering, then BLUETOOTH scanning can be repeated until there is at least one electronic device 401 available. If one or more electronic devices 401 are available, then wireless power transmission process 440 may continue at block 448, where one or more electronic devices 401 may log into a charging application developed in any suitable operating systems such as iOS, ANDROID, and WINDOWS, among others. This charging application may establish a suitable communication channel between transmitter 102 and electronic device 401, where configuration of transmitter 102 can be accessed and reprogrammed according to the charging or powering requirements of electronic devices 401.

One or more electronic devices 401 may access the charging application in order to modify the configuration of transmitter 102. Specifically, one or more electronic devices 401 can communicate with transmitter 102 via BLUETOOTH and log into the charging application to set up charging or powering priorities as necessary, at block 450. For example, in a long family trip, charging or powering priorities can be established to first charge or power-up electronic devices 401 for kids' entertainment such as portable gaming consoles and tablets, followed by the charging or powering of parents' electronic devices 401 such as smartphones and laptops. Other transmitter 102 parameters such as power intensity and pocket-forming focus/timing can also be modified through the use of this charging application. However, authorization access to transmitter 102 configuration may be restricted to certain users who may be required to provide corresponding user-credentials and passwords.

After charging priorities in transmitter 102 are set, transmission of RF waves 116 towards the designated electronic devices 401 can begin, at block 452, where these RF waves 116 may generate pockets of energy at receivers 120 for powering or charging one or more electronic devices 401 sequentially or simultaneously. In other embodiments, different charging or powering thresholds may be established for maintaining suitable operation. For example, minimum and maximum charging thresholds may be established at about 20% and 95% of total charge respectively, where charging or powering of electronic devices 401 may be stopped when reaching 95% of total charge, and may resume when total charge of electronic devices 401 falls below 20%.

BLUETOOTH scanning may continue throughout the process in order to identify additional electronic devices 401 that may require wireless charging or powering, at block 454. If new or additional electronic devices 401 are identified, then transmitter 102 may be accessed through the charging application to set charging or powering priorities for these additional electronic devices 401. If no further electronic devices 401 are recognized by BLUETOOTH scanning, then wireless power transmission process 440 may end, at block 456.

FIGS. 4A-4D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 4A-4D.

Presented below are example methods of wirelessly delivering power to receivers in a vehicle.

In some embodiments, an example method includes defining, by a transmitter, a pocket of energy positioned within a vehicle, and the vehicle includes the transmitter and a power source powering the transmitter. The method further includes charging, by the transmitter, an electronic device positioned within the vehicle, and the electronic device includes a receiver that interfaces with the pocket of energy in the vehicle.

In some embodiments, the power source includes at least one of a vehicle lighter socket and a direct connection to a power wire within the vehicle.

In some embodiments, the electronic device is a first electronic device and the transmitter charges a second electronic device positioned within the vehicle based on the second device interfacing with the pocket of energy in the vehicle.

In some embodiments, another example method includes scanning, using a wireless communication component of a transmitter, for available receivers within a vehicle that are authorized to receive wirelessly delivered power from the transmitter and detecting, by the transmitter, a first receiver and a second receiver of the available receivers within the vehicle based on the scanning. The method further includes, while continuing to scan for available receivers within the vehicle: (i) receiving, by a connector of the transmitter, where the connector is coupled to a power source of the vehicle, electrical current from the power source that is used by the transmitter to generate a plurality of power waves, (ii) receiving, by the wireless communication component of the transmitter, a charging request from the second receiver within the vehicle, (iii) adjusting, by a controller of the transmitter, respective gains and phases of at least a second set of the plurality of power waves, and (iv) transmitting the second set of the plurality of power waves such that the second set of the plurality of power waves converge to form a second constructive interference pattern, distinct from the first constructive interference pattern, in proximity to a location of the second receiver within the vehicle.

In some embodiments, the charging request (i) corresponds to a request for wirelessly delivered power from the transmitter, and (ii) is sent by the second receiver when a charge level of the second receiver is less than a minimum level of charge.

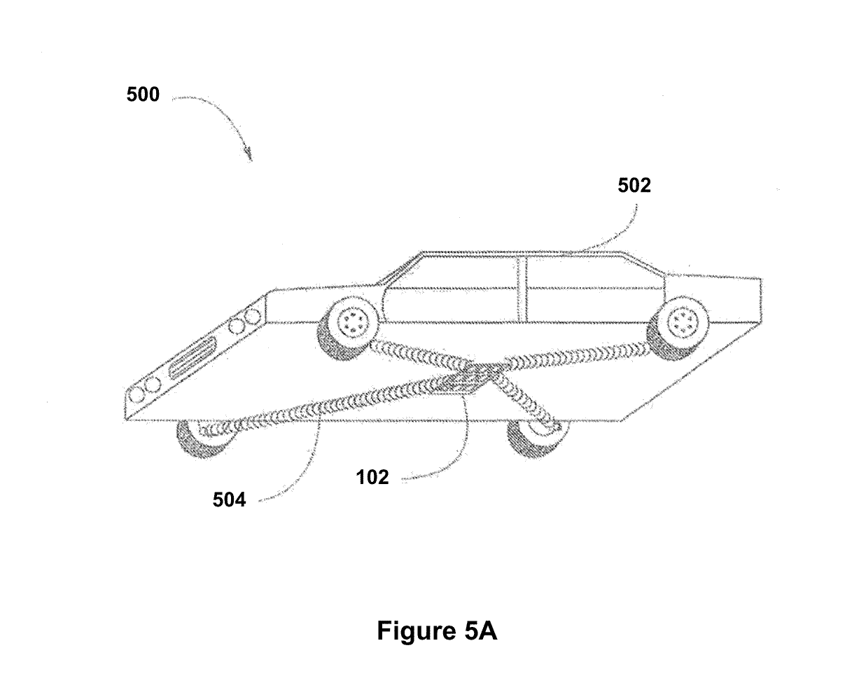

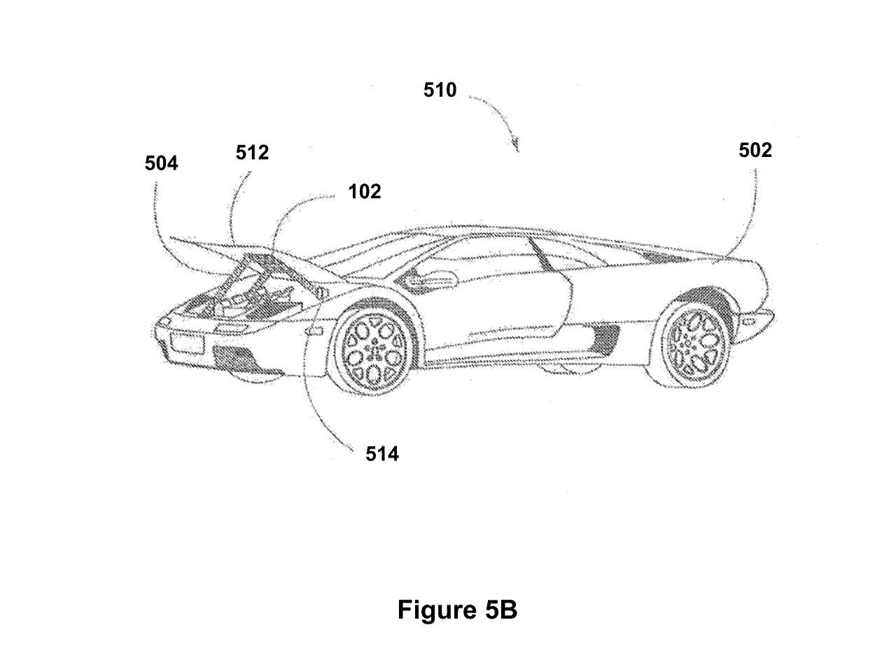

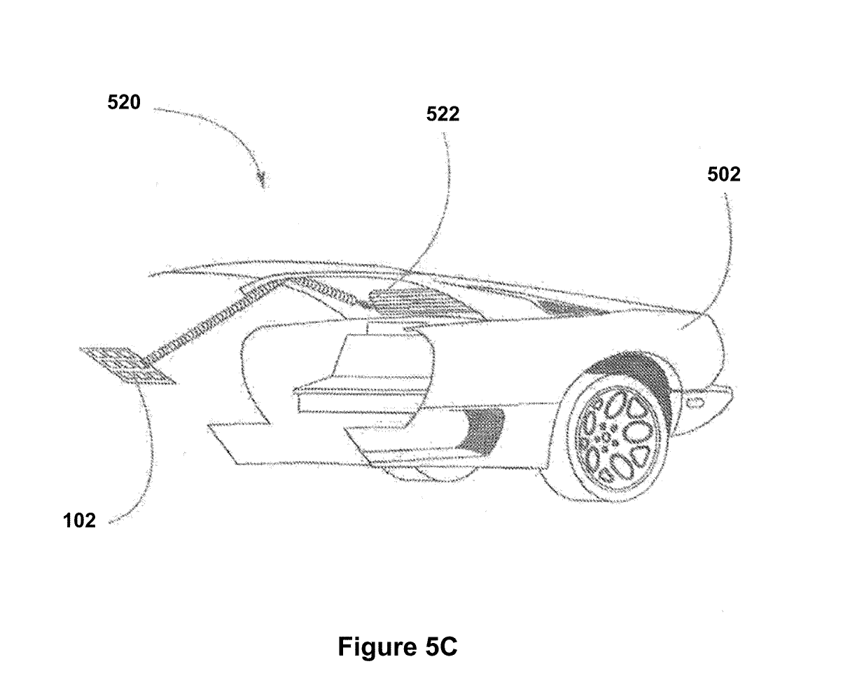

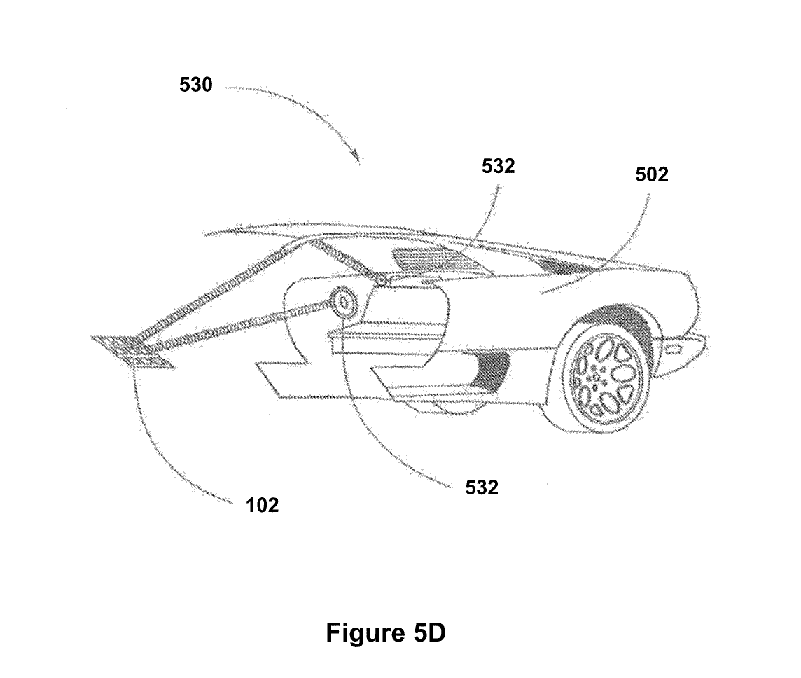

FIGS. 5A-5D illustrate additional embodiments of wireless power transmission systems associated with vehicles, in accordance with some embodiments.

FIG. 5A illustrates a wireless power transmission system 500 where a transmitter 102 may provide wireless power, through pocket-forming, to sensors in the bottom part of a car 502. Transmitter 102 can be placed in the bottom of car 502, and may power, for example, tire pressure gauges, brake sensors and the like. The foregoing gauges and sensors may include embedded or otherwise operatively coupled receivers (not shown) (e.g., an embodiment of the receiver 120, FIG. 1) for converting pockets of energy into usable energy. Even though the paths of RF waves 504 appear to be in straight lines, transmitter 102 can bounce RF waves 504 off of suitable reflecting areas of car 502 to improve power delivery efficiency. One of the main advantages of the foregoing disclosed configuration of the wireless power transmission system 500 may be the cost-effective solution of eliminating the wires required for powering the aforementioned sensors in the bottom of car 502.

FIG. 5B illustrates a wireless power transmission system 510 where a transmitter 102 may provide wireless power, through pocket-forming, to sensors in the engine compartment of a car 502. Transmitter 102 can he placed in the bottom internal surface of a hood 512 (or other suitable locations) of car 502 in order to power engine sensors such as throttle position sensors, engine coolant temperature sensors, barometric sensors and the like. The transmitter 102 can use reflecting areas from the engine compartment of car 502 to bounce off RF waves 504 (e.g., power waves 116, FIG. 1) to improve power delivery efficiency. In some embodiments, transmitter 102 can be used to power the sensors present in typical alarm systems, for example, door sensors, pressure sensors (for the interior of car 502), shock sensors and the like. In other embodiments, transmitter 102 can function as an alternate or main power supply for alarm speakers 514.

FIG. 5C illustrates a wireless power transmission system 520 where a transmitter 102 may provide wireless power, through pocket-forming, to sensors, gauges or small miscellaneous devices in the interior of a car 502. In some embodiments, transmitter 102 can be placed in the instrument panel (not shown) of car 502. In this particular embodiment, transmitter 102 is shown to be powering a rear window defroster 522 of car 504, and thus diminishing the need for wires. In some embodiments, transmitter 102 can provide power to the actuators in the car windows, and even to the interior lighting system.

FIG. 5D illustrates a wireless power transmission system 530 where a transmitter 102 may provide wireless power, through pocket-forming, to devices in the interior of car 502. In this embodiment, transmitter 102 can provide wireless power to speakers 532 while eliminating the use of wires.

FIGS. 5A-5D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 5A-5D.

Presented below are example systems and methods of wirelessly delivering power to receivers on or within a vehicle.

In some embodiments, an example method includes defining, by a transmitter, a pocket of energy within a vehicle via a plurality of wireless power transmission waves emitted by the transmitter, the vehicle including the transmitter, a receiver, and a vehicle sensor coupled to the receiver. The method further includes interfacing, by the receiver, with the pocket of energy within the vehicle, and providing, by the receiver, power to the vehicle sensor based on the interfacing.

In some embodiments, the vehicle includes a bottom portion, and the transmitter is located in the bottom portion. The sensor is at least one of a tire pressure sensor and a brake sensor.

Alternatively or in addition, in some embodiments, the vehicle includes an engine compartment and the transmitter is located in the engine compartment. In such embodiments, the sensor is an engine sensor.

In some embodiments, an example system includes a vehicle, one or more sensors coupled to the vehicle, and a transmitter coupled to the vehicle (e.g., an exterior of the vehicle). The vehicle is configured to power the transmitter and the transmitter is configured to define a pocket of energy within the vehicle via a plurality of wireless power transmission waves emitted by the transmitter. The system further includes a receiver coupled to the vehicle. The sensor is coupled to the receiver and the receiver is configured to power the sensor by interfacing with the pocket of energy.

FIGS. 6A-6D provide examples of wireless power transmission for wirelessly delivering power to cordless power tools, in accordance with some embodiments.

Referring to FIG. 6A, a wireless power transmission system 600 may include a transmitter 102 embedded in a toolbox 602 to wirelessly charge or power one or more cordless power tools 604, according to an embodiment. Toolbox 602 may be capable of storing and transporting a plurality of cordless power tools 604 and other related tools or components. Transmitter 102 may be embedded in a region or area of toolbox 602 suitable for transmitting RF waves 116 towards receiver 120 which may be attached or operatively coupled to the battery 606 of cordless power tool 604. For example, transmitter 102 may be positioned at the top right corner of toolbox 602 housing to direct RF waves 116 towards receiver 120 for the generation of pockets of energy capable of wirelessly charging the battery 606 of cordless power tool 604. The cordless power tool 604 may be an example of the electronic device 122.

Toolbox 602 may also include a battery 603 which may be operatively coupled with transmitter 102 through a cable (not shown) for allowing the generation and transmission of RF waves 116 as required by the application. Simply put, battery 603 may function as a power source for transmitter 102. In some embodiments, toolbox 602 may be connected to an external power source 608 to charge battery 603 through a suitable cable 610, while simultaneously powering transmitter 102 for the generation and transmission of RF waves 116 directed towards receiver 120, which can be embedded or attached to cordless power tool 604. External power source 608 source may include a 120/220 AC volt outlet, in which case toolbox 602 may include a suitable AC/DC converter (not shown) for converting AC voltage and supplying DC voltage to battery 603 for charging.

In another embodiment, when battery 603 is charged to a suitable level, toolbox 602 may be disconnected from external power source 608, and subsequently carried and positioned in a desired working area where cordless power tool 604 may be used. In this case, transmitter 102 may receive power for the generation and transmission of RF waves 116 solely and directly from battery 603. Charged battery 603 in toolbox 602 may provide enough charge to transmitter 102 for the generation of pockets of energy within a power range of about 1 watt to about 5 watts, and within a working distance of about 5 ft. to about 20 ft. These power levels of pocket of energy may be suitable for charging the battery 606 of cordless power tool 604 while in use, or at least extending the life of battery 606 during operation. In general, the power and range of the generated RF waves 116 may vary according to the number of antenna elements, distribution, and size of transmitter 102. A cordless power tool 604 not in use or in standby can also be charged by a transmitter 102 embedded in toolbox 602.

FIG. 6B shows another configuration of the wireless power transmission system 600. In this configuration, the portable toolbox 602 may be located on or within a vehicle 612, according to an embodiment. Vehicle 612 may be a private car or a service van commonly used by technicians having to perform field work or related activities. Similarly as in FIG. 6A, toolbox 602 may be connected to external power source 608 for charging battery 603 and powering transmitter 102. External power source 608, in this case, may be the battery of vehicle 612. Toolbox 602 may be operatively coupled to external power source 608 through a suitable connection that includes a car lighter socket 614 and cable 616. In order to avoid draining the battery of vehicle 612, engine 618 may be on or running when charging battery 603 or powering transmitter 102 in toolbox 602. In some embodiments, transmitter 102 may generate and direct RF waves 116 towards the receivers 120 embedded or attached to one or more cordless power tools 604 for the wireless charging of batteries 112. Transmitter 102 in toolbox 602 may wirelessly charge or power two or more cordless power tools 604 simultaneously or sequentially according to the power or application requirements. Transmitter 102 in toolbox 602 may also charge a spare battery 620 having a suitable receiver 120 attached.

In some embodiments, when battery 603 in toolbox 602 is charged to a suitable level, toolbox 602 can be disconnected from the car lighter socket 614 and placed at a location outside vehicle 612. Transmitter 102 in toolbox 602 may subsequently generate RF waves 116 which may wirelessly charge or at least extend the life of batteries 606 during the operation of cordless power tools 604, in this case, transmitter 102 may be energized directly from the charged battery 603 in toolbox 602. In some embodiments, a surface area of the antenna array 110 (FIG. 1) of the transmitter 102 embedded in toolbox 602 may range from approximately two in² to about 12 in² depending on the dimensions of toolbox 602.

FIG. 6C illustrates an additional configuration of wireless power transmission system 600. In this configuration, transmitter 102 may be configured in the doors or windows of vehicle 612, according to an embodiment. Specifically, the antenna array of transmitter 102 may be configured to fit one window of vehicle 612. In such a case, the antenna array may include between about 300 and about 600 antenna elements distributed within a surface area that may vary between about 90 in² and about 160 in². This increased number of antenna elements and footprint of transmitter 102 may allow for a higher level of power distribution and reach of the emitted RF waves 116 as compared to the embodiment shown in FIG. 6B. For example, transmitter 102 within the specified dimensions and number of antenna elements may emit RF waves 116 capable of generating a pocket of energy between about 1 Watt and 10 Watts of power, and within a distance of about 30 ft and about 50 ft.

In FIG. 6C, transmitter 102 may be constantly and directly connected to an external power source 608 such as vehicle 612 battery via car lighter socket 614 and cable 616. Engine 618 may be on or running when transmitter 102 is in operation in order to prevent draining of the vehicle's 612 battery. Transmitter 102 may generate and direct RF waves 116 towards the receivers 120 embedded or attached to one or more cordless power tools 604 for the charging of batteries 606. Transmitter 102 may wirelessly charge or power two or more cordless power tools 604 simultaneously or sequentially according to the power or application requirements. Transmitter 102 may also wirelessly charge a spare battery 620 having a suitable receiver 120 attached.

FIG. 6D shows a flowchart of a wireless power transmission process 630 that may be implemented for charging one or more cordless power tools 604 using toolbox 602 as a portable device. This process may be applicable to the embodiments of wireless power transmission systems 600 shown in FIGS. 6A-6C.

Wireless power transmission process 630 may begin by checking the charge levels of battery 603 embedded in toolbox 602, at block 632. This charge check may be performed by a control module included in toolbox 602 (not shown in FIGS. 6A-6B) or by micro-controller (e.g., processor 104, FIG. 1) in transmitter 102, which may be operatively connected to battery 603. Different charging levels for battery 603 may be established for maintaining suitable operation. For example, minimum and maximum charging thresholds may be established at about 25% and 99% of total charge respectively. At block 634, if battery 603 charge is below the minimum threshold or 25%, then toolbox 602 can be connected to external power source 608 using cable 610, where external power source 608 may include vehicle 612 battery or a standard 120/220 AC volts outlet as explained in FIGS. 6A-6B. When battery 603 charge is at 99% or at least above 25%, toolbox 602 can be disconnected from external power source 608, at block 436.

If battery 603 is charged to a suitable level, specifically between about 25% and about 99%, then wireless power transmission process 630 may continue at block 638, where communications component 112 in transmitter 102 may identify one or more cordless power tools 604 that may require wireless charging. Charging or powering priorities and other parameters such as power intensity and pocket-forming focus/timing may be established using a control module included in toolbox 602 or micro-controller in transmitter 102. For example, based on charging or powering priorities, transmitter 102 may be configured to first provide wireless charging to cordless power tools 604 in use, followed by cordless power tools 604 in standby, and lastly to spare batteries 620.

After cordless power tools 604 are identified and charging priorities/parameters in transmitter 102 are set, transmission of RF waves 116 towards the designated cordless power tools 604 or spare batteries 620 can begin, at block 640, where these RF waves 116 may generate pockets of energy at receivers 120 for powering or charging one or more cordless power tools 604 and spare batteries 620 sequentially or simultaneously.

Using communications component 112, transmitter 102 in toolbox 602 may continuously check if there are other cordless power tools 604 or spare batteries 620 that may require wireless charging or powering, at block 642. If new or additional cordless power tools 604 or spare batteries 620 are identified, then transmitter 102 in toolbox 602 may wirelessly charge the identified cordless power tools 604 and spare batteries 620 according to the established charging priorities and parameters. If no further cordless power tools 604 are recognized by communications component 112 in transmitter 102, then wireless power transmission process 630 may end.

FIGS. 6A-6D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 6A-6D.

Presented below are example methods of wirelessly delivering power to cordless power tools.

In some embodiments, an example method includes establishing, by a transmitter, a connection with a power source; generating, by the transmitter, a plurality of power transmission waves to form a pocket of energy; receiving, by the transmitter, a transmission of a power requirement of a cordless power tool and a receiver location; and transmitting, by the transmitter, the power transmission waves through at least two antennas coupled to the transmitter in response to the received transmission.

In some embodiments, the transmitter establishes communication with the receiver when the cordless power to the cordless power tool is within a predetermined distance (e.g., a distance of 10 feet or less) from the transmitter.

In some embodiments, another example method includes establishing, by a transmitter that is coupled to at least two antennas for transmitting power transmission waves to a plurality of cordless power tools, a connection with a power source that is used to charge a battery of the transmitter and determining, by the transmitter, whether the battery has a charge level that is above a threshold charge level. The method further includes, in accordance with determining that the battery has the charge level that is above the threshold charge level, identifying, by a communication component of the transmitter that is distinct from the at least two antennas of the transmitter, a cordless power tool of the plurality of cordless power tools that requires wireless charging. The method further includes receiving, by the communication component of the transmitter, information that identifies a power requirement of the cordless power tool and a location of a receiver that is coupled to the cordless power tool and transmitting, by the transmitter, a plurality of power transmission waves through the at least two antennas in response to the received information, and the plurality of power transmission waves are transmitted so that the plurality of power transmission waves converges to form a pocket of energy in proximity to the location of the receiver.

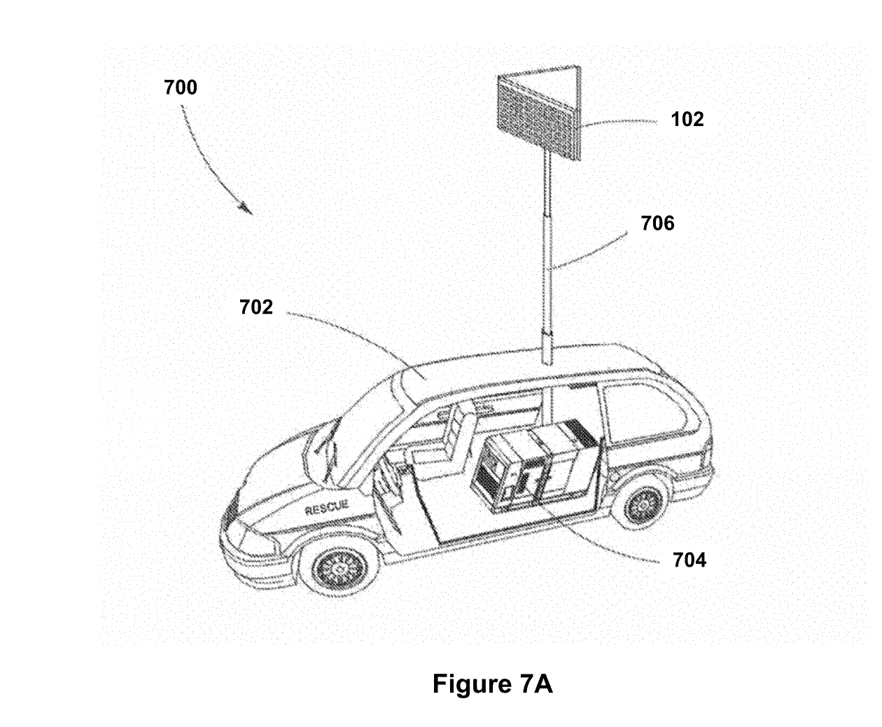

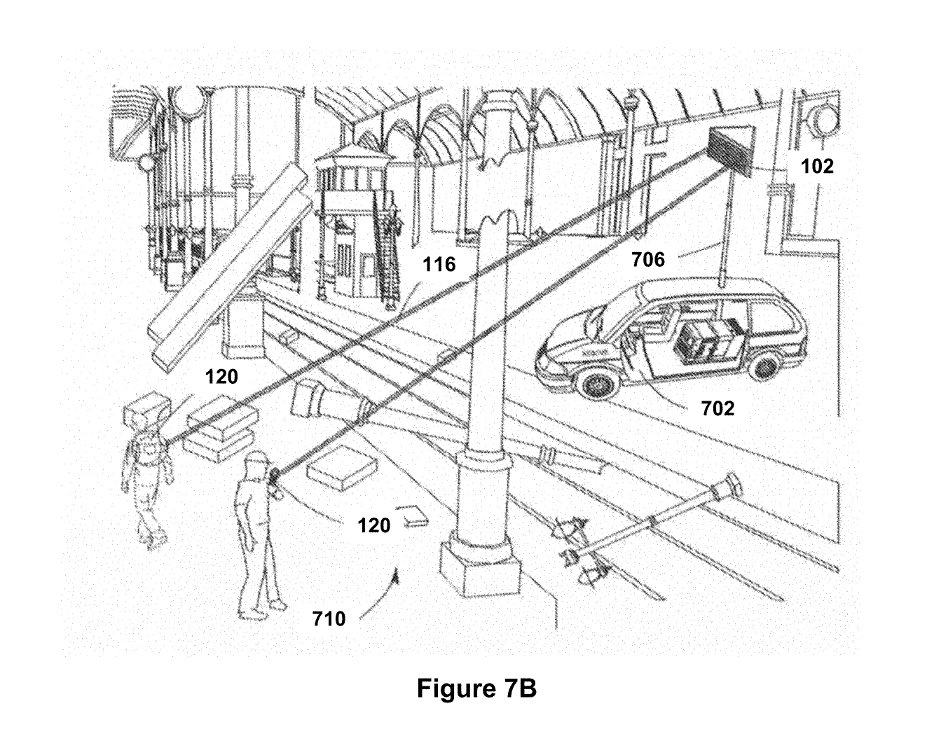

FIGS. 7A-7B illustrate wireless power transmission systems used in rescue situations, in accordance with some embodiments.

FIG. 7A shows a configuration of wireless power transmission system 700 where a transmitter 102 may be located on or within a vehicle 702, according to some embodiments. Vehicle 702 may be a rescue car, fire truck, ambulance and the like. Transmitter 102 may use a diesel generator 704 as power source 210. However, other power sources may be employed too. Transmitter 102 may generate and direct RF waves 116 towards receivers 120 embedded or attached to rescue devices such as lamps, GPS, radios, cellphones, lights, among others. In addition, transmitter 102 in vehicle 702 may wirelessly extend the life of batteries in the previously mentioned devices during the operation.

Transmitter 102 may be located in a telescopic mast 706, which may be lifted up for increased range of wireless powering. Furthermore, other transmitter 102 configurations may be used in dependency of the region and requirements, such requirements may include low profile transmitters for a higher stability of vehicle 702 during gales or winds with high speed.

FIG. 7B illustrates a disaster zone 710, where a rescue vehicle 702 provides power and charge to a variety of rescue devices of a rescue team. Vehicle 702 may include a transmitter 102 located at the top of a telescopic mast 706. RF waves 116 may be transmitted through obstacles and may be reflected on objects for reaching receivers 120.

Receivers 120 may allow tracking of vehicle 702, such a feature may allow the capacity to operate beyond the range of transmitter 102 through the charge on the batteries. When batteries have low charge, receivers 120 may guide its user to vehicle 702 in order to obtain charge.

Vehicle 702 may operate and reach sharper areas than vehicles with a wired power source, such capability is enabled through the wireless power transmission, which allows a higher mobility than cabled power sources.

FIGS. 7A-7B illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 7A-7B.

Presented below are example methods of wirelessly delivering power to rescue devices.

In some embodiments, an example method includes generating power RF signals from a RF circuit connected to the transmitter controlling the generated RF signals with a controller to provide a power RF signal and short RF communication signals; transmitting the power RF and short RF communication signals, through antenna elements connected to the transmitter, capturing power RF signals in a receiver with an antenna connected to the rescue electronic device to convert the pockets of energy into a DC voltage for charging or powering the rescue electronic device; and communicating power requirements of the rescue electronic device and the receiver location information between the pocket-forming transmitter and receiver with the short RF signals.

In some embodiments, the power source is a mobile diesel generator, a mobile gasoline generator or a vehicle generator or battery.

In some embodiments, the transmitter includes a housing suitable for field use, at least two antenna elements, at least one RF integrated circuit, at least one digital signal processor, and a communication component for generating the power RF and short RF signals.

In some embodiments, a telescopic mast connected to the transmitter is used to elevate the transmitter above the clutter at a rescue site.

In some embodiments, the method further includes extending the transmission distance of the pocket-forming transmitter by mounting the pocket-forming transmitter a predetermined height with the telescopic mast connected to a top surface of a vehicle including a fire truck, ambulance, rescue truck or other rescue vehicle.

In some embodiments, another example method includes, at a wireless power transmitter that includes a receiver antenna element, a radio frequency (RF) circuit, and a plurality of transmitter antenna elements, and the wireless power transmitter is connected to a power source and a telescoping mast of a mobile vehicle, the telescoping mast extending in a vertical direction above the mobile vehicle, receiving, via the receiver antenna element, a communication signal from a receiver device positioned at a location within a transmission range of the wireless power transmitter and controlling, via the RF circuit, operation of the plurality of transmitter antenna elements to generate wireless power transmission RF signals having predetermined phases and amplitudes using power from the power source. The method further includes transmitting and steering, via the RF circuit, the wireless power transmission RF signals via the plurality of transmitter antenna elements so that the wireless power transmission RF signals constructively interfere at the location.

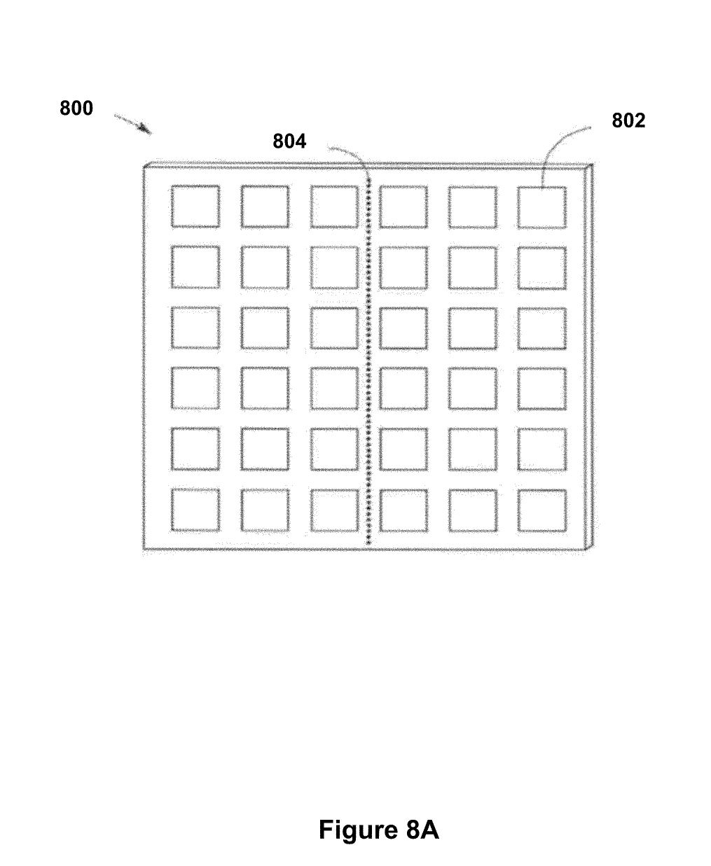

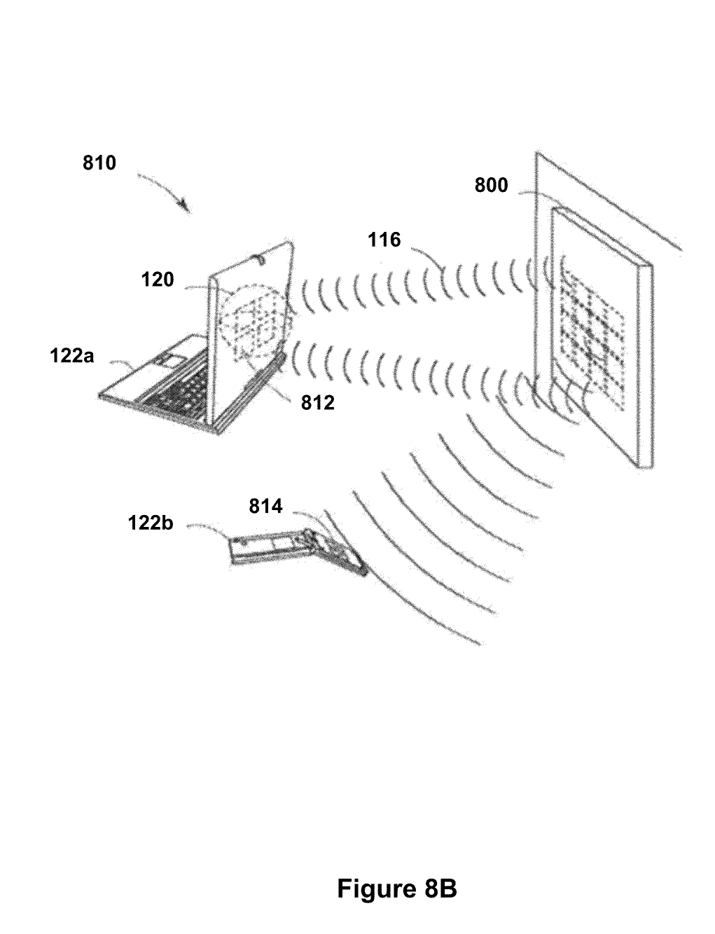

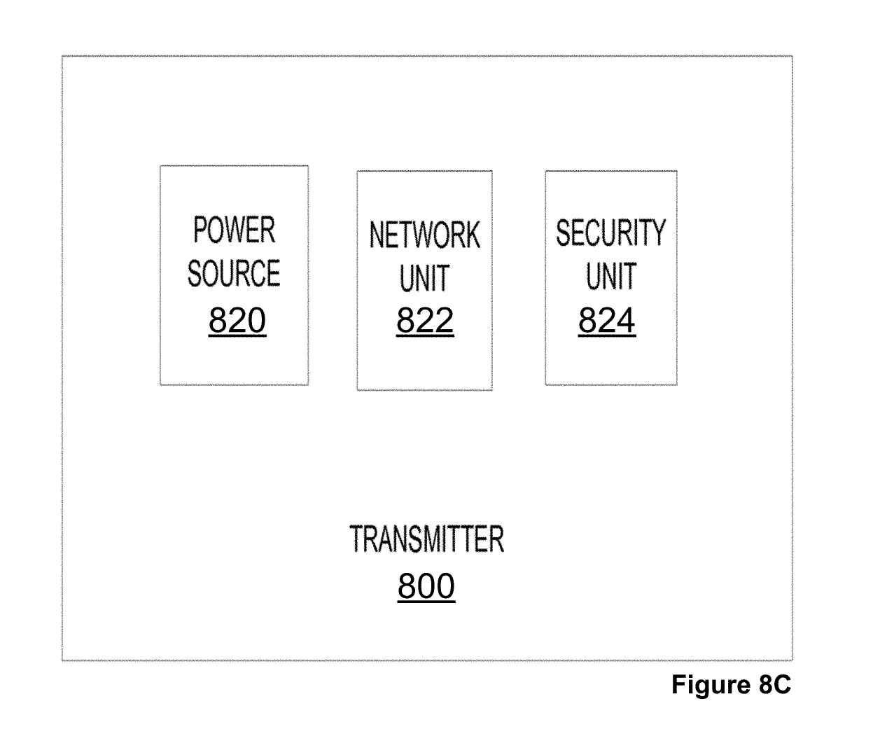

FIG. 8A illustrates an example embodiment of a multimode transmitter. Some elements of this figure are described above.

A multimode transmitter 800, such as transmitter 102, is configured to operate as or includes a wireless power router and/or a communication network router, whether in a serial manner, such as one at a time, or a parallel manner, such as concurrently. More particularly, transmitter 800 is configured to define a pocket of energy via a plurality of wireless power waves so that a first receiver is able to interface with the pocket of energy, as described herein. Transmitter 800 is configured to emit the wireless power waves, as described herein. For example, at least one of the wireless power waves can be based on a radio frequency.

Transmitter 800 is also configured to provide a network communication signal to a second receiver so that the second receiver is able to interface with the network signal (i.e., is able to access the Internet using the network signal). Such provision can be performed in a wired manner, such as via a cable, a wire-line, or others. Such provision can also be performed in a wireless manner, such as optical, radio, laser, sound, infrared, or others. Such provision can based at least in part on the transmitter receiving a unique identifier from the second receiver, such as a media access control (MAC) address. For example, the network signal includes at least one of an Ethernet signal, a WI-FI signal, an optical signal, a radio signal, an infrared signal, a laser signal, or another type of signal, whether via a short range communication protocol, such as BLUETOOTH, or via a long range communication protocol, such as a satellite signal or a cellular signal, such as a cell site. The network signal is based at least in part on a network, and the network is or includes at least one of a local area network (LAN), a wide area network (WAN), a storage area network (SAN), a backbone network, a metropolitan area network, a campus network, a virtual private network, a global area network, a personal area network (PAN), or others, whether for an intranet, an extranet, an internetwork, or darknet.

Transmitter 800 includes a plurality of antenna elements 802, as described herein, and a radio frequency integrated circuit (RFIC). Antenna elements 802 and RFIC are arranged in a flat array arrangement, which reduces losses due a shorter distance between components. However, other types of arrangements are possible, such as non-flat, for instance, hemispherical. Transmitter 800 is configured to regulate a phase and an amplitude of pocket-forming operations in antenna elements 802, as described herein. For example, such regulation can be via corresponding RFIC in order to generate a desired pocket-forming output and null-space steering. Furthermore, transmitter 800 can be configured so that multiple pocket-forming outputs may charge a higher number of receivers and allow a better wave trajectory to such receivers. Transmitter 800 can include an omnidirectional antenna.

In some embodiments, transmitter 800 includes or is coupled to a plurality of arrays comprising antenna elements 802. Such coupling can be direct or indirect, wired or wireless, and/or local or remote. For example, such coupling can be via a wire spanning between transmitter 800 and at least one of such arrays. Note that such arrays can be embodied as one unit or a plurality of inter-coupled units or intra-coupled units. Such coupling can be direct or indirect, wired or wireless, and/or local or remote. For example, such coupling can be via a wire spanning between at least two of such arrays. Also, note that at least two of such arrays can be identical to each other or different from each based on at least one of structure, function, shape, size, coupling characteristics, or material properties. A presence of such arrays may increase or decrease a number of antenna elements 802 operating for each application, such as either for a wireless power transmission or a communication network signal transmission. In some embodiments, transmitter 800 lacks distinct array division, such as visual, such as into the first portion and the second portion. Resultantly, at least one of such arrays comprising antenna elements 802 operates for the communication network signal transmission only, and the switch, as described herein, changes an operational mode to enable the power router functionality. For example, transmitter 800 is configured to operate such that a first portion of an array, as described herein, such as a half, transmits the network signal, such as a WI-FI signal, and a second portion of the array, such as the other half, defines the pocket of energy, such as described herein. Line 804 represents a division in the array arrangement. Note that although the first portion and the second portion are symmetrical, the first portion and the second portion can be asymmetrical. Also, note that the first portion and the second portion can differ from each other or be identical to each other in at least one of a shape, a size, and a number of antenna elements 802.

In some embodiments, transmitter 800 includes an antenna, as described herein. Therefore, transmitter 800 defines the pocket and provides the network signal via the antenna. Transmitter 800 can define the pocket and provide the signal simultaneously. Alternatively or additionally, transmitter 800 is configured to switch between a first operational mode and a second operational mode. Resultantly, transmitter 800 includes a switch configured to switch between the first mode and the second mode. The switch can be hardware based, such as an A/B switch, a knob, or a lever. The switch can also be software based, such as via a set of processor-executable instructions, for instance. via machine code. Such switch can switch manually, such as via a user input, for instance, via a button. Such switch can also switch automatically, such as via a set of processor-executable instructions, for instance via machine code. In the first mode, transmitter 800 defines the pocket only. In the second mode, transmitter 800 provides the network signal only. For example, such switch can be an A/B switch, whether manually switchable or automatically switchable, based on at least one input criterion, which can be remotely updateable. Note that transmitter 800 can be configured so that the communication network router functionality and the wireless power functionality are simultaneously operating, such as parallel operation, whether dependent or independent on each other, or only the communication network router functionality or the wireless power functionality operates at one time, such as serial operation, whether dependent or independent on each other.

In some embodiments, transmitter 800 includes a first antenna, as described herein, and a second antenna, as described herein. Therefore, transmitter 800 defines the pocket via the first antenna and provides the network signal via the second antenna. The first antenna and the second antenna can be controlled via a controller, whether or not transmitter 800 includes such controller, whether or not such controller is local or remote to transmitter 800, whether or not such controller is directly or indirectly coupled to at least one of the first antenna and the second antenna. Note that the first antenna and the second antenna can be part of a larger antenna, such as an array. Also, note that the first antenna and the second antenna can be coupled to each other. Further, the first antenna and the second antenna can be not coupled to each other. Transmitter 800 is configured to that the first antenna defines the pocket of energy and the second antenna provides the network signal simultaneously. Alternatively or additionally, transmitter 800 is configured to switch between a first operational mode and a second operational mode. Resultantly, transmitter 800 includes a switch configured to switch between the first mode and the second mode. The switch can be hardware based, such as an A/B switch, a knob, or a lever. The switch can also be software based, such as via a set of processor-executable instructions, for instance via machine code. Such switch can switch manually, such as via a user input, for instance, via a button. Such switch can also switch automatically, such as via a set of processor-executable instructions, for instance via machine code. In the first mode, transmitter 800, via the first antenna defines the pocket only. In the second mode, transmitter 800, via the second antenna, provides the network signal only. However, in some embodiments, the transmitter 800 includes a plurality of antennas, as described herein, such as at least two, defining the pocket of energy. In some embodiments, the plurality of antennas further provides the network signal. For example, such switch can be an A/B switch, whether manually switchable or automatically switchable, based on at least one input criteria, which can be remotely updateable. Note that transmitter 800 can be configured so that the communication network router functionality and the wireless power functionality are simultaneously operating, such as parallel operation, whether dependent or independent on each other, or only the communication network router functionality or the wireless power functionality operates at one time, such as serial operation, whether dependent or independent on each other.

In some embodiments, a device includes the first receiver and the second receiver. For example, an electronic device, such as a smartphone, includes the first receiver, embodied as a first hardware unit, as described herein, and the second receiver, embodied as a second hardware unit, such as a WI-FI card. Note that the first receiver is physically distinct from the second receiver, whether or not the first receiver is operably coupled to the second receiver. However, in other embodiments, a first device, such as a smartphone, includes the first receiver and a second device, such as a tablet computer, includes a second receiver. Yet, in other embodiments, the first receiver and the second receiver are one receiver, such as described herein.

In some embodiments, transmitter 800 includes a network communication unit, which can include the communication network router or be coupled to the communication network router, such as via wiring. Such unit can facilitate transmitter 800 in providing the network signal. Such unit can be implemented via hardware, such as a chip or an appliance, and/or software, such as a module or a software application, in any combination. Such unit can communicate in at least one of a wired manner and a wireless manner. Such unit includes at least one of a router, a network bridge, a firewall, a modem, a network switch, a printer server, or a network repeater. At least two of such components can be structurally distinct from each other or embodied as one unit. At least two of such components can be functionally distinct from each other or function as one unit.

The network bridge enables a connection, whether direct or indirect, such as a link, a path, a network, or a channel, between a plurality of communication networks for inter-communication there between. For example, a first network can be a wired network and a second network can be a wireless network, where the network bridge bridges the first network and the second network so that members of each of the first network and the second network can communicate with each other through the network bridge. Note that the first network and the second network can be of one type, such as based on a common protocol, such as Ethernet, or of different types, such as where the bridge translates a plurality of protocols. Also, note that the plurality of networks can be local to each other or remote from each other in any manner.

The firewall enables control, whether direct or indirect, of at least one of incoming network traffic and outgoing network traffic based on a set of rules applied thereon. For example, the firewall can operate as a barrier between a first network and a second network. The firewall can be network-layer based or a packet-filter based. The firewall can also be application-layer based. The firewall can also be proxy-server based. The firewall can also be network address translation based.

The modem enables signal modulation and signal demodulation. The modem can be a networking modem, such as a broadband modem, or a voice modem.

The network switch enables a connection, whether direct or indirect, of a plurality of devices together on a communication network via packet switching, such as based on a unique network address, for instance MAC address. The switch operates at least one level of an Open Systems Interconnection model (OSI) model, including at least one of a data link layer and a network layer. The network switch can be a multilayer switch. The network switch can be managed or unmanaged.

The print server enables a connection, whether direct or indirect, of a printer to a computer, such as a desktop computer or a laptop computer, over a network. The printer server can receive a print job from the computer, manage the job with other, if any, and send the job to the printer. In some embodiments, the print server is a networked computer. In some embodiments, the print server is a dedicated network device. In some embodiments, the print server is a software application.

The network repeater enables a regeneration or a retransmission of a signal at a higher level or a higher power than when received, such as due to a transmission loss. The network repeater can communicate such signal over an obstruction or extend a range of the signal. The network repeater can translate the signal from a first communication protocol to a second communication protocol. In some embodiments, transmitter 800 is configured for tethering, such as connecting one device to another. For example, transmitter 800 allows sharing of a network connection with another device, such as a tablet or a smartphone. Such tethering can be done over any type of network described herein. The tethering can be in a wired manner or a wireless manner.

In some embodiments, the network signal is encrypted, whether onboard or via another device. Such encryption can be performed via a symmetric key architecture, where an encryption key is identical to a decryption key. For example, the key can include alphanumeric or biometric information. However, the network communication signal is encrypted via a public key encryption architecture, such as comprising a public key and a private key, for instance a Pretty Good Privacy (PGP) method. The network signal can be encrypted automatically, such as via an algorithm, for instance a set of processor-executable instructions. However, the network signal can also be encrypted manually, such as via a user input. The network signal can be decrypted in a manner, as described herein. Also, transmitter 800 can include at least one of an encryption chip and a decryption chip to facilitate the provision of the encryption signal. Note that the encryption chip and the decryption chip can be embodied as at least one of a functional unit and a structural unit.

In some embodiments, transmitter 800 is configured to define the pocket via a signal path to the first receiver. The signal path is defined via transmitter 800 based at least in part on at least one of a gain information obtained from the second receiver and a phase information obtained from the second receiver. At least one of the gain information and the phase information can be obtained based on transmitter 800 providing the network signal, such as based at least in part on receiving a response from the second receiver.

In some embodiments, transmitter 800 defines the pocket of energy adaptively, as described herein, based on providing the network signal. Such adaption can be based at least in part on at least partially avoiding at least a wireless power wave obstacle portion, such as a chair, positioned between transmitter 800 and the first receiver. For example, transmitter 800 can define the pocket of energy via a signal path to the first receiver. The signal path is defined via transmitter 800 based at least in part on at least one of a gain information obtained from the second receiver and a phase information obtained from the second receiver, such as based at least in part on receiving a response from the second receiver. The at least partially avoiding is based at least in part on the signal path, as previously established.

In some embodiments, transmitter 800 defines the pocket of energy indoors, such as within a structure, for instance, a building, a tunnel, a vehicle, a hangar, a warehouse, a tent, an arena, or others. Such defining can be based at least in part on bouncing at least one of the wireless power waves from at least one of a floor, a wall extending from the floor, and a ceiling extending from the wall. For example, transmitter 800 can define the pocket of energy via a signal path to the first receiver. The signal path is defined via transmitter 800 based at least in part on at least one of a gain information obtained from the second receiver and a phase information obtained from the second receiver, such as based at least in part on receiving a response from the second receiver. The bouncing is at least until the signal path is defined. However, in other embodiments, transmitter 800 defines the pocket of energy outdoors, such as at a camp site, an air field, a vehicle, a stadium, a street, a yard, a park, a field, or others.

In some embodiments, transmitter 800 is configured to determine a position of the first receiver based at least in part on a signal triangulation of the second receiver, such as a cellular signal. Transmitter 800 defines the pocket of energy based at least in part on the position.

FIG. 8B illustrates an example embodiment 810 of a multimode transmitter defining a pocket of energy and providing a network signal.

Transmitter 800 outputs power waves 116 to define pocket of energy 812. Receiver 120 interfaces with pocket energy 812 to charge laptop computer 122a. Transmitter 800 also provides a network signal to phone 122b, which includes a network receiver 814 to interface with the network signal. Transmitter 800 determines which signal to output (network or power) through micro-controller (e.g., processor 104, FIG. 1), which, for example, receives a unique identifier, such as a MAC address of laptop computer 122a or phone 122b.

For example, once transmitter 800 identifies and locates receiver 120, a channel or path can be established by knowing the gain or the phases coming from receiver 120, as described herein. Transmitter 800 starts to transmit controlled power waves 116, via antenna elements 802 (FIG. 8B), which converge in 3D space. Power waves 116 are produced using power source (not shown) and a local oscillator chip using a suitable piezoelectric material. Power waves 116 are controlled by RFIC, which includes a chip for adjusting phase and/or relative magnitudes of RF signals, which serve as inputs for antenna elements 802 to form constructive and destructive interference patterns (pocket-forming). Pocket-forming may take advantage of interference to change the directionality of the antenna elements 802 where constructive interference generates pocket of energy 812 and deconstructive interference generates a null space. Receiver 120 utilizes pocket of energy 812 produced by the pocket-forming for charging or powering an electronic device, for example laptop computer 122a and thus effectively providing wireless power transmission using pocket-forming.

Transmitter 800 also identifies and locates receiver 814 from smartphone 122b. Smartphone 122b may request the network signal, such as a WI-FI signal. Therefore, transmitter 800 may send the requested network signal in parallel with the power waves 116 for powering laptop computer 122a.

In some embodiments, a network router, such as a WI-FI router, includes a housing, which houses transmitter 800 that outputs power waves 116 to define pocket of energy 812, as described herein, and a network signal, such as a WI-FI signal, as described herein. Such output can be concurrent or non-concurrent. The router can also be configured to provide a wired network connection, whether for a same network or a different network. The router can be used to wirelessly charge a first electronic device and to wirelessly provide network access to a second electronic device. Note that the first device and the second device can be one device or different devices. For example, the router can wirelessly charge a cellular phone, as described herein, and simultaneously provide an internet connection to the cellular phone, as described herein. Alternatively, transmitter 800 includes a WI-FI router or WI-FI circuitry which is configured to power a tablet computer and provide an internet connection to that tablet computer.

FIG. 8C illustrates a schematic diagram of an example embodiment of a multimode receiver. Thus, same reference characters identify identical and/or like components described above and any repetitive detailed description thereof will hereinafter be omitted or simplified in order to avoid complication.

Transmitter 800 includes power source 820, a network unit 822, and a security unit 824 operably interconnected with each other in any operational manner, whether directly or indirectly. Note that network unit 822 and security unit 824 can also be one unit. Network unit 822 includes the network communication unit, as described herein. Security unit 824 enables security operations, such as encryption or decryption, as described herein. For example, security unit 824 includes at least one of the encryption chip, the decryption chip, and the encryption-decryption chip. Power source 820 can operate as described herein. However, in other embodiments, power source 820 can also receive power, include, or be at least one of a mains electricity outlet, a wireless power receiver, as described herein, or an energy storage device, such as a battery. In some embodiments, transmitter 800 receives power, includes, or is a renewable energy source, such as a wind turbine, a liquid turbine, a photovoltaic cell, a geothermal turbine, or others. For example, transmitter 800 includes the renewable energy source or is coupled to the renewable energy source, whether directly or indirectly, whether locally or remotely. For example, the wind turbine can be at least one of a vertical axis turbine and a horizontal axis turbine, or others. The liquid turbine can be at least one of a reaction turbine or an impulse turbine, or others. The photovoltaic cell can be at least one of a silicon cell and a thin film cell, or others. The geothermal turbine can be steam-based or others.

FIGS. 8A-8C illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 8A-8C.

Presented below an example of a multi-mode transmitter.

In some embodiments, a multi-mode transmitter includes a first antenna element and a second antenna element. Further, the transmitter is configured to emit a first signal by the first antenna element and a second signal by the second antenna element, where the first signal includes a plurality of wireless power waves establishing a pocket of energy. Moreover, the second signal is different from the first signal and the second signal provides WI-FI access.

In some embodiments, the transmitter includes an antenna array, and the antenna array includes the first antenna element and the second antenna element.

In some embodiments, the antenna array is defined via a first portion and a second portion, and the transmitter is configured to emit the first signal via the first portion, and the transmitter is configured to emit the second signal via the second portion.

In some embodiments, the first portion and the second portion are symmetrical geometrically.

In some embodiments, the first portion and the second portion are asymmetrical geometrically.

In some embodiments, the first portion includes a first plurality of antenna elements and the second portion includes a second plurality of antenna elements. Moreover, in some embodiments, the first plurality of antenna elements is numerically different from the second plurality of antenna elements. Alternatively, in some embodiments, the first plurality of antenna elements is numerically identical to the second plurality of antenna elements.

In some embodiments, the transmitter is configured to switch between a first mode and a second mode, and the transmitter is configured to emit the first signal during the first mode only and the second signal during the second mode only.

In some embodiments, the transmitter is configured to emit the first signal to a first receiver and the second signal to a second receiver, and a device includes the first receiver and the second receiver.

In some embodiments, the transmitter is configured to emit the first signal to a first receiver coupled to a first device and the second signal to a second receiver coupled to a second device different from the first device.

In some embodiments, the transmitter is configured to emit the first signal to a first receiver and the second signal to a second receiver, and the first receiver and the second receiver are one receiver.

In some embodiments, the transmitter includes a third antenna element, and the transmitter is configured to emit the first signal concurrently by the first antenna element and the third antenna element.

In some embodiments, the second signal provides WI-FI access by providing a device that receives the second signal with an internet connection.

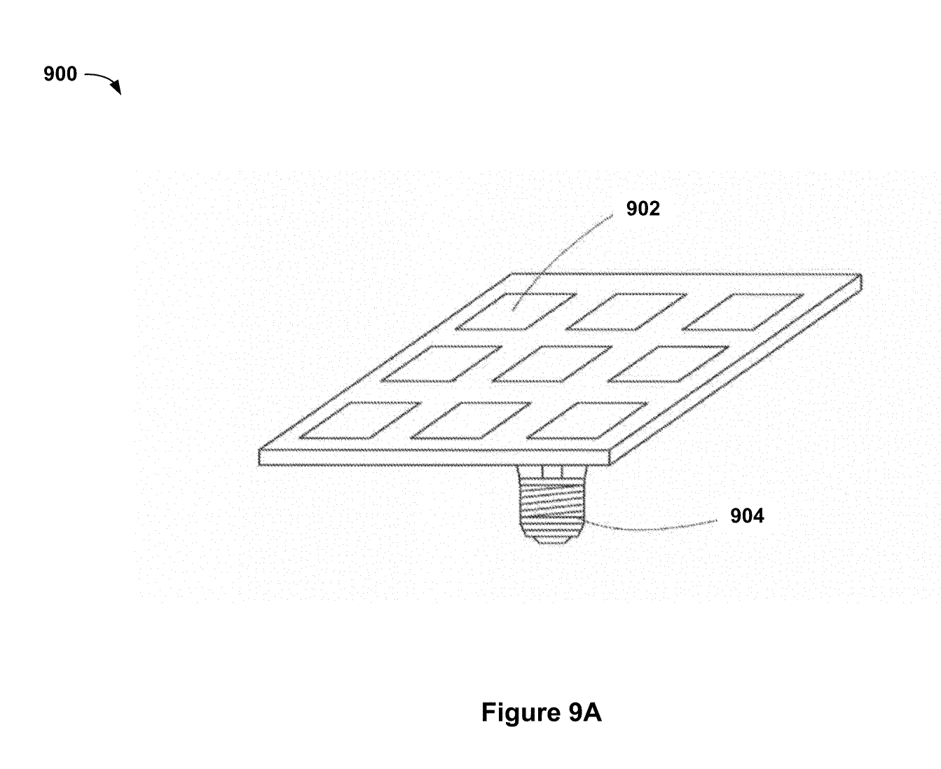

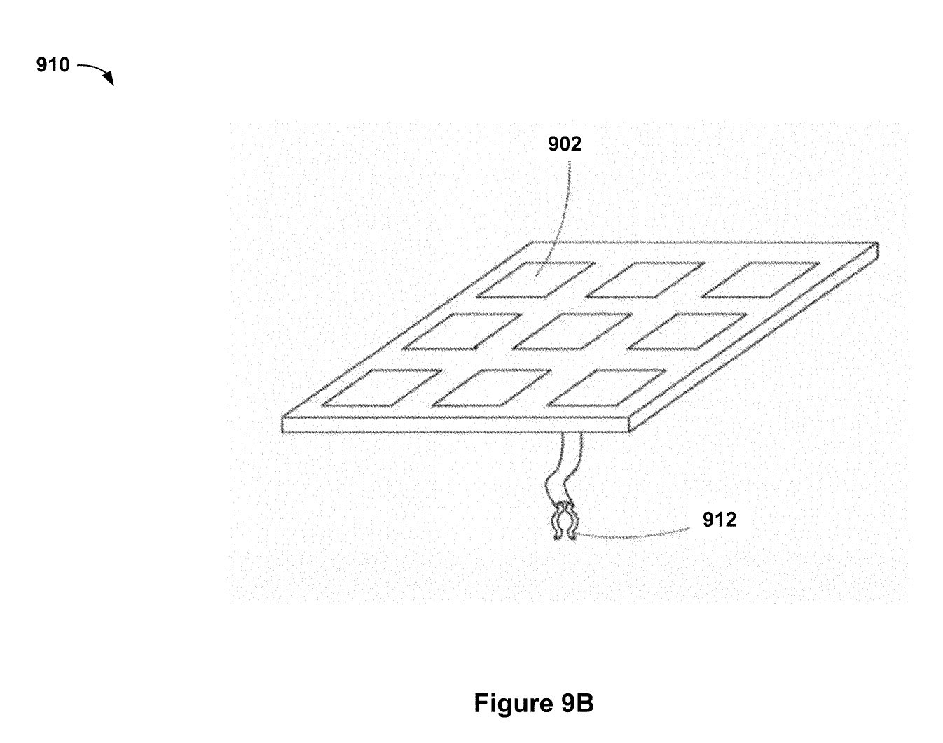

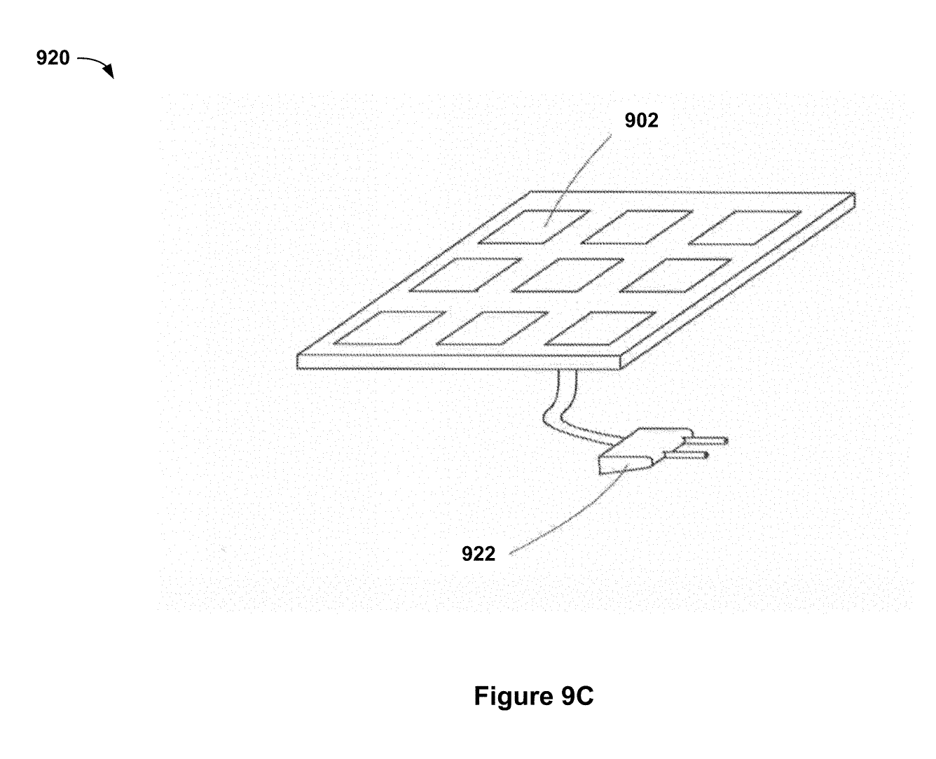

FIGS. 9A-9C illustrate various power couplings for transmitters used in wireless power transmission systems, in accordance with some embodiments.

FIG. 9A depicts a flat transmitter 900 (e.g., an embodiment of the transmitter 102, FIG. 1) of a predetermined size to fit into a number of spaces, which includes antenna elements 902. Transmitter 900 includes a screw cap 904. Screw cap 904 connects the transmitter 900 to a light socket, wherein the light socket operates as a power source for the transmitter 900.

Screw cap 904 may include a variety of electronics devices, such as, capacitors, inductors, power converters and the like. Such electronic devices may be intended for managing the power source, which feeds transmitter 900.

Furthermore, transmitter 900 including screw cap 904 as power connection may increase versatility of transmitter 900, because transmitter 900 is able to be located in every place where a screw cap 905 is received by a light socket.

Transmitter 900 includes several shapes which may vary in dependence with final application and user preferences.

FIG. 9B depicts a flat transmitter 910 (e.g., an embodiment of the transmitter 102, FIG. 1), which includes antenna elements 904. Transmitter 910 includes a cable 912 with a pair of wires for connection to the power source. Power source includes an electrical service in a building or mobile vehicle and the like.

Cables 912 include labels of positive and negative cables in case of connecting to a DC current power source and/or ILA and L2 cables in case of AC current power source. Furthermore, more cables may be included, and such cables may be for three-phase power source and a ground cable connection.

Transmitter 910 includes a variety of electronics devices, such as, capacitors, inductors, power converters and the like. Such electronic devices may be intended for managing the power source which may feed transmitter 910.

Transmitter 910 is located in several places due to the cables 912, which may be connected to any power source, and such power source may be AC or DC in dependence with final application and user preferences.

Transmitter 910 includes several shapes which may vary in dependence with final application and user preferences.

FIG. 9C depicts a transmitter 920 (e.g., an embodiment of the transmitter 102, FIG. 1) which includes antenna elements 902 in a flat arrangement. Transmitter 920 is connected to a power source through one or more power plug 922. Such power plug 922 complies with the standard of each country and/or region. Power plug 922 is intended to connect transmitter 920 to one or more power outlet on the walls, floors, ceilings and/or electric adapters.

Transmitter 920 includes a variety of electronics devices, such as capacitors, inductors, power converters and the like. Such electronic devices are intended for managing the power source which feeds transmitter 920.

Transmitter 920 includes several shapes which may vary in dependence with final application and user preferences.

FIGS. 9A-9C illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 9A-9C.

Presented below is an example method of coupling a transmitter to a power source.

In some embodiments, an example method includes receiving, by an antenna of a receiver coupled to the electronic device, pockets of energy generated in response to RF waves emitted by a pocket-forming transmitter coupled to a power source through a power coupling and converting, by a rectifying circuit of the receiver, the received pockets of energy into electricity to charge the electronic device.

In some embodiments, the power coupling of the transmitter includes an Edison screw cap for insertion into a light socket connected to the power source, and the power source is an electrical service available to a user of the electronic device.

In some embodiments, the power coupling of the transmitter includes a cable with a pair of wires for connection to the power source, and the power source is an electrical service available to a user of the electronic device.

In some embodiments, the power coupling of the transmitter includes an electrical plug for insertion into a socket connected to the power source, and the power source is an electrical service available to a user of the electronic device.

FIGS. 10A-10C illustrate wireless power transmission systems used in military applications, in accordance with some embodiments.

FIG. 10A is an example embodiment of a power distribution system 1000 in a military camp where troops may be settled in remote locations. Power distribution system 1000 may include a mobile power generator 1002, which may serve to power electrical equipment. Mobile power generator 1002 may be a mobile diesel generator or other sources such as solar photovoltaic arrays, wind turbines or any reliable power source or combination thereof coupled with mobile power generator 1002. The power generator 1002 is configured to power a transmitter 102, which may enable wireless power transmission. Transmitter 102 may use mobile power generator 1002 as a power source to form pockets of energy. Pockets of energy may form at constructive interference patterns and can be 3Dimensional in shape whereas null-spaces may be generated at destructive interference patterns. Electrical devices 1004 such as radios, laptops or any devices requiring a power input may be coupled with a receiver 120 (not shown). Receiver 120 may then utilize pockets of energy produced by pocket-forming for charging or powering electrical devices 1004.

Transmitter 102 may form pockets of energy covering a range from about a few feet to hundreds of feet depending on the size of the antenna array. For the foregoing application, about 30 to about 60 feet may suffice. Additional transmitters 102 may be used to extend the distance in a power distribution system. A central transmitter 102 coupled with mobile power generator 1002 may serve as a central distribution center while additional transmitters 102 may be placed at a distance and retransmit energy received from the central transmitter to reach greater distances. Each transmitter 102 size may be relative to the desired transmission distance.

FIG. 10B is another example embodiment of a power distribution system 1010. A transmitter 102 coupled with a mobile power generator 1002 may be mounted over a military vehicle 1012 in order to add mobility. Military vehicle 1012 may be any vehicle with enough robustness and ruggedness for battlefield applications such as a high mobility multi-purpose wheeled vehicle (HMMWV/Humvee) armored trucks, tanks or any vehicle capable of carrying transmitter 102 coupled with mobile power generator 1004. Military vehicle 1012 may accompany soldiers into the battlefield and serve as a power source for electrical devices 1004 carried by soldiers. Electrical devices 1004 carried by soldiers may be coupled with receivers 120 (not shown in FIG. 10B) in order to receive energy from transmitter 102.

FIG. 10C is another embodiment of power distribution system 1020 where remote controlled vehicles 1022 designed for espionage, detecting mines or disabling bombs may be powered wirelessly. In this embodiment, remote control and power may be critical factors to prevent exposure or harm to human soldiers 1024. Remote controlled vehicle 1022 may be coupled with a receiver 120. A transmitter 102 coupled with a mobile power generator 1004 may form pockets of energy 1026 at constructive interference patterns that may be 3Dimensional in shape whereas null-spaces may be generated at destructive interference patterns. A receiver 120 may then utilize pockets of energy 1026 produced by pocket-forming for charging or powering remote controlled vehicle 1022.

FIGS. 10A-10C illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 10A-10C.

Presented below are example systems and methods of wireless power transmission in military applications.

In some embodiments, an example method includes: (i) communicating, by a receiver associated with a mobile electronic device, a security code to a transmitter coupled to a power source, the transmitter configured to recognize the security code; (ii) receiving, by an antenna of the receiver associated with the mobile electronic device, a pocket of energy generated in response to transmission signal waves emitted by the transmitter, the transmission signal waves being emitted upon recognition of the security code by the transmitter; and (iii) charging, by the receiver, the mobile electronic device, the receiver including a rectifying circuit to convert the received pocket of energy into electricity.

In some embodiments, the power source is one or more of a mobile diesel generator, a mobile gasoline generator, solar panels, and wind turbines.

In some embodiments, the method further includes charging, by the receiver, the mobile electronic device by establishing a path for the pocket of energy to converge in 3D space upon an antenna of the receiver. The antenna of the receiver is in communication with an antenna of the transmitter and the antenna of the transmitter is broadcasting the transmission signal waves.

In some embodiments, the transmitter includes a plurality of antennas, a radio frequency integrated circuit, and a processor configured to implement security logic and a communications component.

In some embodiments, the method further includes receiving, by the receiver associated to the mobile electronic device, the pocket of energy generated in response to transmission signal waves emitted by a secondary transmitter, the transmission signal waves being emitted by a secondary transmitter in response to the transmission signal waves emitted by the transmitter.

In some embodiments, the receiver receives the pocket of energy from the transmitter and is switched to the secondary transmitter to continue charging the mobile electronic device.

In some embodiments, the pocket of energy is regulated by utilizing adaptive pocket-forming.

In some embodiments, the power source is a mobile generator mechanically coupled to the transmitter and configured to extend reach of the transmission signal waves emitted by transmitter.

In some embodiments, the receiver is in a remote controlled vehicle.

In some embodiments, another example method includes, at a receiver having a communications component, at least one antenna element, and a rectifying circuit: (i) communicating, by the communications component of the receiver, a communications signal, which includes a security code, to a transmitter coupled to a power source, and the transmitter is configured to recognize the security code; (ii) receiving, by the at least one antenna element of the receiver, energy from a plurality of power transmission waves that forms a constructive interference pattern proximate to a location of the receiver, and the transmitter transmits the plurality of power transmission waves in response to recognizing the security code communicated to the transmitter by the receiver; and (iii) charging, using electricity generated by the rectifying circuit using the energy from the plurality of power transmission waves received by the at least one antenna element of the receiver, an electronic device that is coupled with the receiver.

In some embodiments, the transmitter includes a plurality of antennas, a radio frequency integrated circuit, a processor configured to implement a security logic used to recognize the security code, and a communications component.

In some embodiments, the transmitter, in response to recognizing the security code communicated to the transmitter by the receiver: (i) transmits the plurality of power transmission waves to form the constructive interference pattern in proximity to the receiver in response to determining that the receiver is within range of the transmitter; and (ii) transmits the plurality of power transmission waves to a secondary transmitter, that is distinct and separate from the transmitter, in response to determining that the receiver is outside the range of the transmitter, and the secondary transmitter re-transmits the plurality of power transmission waves that forms the constructive interference pattern proximate to the location of the receiver.

In some embodiments, an example system for secured wireless charging of a mobile electronic device includes: (i) a mobile electronic device coupled to a receiver; (ii) the receiver configured to communicate a security code to a transmitter; and (iii) the transmitter configured to: receive the security code from the receiver; recognize, using security logic of the transmitter, the security code; and in response to recognizing the security code, transmit a plurality of power transmission waves that forms a constructive interference pattern proximate to a location of the receiver. The receiver is further configured to: receive, via an antenna element of the receiver, energy from the plurality of power transmission waves; and charge, using electricity generated using the energy from the plurality of power transmission waves received by the antenna element of the receiver, the mobile electronic device.

In some embodiments, the system further includes a secondary transmitter distinct and separate from the transmitter. The transmitter is further configured to, in response to determining that the receiver is outside a range of the transmitter, transmit the plurality of power transmission waves to the secondary transmitter; and the secondary transmitter is configured to re-transmit the plurality of power transmission waves that form a constructive interference pattern proximate to the location of the receiver.

In some embodiments, another example method includes, at a transmitter having a communications component, at least one processor, and a plurality of antenna elements: (i) receiving, by the communications component, a communication signal from a receiver that includes a security code; (ii) analyzing via the at least one processor, using security logic of the transmitter, the security code received from the receiver; and (iii) in response to recognizing the security code, transmitting, by at least some of the plurality of antenna elements, a plurality of power transmission waves that forms a constructive interference pattern proximate to a location of the receiver. In some embodiments, at least one antenna element of the receiver receives energy from the plurality of power transmission waves transmitted by the transmitter; and the receiver, using electricity generated from the plurality of power transmission waves received from the transmitter, charges or powers an electronic device that is coupled with the receiver.

In some embodiments, the plurality of power transmission waves is a plurality of RF power transmission waves.

In some embodiments, the transmitter is a far-field transmitter.

FIG. 11A illustrates a law enforcement officer wearing a uniform with an integrated wireless power receiver, in accordance with some embodiments.

In FIG. 11A, a law enforcement officer is wearing a uniform with an integrated receiver 1104. Uniform with an integrated receiver 1104 (e.g., an embodiment of the receiver 120, FIG. 1) may include electrical devices 1102 such as radios, night vision goggles, and wearable cameras among others. Electrical devices 1102 may be coupled to receiver 1104 through wires strategically distributed in the uniform. Receiver 1104 may then have an array of sensor elements 128 distributed thereon.

FIGS. 11B-11D illustrate wireless power transmitters integrated with various types of mobile law enforcement equipment (e.g., a police squad car and a SWAT team vehicle) for use in conjunction with law enforcement operations, in accordance with some embodiments.

FIG. 11B illustrates a mobile power source 1110 for police officers wearing uniforms with an integrated receiver 1104. Mobile power source 1100 may also serve electrical devices 1102 coupled with receivers 1104 independently. In some embodiments, a police car 1112 may include a transmitter 1103 (e.g., an embodiment of the transmitter 102, FIG. 1) which may be placed on top of siren 1114. Transmitter 1103 may be coupled to any suitable battery management system in police car 1112 to get the power necessary to enable wireless power transmission. Transmitter 1103 may include an array of transducer elements 1105 which may be distributed along the edge of the structure located on top of siren 1114. Transmitter 1103 may then transmit controlled RF waves 1116 which may converge in 3D space. These RF waves 1116 may be controlled through phase and/or relative amplitude adjustments to form constructive and destructive interference patterns (pocket-forming). Uniforms with an integrated receiver 1104 may then utilize pockets of energy produced by pocket-forming for charging or powering electrical devices 1102.

FIG. 11C illustrates a mobile power source 1120 for specialized police officers wearing uniforms with an integrated receiver 1104. Mobile power source 1120 may also serve electrical devices 1102 coupled with receivers 1104 independently. In FIG. 11C, a SWAT Mobile Command Truck 1122 may include a transmitter 1103 which may be placed on top of siren 1126. Transmitter 1103 may be coupled to any suitable battery management system in SWAT Mobile Command Truck 1122 to get the power necessary to enable wireless power transmission. Transmitter 1103 may include an array of transducer elements 204 which may be distributed along the edge of the structure located on top of siren 1126. Transmitter 1103 may then transmit controlled RF waves 1116 which may converge in 3D space. These RF 1116 may be controlled through phase and/or relative amplitude adjustments to form constructive and destructive interference patterns (pocket-forming). Uniforms with an integrated receiver 1104 may then utilize pockets of energy produced by pocket-forming for charging or powering electrical devices 1102.

FIG. 11D illustrates a mobile power source 1130 for remote controlled vehicles 1132 designed for espionage, detecting mines or disabling bombs that may be powered wirelessly. In this embodiment, remote control and power may be critical factors to prevent exposure or harm to police officers 1134. In some embodiments, a police car 1136 may include a transmitter 1103, which may be placed on top of siren 1140. Transmitter 1103 may be coupled to any suitable battery management system in police car 1136 to get the power necessary to enable wireless power transmission. Transmitter 1103 may include an array of transducer elements 1105, which may be distributed along the edge of the structure located on top of siren 1140. Transmitter 1103 may then transmit controlled RF waves 116, which may converge in 3D space. These RF waves 1116 may be controlled through phase and/or relative amplitude adjustments to form constructive and destructive interference patterns (pocket-forming). Remote controlled vehicle 1132 may be coupled with the receiver 1104. The receiver 1104 may then utilize pockets of energy produced by pocket-forming for charging or powering remote controlled vehicle 1132.

In summary, law enforcement officers may be required to carry a great deal of equipment which in most cases are electrical devices, the wireless power distribution system disclosed here may charge or power the electrical devices wirelessly. In some embodiments, the wireless power distribution system may include at least one transmitter coupled with any suitable battery management system in a Law Enforcement vehicle, in other embodiments, a Law Enforcement uniform may be coupled with wireless receiver components that may use the pockets of energy to charge or power the electrical devices.

FIGS. 11A-11D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 11A-11D.

Presented below are example systems and methods of wireless power transmission in law enforcement applications.

In some embodiments, an example method for wireless power transmission for electrical devices used by law enforcement equipment is provided. The method includes: emitting RF waves from a pocket-forming transmitter each having an RF wave; integrated circuit, transducer elements, and communication circuitry; generating pockets of energy from the transmitter to converge in 3D space at predetermined locations within a predefined range; incorporating a receiver within a law enforcement uniform; attaching the electrical devices to the receiver; and convening the pockets of energy in 3D space from the transmitter to the receiver located within the law enforcement uniform to charge or power the electrical devices. In some embodiments, the electrical devices are radios, night vision goggles, wearable cameras, flashlights, sensors and other portable law enforcement electrical devices for use in law enforcement. In some embodiments, the electrical devices are coupled to the receiver through wires strategically distributed in the uniform. In some embodiments, the transmitter and receiver include transducer and sensor elements, respectively.

In some embodiments, an example apparatus for wireless power receipt by a law enforcement equipment device includes: a receiver configured to be removably coupled to an article of clothing and configured to communicate a security code to a transmitter, the receiver comprising: an antenna configured to receive a pocket of energy, the pocket of energy being generated in response to power transmission waves from the transmitter, the power transmission waves being transmitted upon recognition of the security code by the transmitter; and a rectifying circuit configured to convert the received pocket of energy into electricity to charge a law enforcement equipment removably coupled to the article of clothing.

In some embodiments, the receiver further communicates to the transmitter information including an identification, a location, and an indication of the power level of the law enforcement equipment.

In some embodiments, the antennas of the receiver are arranged as an array integrated into the article of clothing.

It should be noted that the embodiments described above in FIGS. 10A-10C equally apply to the embodiments shown in FIGS. 11A-11D.

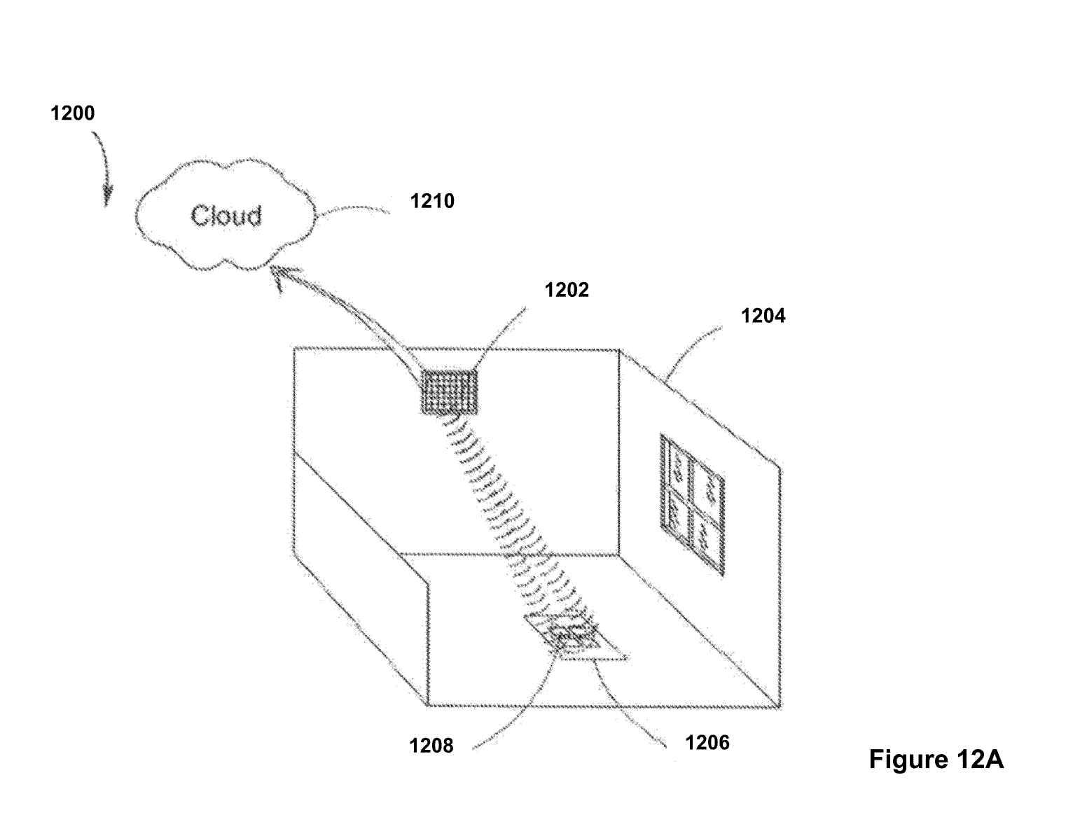

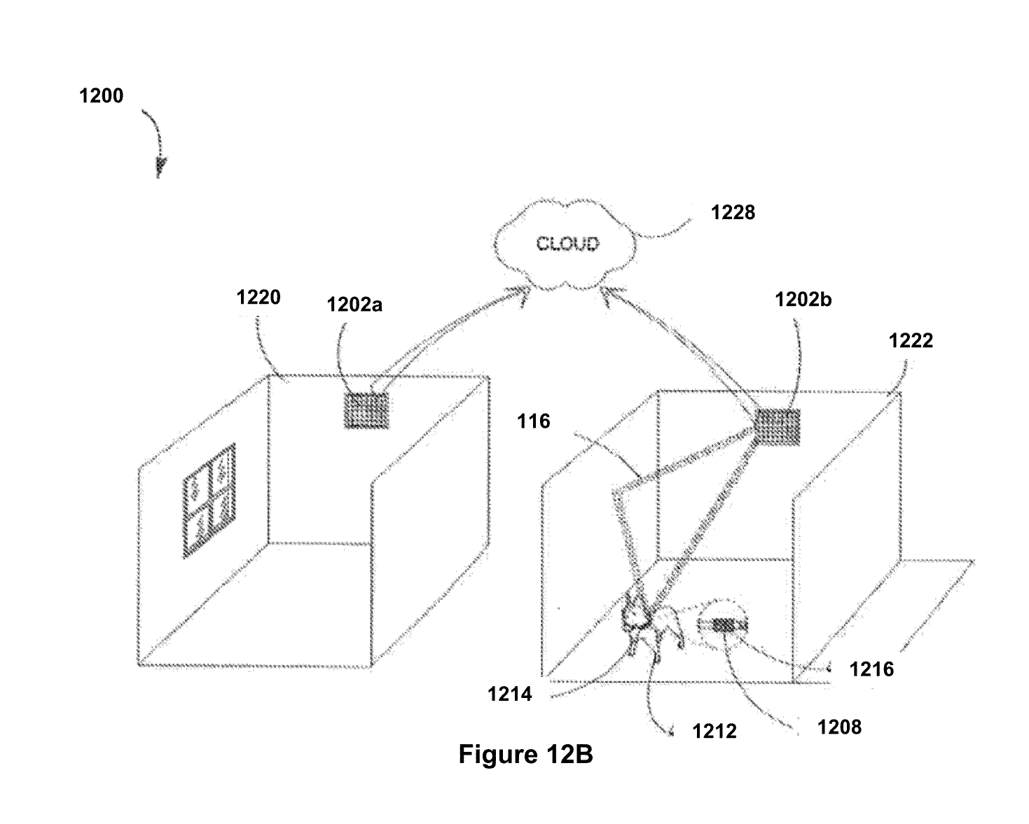

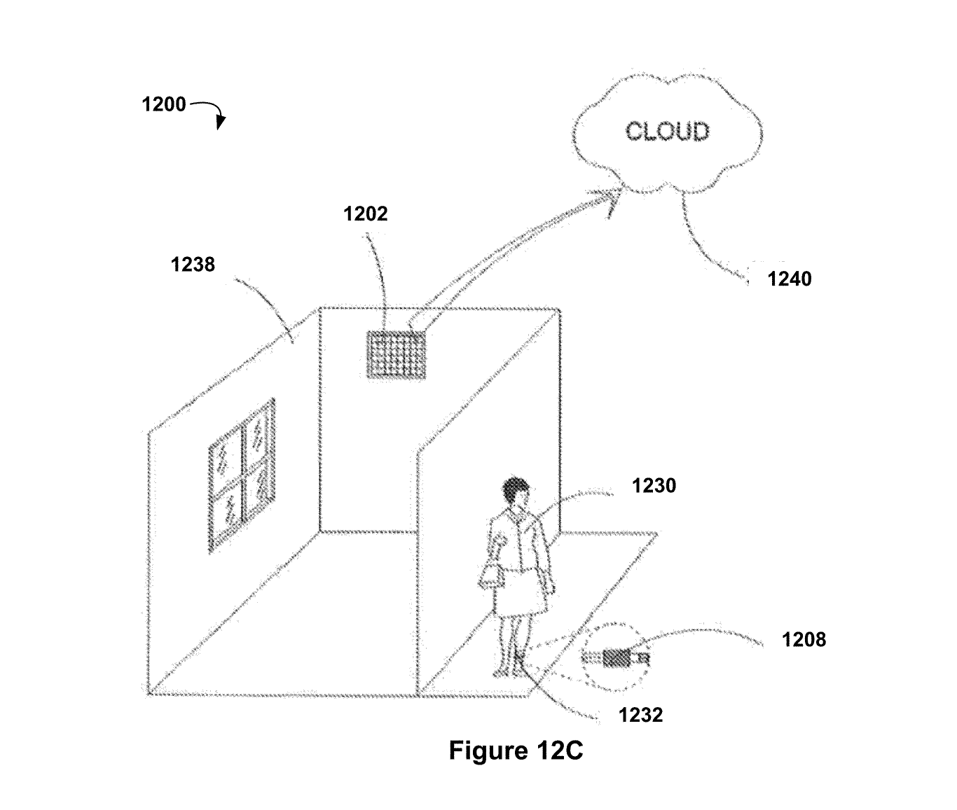

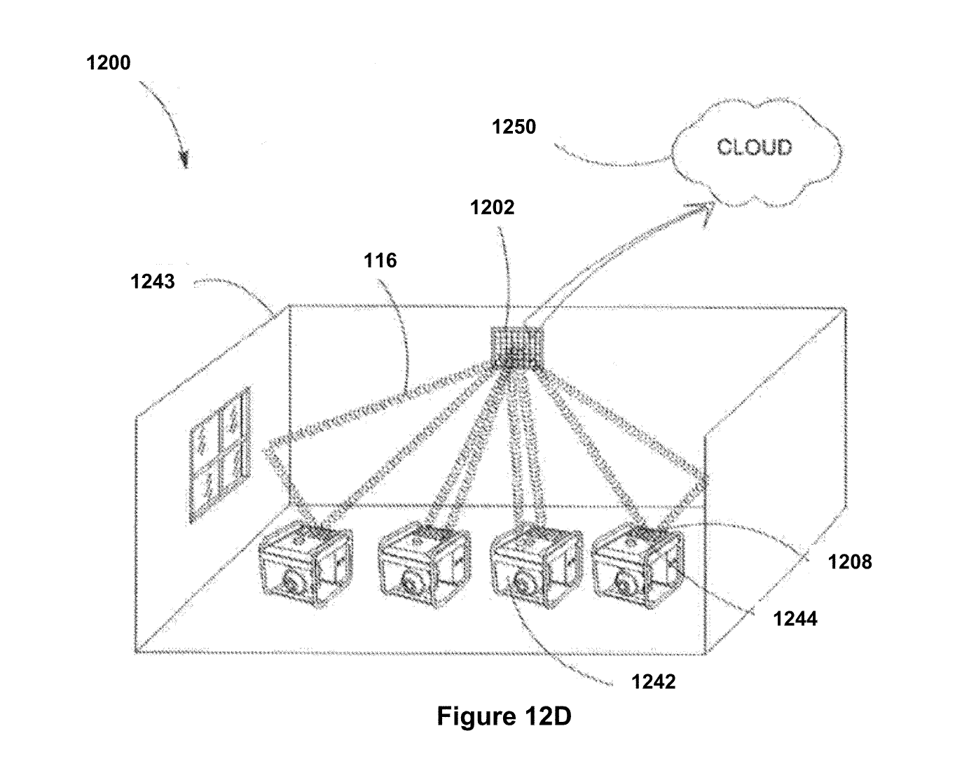

FIGS. 12A-12D illustrate tracking systems that upload data to a cloud-based service for use in conjunction with wireless power transmission systems, in accordance with some embodiments.

FIG. 12A shows a wireless tracking system 1200 for determining the location of objects or living beings. In some embodiments, wireless tracking system 1200 may be applied in a wireless power transmission system using pocket-forming techniques. Transmitter 1202 (e.g., an embodiment of the transmitter 102, FIG. 1) may be in house 1204 placed on a suitable location, such as on a wall, for an effective wireless power transmission to electronic device 1206. Objects or living beings may use an electronic device 1206 with embedded or adapted receiver 1208. Receiver 1208 (e.g., an embodiment of the receiver 120, FIG. 1) may include components described in FIG. 1 and transmitter 1202 may also include components described in FIG. 1.

While transmitter 1202 may charge or power receiver 1208, micro-controller 208 (from transmitter 1202) may be able to process information provided by communications component from receiver 1208, as described above. This information may be repeatedly uploaded to a cloud-based service 1210 to be stored in a database in determined intervals of time. Through data stored in database, the information may be read through a suitable interface such as computer software from any suitable computing device and from any suitable location. Transmitter 1202 may use a unique identifier of receiver 1208 for identifying and tracking electronic device 1206 from other devices. The unique identifier of receiver 1208 may be according to the type of communications component that may be used in receiver 1208; for example, if a protocol is used, the MAC address may be the unique identifier. This unique identifier may allow the information of electronic device 1206 with receiver 1208 to be mapped and stored in the database stored in cloud-based service 1210. Other unique identifiers may include International Mobile Equipment Identity (IMEI) numbers, which usually include a 15-digit unique identifier associated with all GSM, UNITS and LTE network mobile users; Unique Device ID (UDID) from iPhones, iPads and Mods, comprising a combination of 40 numbers and letters set by Apple; Android ID, which is set by Google and created when a user first boots up the device; or International Mobile Subscriber Identity (IMSI), which is a unique identification associated with the subscriber identity module (SIM). Furthermore, a user may be able to obtain user credentials to access the database stored in a private or public cloud-based service 1210 to obtain the information of receiver 1208. In some embodiments, cloud-based service 1210 may be public when the service, provided by the same transmitter 1202 or wireless manufacturer, is utilized in the public network by using only the user credentials for obtaining the desired information. And, cloud-based service 1210 may be private when transmitter 1202 may be adapted to a private network that has more restrictions besides user credentials.

In some embodiments, in order to track the location of a determined living being or object, a cloud-based service 1210 may be suitable for finding the location of receiver 1208. For example, when receiver 1208 may not be in house 1204, a user may be able to access with user credentials a suitable interface such as an Internet explorer, to visually depict the places where receiver 1208 was located, using information uploaded in database from the cloud-based service 1210. Also, if receiver 1208 may reach power or charge from another transmitter 1202 located in public establishments such as stores, coffee shops, and libraries, among others, the information may be uploaded to cloud-based service 1210, where the user may also be able to depict the information stored in the cloud-based service 1210.

In some embodiments, wireless tracking system 1200 may be programmed to send notifications when living beings or objects are not in the place where it/she/he has to be. For example, if a cat is not at owner's home, a notification such as an interactive message may be sent to a cellphone notifying that the cat is not at home. This interactive message service may be adapted to cloud-based service 1210 as an extra service. The interactive message may be optionally sent to an e-mail or to computer software as it may be desired. Furthermore, additional information may be included in the interactive message such as current location, time, battery level of receiver 1208, among other types of data.

In some embodiments, wireless tracking system 1200, may operate when receiver 1208 includes at least one audio component, such as a speaker or microphone, which may enable location determination via sonic triangulation or other such methods.

In some embodiments, transmitter 1202 may be connected to an alarm system which may be activated when receiver 1208 is not located in the place where it has to be.

In one example, FIG. 12B shows a wireless tracking system 1200 for tracking the location of a dog 1212. In some embodiments, dog 1212 is wearing a necklace collar 1214 that may include an integrated chip 1216 with an embedded receiver 1208. Dog 1212 may be outside first room 1220 and inside second room 1222. First room 1220 may be the place where dog 1212 lives; however dog 1212 escaped and arrived at second room 1222 (e.g., a coffee shop). In first room 1220, a first transmitter 1202a (e.g., an embodiment of the transmitter 102, FIG. 1) is hanging on a wall, and in second room 1222, a second transmitter 1202b (e.g., an embodiment of the transmitter 102, FIG. 1) is hanging on a wall. First transmitter 1202a detects that dog 1212 is not at home, here the interruption of RF waves 104 transmission to receiver 1208 from necklace collar 1214 allows first transmitter 1202a to detect the absence of dog 1212 in first room 1220. In some embodiments, the type of communication component to communicate first transmitter 1202a or second transmitter 1202b with receiver 1208, is a WI-FI protocol.

Subsequently, the owner of dog 1212 receives a message notification informing him/her that his/her dog 1212 is outside first room 1220. When dog 1212 arrived at second room 1222, receiver 1208 received RF waves 116 from second transmitter 1202b, while this second transmitter 1202b detects the presence of a new receiver 1208 and uploads the location and time to database stored in the public cloud-based service 1228. Afterwards, the owner of dog 1212 accesses public cloud-based service 1228 through a smartphone application for tracking the location of dog 1212. The owner may have his/her credentials to access cloud-based service 1228, where the user account is mapped with MAC address of first transmitter 1202a and receiver 1208. In the cloud-based service 1228, a display is provided with the locations with determined times where dog 1212 has been during its absence from first room 1220, using the MAC address of receiver 1208. Finally, the owner is now able to rescue his/her dog 1212 by knowing the current location where dog 1212 is.

In another example, FIG. 12C shows a wireless tracking system 1200 for tracking and controlling the location of a woman 1230 that has conditional liberty in her house 1238, in this example, woman 1230 is wearing an ankle monitor 1232 that may include a GPS chip 1216 with an adapted receiver 1208 to charge its battery. Ankle monitor 1232 receives RF waves 116 from transmitter 1202 that is hanging on a wall from house 1238. Receiver 1208 communicates with transmitter 1202 through a ZIGBEE protocol. In this case, the unique identifier which is used to identify receiver 1208 is Personal Area Network Identifier (PAN ID). Receiver 1208 sends information to transmitter 1202 about the battery status, how many times battery has been charged, battery age indicator, and cycle efficiency. This information may be uploaded to a private cloud-based service 1240 which, is monitored by a police station that supervises woman 1230. Further, transmitter 1202 may include an alarm system which may be activated when receiver 1208 is not receiving RF waves 116 or/and woman 1230 is not in house 1238. This alarm system provides an audio RF alert, while transmitter 1202 sends a notification to computer software of police office.

As shown in FIG. 12C, woman 1230 escaped house 1238; therefore the alarm system is activated providing audio sound alert and a police office receives a message notification informing it that woman 1230 is outside house 1238. Then, a police officer detects the location of woman 1230 in a map using the GPS chip 1216 from ankle monitor 1232. Further, the police officer accesses the private cloud-based network to monitor the battery life and the last time when receiver 1208 received RF waves 116. The police officer may also have his/her credentials to access the private cloud-based service 1240, where the user account is mapped with PAN ID of transmitter 1202. In addition, if the woman 1230 arrived to a public place such as coffee shop, receiver 1208 may upload information and location of the woman 1230 to public cloud-based service 1240 which may be transferred to private cloud-based service 1240; this operation is used as a back-up tracking system in case GPS does not work appropriately. Finally, the woman 1230 may be found and handcuffed by police officer due to location was provided by GPS and/or private-cloud based service.

In one more example, FIG. 12D shows a wireless tracking system 1200 for tracking and controlling commodities of generators 1242 stored inside a warehouse 1243. Here, one transmitter 1202 is used, which is hanging on a wall of warehouse 1243. Each generator 1242 has an electronic tag 1244 with an adapted receiver 1208. Transmitter 1202 may transfer RF waves 116 to each receiver 1208 for powering and tracking each electronic tag 1244. The communication component used in these receivers 1208 is a BLUETOOTH protocol. In this embodiment, the unique identifier is U LIII for the BLUETOOTH protocol. If one or more generators are illegally removed from warehouse 1243, transmitter 1202 activates an alarm and notifies a security guard through an interactive message informing him/her that one or more generators 1242 are being stolen. The security guard accesses a cloud-based service 1250 through an application and identifies generators 1242 that were stolen through UUID of each electronic tag 1244. The security guard receives another interactive message informing the current location of the stolen generators 1242, in which this information was obtained when receivers 1208 from electronic tags 1244 receive RF waves 116 from other transmitter 1202. This other transmitter 1202 may upload the information of the current location of the stolen generators, allowing the guard to find these generators 1242.

FIGS. 12A-12D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 12A-12D.

Presented below are example methods of wireless power transmission in tracking systems.

In some embodiments, an example method includes: (i) transmitting, by a transmitter, a plurality of wireless power transmission waves; (ii) defining, by the transmitter, a pocket of energy via the waves whereby a receiver is configured to interface with the pocket of energy to charge an electronic device coupled to the receiver; (iii) receiving, by the transmitter, a signal from the receiver based on the receiver interfacing with the pocket of energy; and (iv) tracking, by the transmitter, the electronic device based on the signal from the receiver, and the electronic device is associated with a living being or object.

In some embodiments, the signal includes a unique identifier associated with the electronic device.

In some embodiments, the unique identifier includes at least one of a media access control (MAC) address, an International Mobile Equipment identity number, a 15-digit unique identifier for at least one of a Global System for Mobile Communications (GSM) network, a Universal Mobile Telecommunications System (UMTS) network, and a Long Term Evolution (LTE) network, a Unique Device ID for at least one of a smartphone and a portable music player, an Android advertising ID, and an International Mobile Subscriber identity for a SIM card.

In some embodiments, the transmitter includes a controller and a communication device coupled to the controller, and the communication device is configured to communicate with the receiver in order to control the tracking.

In some embodiments, the signal includes information corresponding to at least one of a battery level of the electronic device, a geographical location of the electronic device, and a unique identifier associated with the electronic device.

In some embodiments, the method further includes uploading, by the transmitter, the information to a cloud based service.

In some embodiments, the electronic device is at least one of a bracelet, a necklace, a belt, a ring, an ear chip, and a watch.

In some embodiments, the receiver is coupled to at least one of a global positioning system (GPS) chip and a real-time location system chip.

In some embodiments, the method further includes decoding, by the transmitter, a short RF signal to identify at least one of a gain and a phase of the receiver, and the decoding facilitates a determination of a geographical location of the receiver; and tracking, by the transmitter, the device based on the decoding.

In some embodiments, another example method includes: (i) transmitting, by a set of a plurality of antennas of a transmitter, a plurality of power waves, such that at least a portion of the plurality of power waves are phase shifted by the transmitter to converge to form a first constructive interference pattern at a first location of a receiver that is coupled with an electronic device; (ii) receiving, by a communications device of the transmitter, a signal from the receiver, the signal indicating a geographical location of the electronic device coupled to the receiver, a power level of a battery of the electronic device, and a unique identifier associated with the electronic device; (iii) storing, by the transmitter, into a database configured to store device data associated with one or more electronic devices, the geographical location and the unique identifier; and (iv) transmitting, by the set of the plurality of antennas of the transmitter, the plurality of power waves while receiving the signal from the receiver, such that at least a portion of the plurality of power waves are phase shifted by the transmitter to converge to form a second constructive interference pattern, distinct from the first constructive interference pattern, at the second location of the receiver, and the second location is based on at least one of the geographical location of the electronic device, the power level of the battery of the electronic device, and the unique identifier associated with the electronic device, and the receiver is configured to harvest energy from the first and second constructive interference patterns to at least partially power the electronic device.

In some embodiments, the method further includes: (i) identifying, by the transmitter, a new geographical location of the receiver based upon the signal received from the receiver; and (ii) updating, by the transmitter, the device data of the electronic device stored in one or more storage media according to at least one geographical location received from the signal, in response to identifying the new geographical location based on the signal.

In some embodiments, storing the geographical location into the database further includes: uploading, by the transmitter, the geographical location of the electronic device to the database of a cloud-based service.

In some embodiments, the method further includes: (i) determining whether the second location (e.g., the new geographic location) of the receiver indicates that the electronic device is located within a predetermined location; and (ii) in accordance with a determination that the second location of the receiver indicates that the electronic device is not located within the predetermined location, sending a notification to a user other than a user associated with the electronic device.

In some embodiments, the method further includes: (i) determining whether the second location (e.g., the new geographic location) of the receiver indicates that the electronic device is located within a predetermined location; and (ii) in accordance with a determination that the second location of the receiver indicates that the electronic device is not located within the predetermined location, activating an alarm system that is connected to the transmitter.

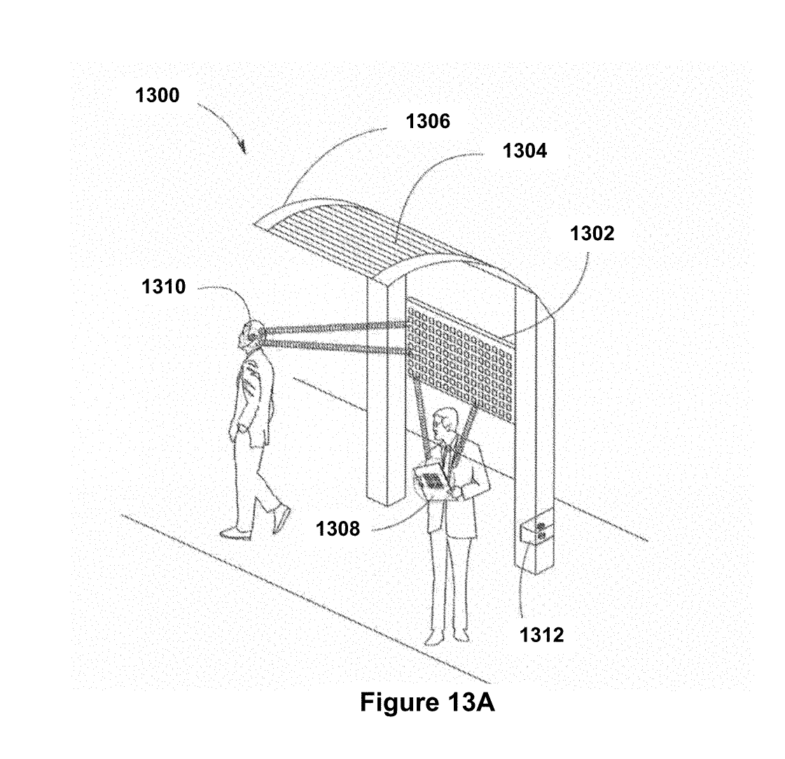

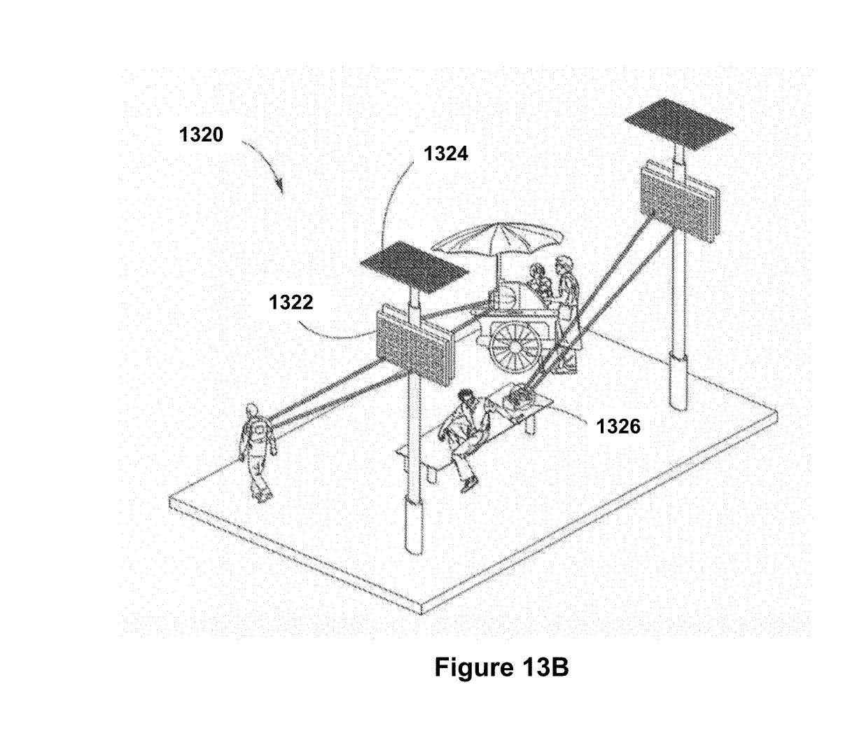

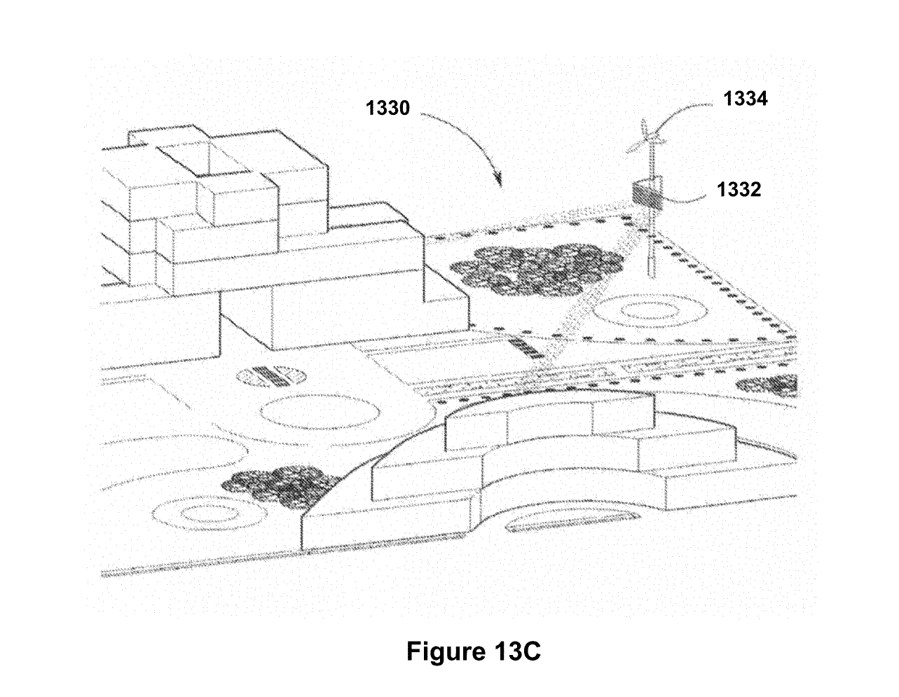

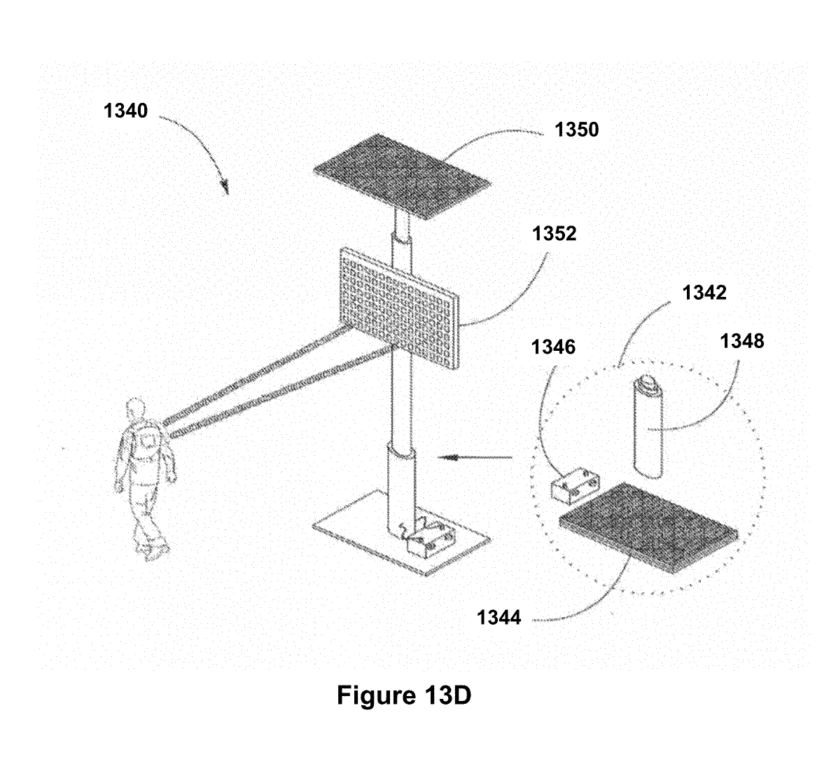

FIGS. 13A-13D illustrate wireless power transmission systems powered with alternative energy sources, in accordance with some embodiments.

FIG. 13A illustrates a wireless power transmission system (WPT) 1300 where a transmitter 1302, similar to transmitter 102 described in FIG. 1 above, utilizes at least one solar panel 1304 as power supply for providing wireless power, through pocket-forming, to users wanting to charge their electronic devices. In this embodiment, a bus stop station may include solar panel 1304 in its roof 1306 for providing solar power to transmitter 1302. Users at such a bus stop station may power their electronic devices, wirelessly through pocket forming, while waiting for transportation. In this embodiment, one user may charge a tablet 1308 while another user may power a BLUETOOTH headset 1310. Both electronic devices, i.e., tablet 1308 and/or headset 1310 may include receivers suitable for pocket forming (e.g., an embodiment of the receiver 120, FIG. 1). Moreover, the aforementioned bus stop station may include an energy storing unit 1312 for saving surplus solar energy. Such energy storing unit 1312 may function as battery component for transmitter 1302. WPT 1300 may be beneficial because users can power devices using alternative sources of energy different from coal or fuel oils. Moreover, electronic devices can be charged while traveling without requiring any wired connections and without the inconveniences typically associated with carrying chargers. The disclosed arrangement could also be employed in train stations, airports and other such places. Furthermore, energy storing unit 1312 can be used to provide power at such locations during the night, or during poor solar conditions.

FIG. 13B illustrates a wireless power transmission system (WPT) 1320 where either one or a plurality of transmitters 1322 can be used to provide wireless power, through pocket-forming, to pedestrians wanting to charge electronic devices. As in the previous embodiment from FIG. 13A, transmitter 1322 can utilize solar panels 1324 as power supply. In addition, transmitter 1322 and solar panel 1324 can be placed in lamp pole structures and can be seen as mainstream infrastructure. Solar panels 1324 for this application can be from about 10 feet to about 30 feet in size. In this embodiment, pedestrians may charge their electronic devices, which may operatively be coupled to, attached to, or otherwise include receivers suitable for pocket-forming, while walking on the street on their way to work or while enjoying foods or beverages in food carts and the like. In some embodiments, WPT 1320 can be used wherever a lamp pole structure can be placed, for example, in parks, bridges and the like. In other variations of WPT 1320, pedestrians may charge portable rechargeable batteries 1326 which upon charging may be utilized at their homes or work sites. This foregoing embodiment may be beneficial for regions where electricity may be scarce, for example, in villages or in third world contexts. Moreover, electric companies can set up dedicated stations for powering such batteries 1326 and may charge a fee based on the amount of power requested. WPT 1320 may lead to spreading green infrastructures for power handling and distribution. Such an example can be seen in FIG. 13C below.

FIG. 13C illustrates a wireless power transmission system (WPT) 1330 where a transmitter 1332 may utilize a typical wind turbine 1334 as power supply. By using the power of the wind and the components typically associated with wind turbine 1334, power can be delivered wirelessly, through transmitter 1332 and pocket-forming, to houses or dedicated regions without utilizing wires, thereby reducing the cost associated with the distribution of energy. In addition, wireless power can be used by any user in the region utilizing a pocket-forming enabled device, i.e., utilizing devices which may operatively he coupled to, attached to or otherwise include receivers suitable for pocket-forming.

FIG. 13D illustrates a wireless power transmission system (WPT) 1340 where a portable assembly 1342 for delivering power wirelessly may be utilized. Assembly 1342 may include a power module 1344 which may further include a power source and a transmitter (not shown), a battery component 1346 for storing surplus energy, and a collapsible pole structure 1348 for mounting the aforementioned components. Pole structure 1348 can be made of a suitable material, for example aluminum, which provides high strength, durability, and low weight. Pole structure 1348 when extended can be of about 10 to 30 feet in height. In its top part, a power source, such as a solar panel 1350 (included in module 1344) may be placed. Then, a transmitter 1350 (also from module 1344) may be attached to pole structure 1348 by suitable mechanical means such as brackets, fasteners, and the like. Moreover, transmitter 1352 may electrically be connected to solar panel 1350 to utilize solar energy for providing wireless power. Lastly, battery component 1346 may also be connected to store surplus energy which can be used to provide power during the night, or during poor solar conditions. Finished Assembly 1342 can be seen in centered in FIG. 13D. This configuration for WPT 1340 can be beneficial when users requiring power find themselves in areas where electricity may be scarce, for example, in villages in the third world, in jungles, deserts, while navigating in the ocean, or any other situation or location where power may not be accessible.

FIGS. 13A-13D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 13A-13D.

Presented below are example methods of wirelessly delivering power to receivers using renewable energy source.

In some embodiments, an example method includes transmitting controlled RF waves from a transmitter that converge to form pockets of energy in 3D space for powering a portable electronic device, connecting an alternate energy source to the transmitter to provide power to the transmitter, and capturing the pockets of energy by a receiver to charge or power the electronic device connected to the receiver.

In some embodiments, another example method includes: (i) receiving, by an antenna of a receiver associated with the mobile electronic device, a pocket of energy generated in response to transmission signal waves emitted by a pocket-forming transmitter coupled to a power source, the power source configured to use alternative energy; and (ii) converting, by a rectifying circuit of the receiver, the received pocket of energy into electricity to charge the electronic device.

In some embodiments, the power source is configured to use alternative energy includes a solar panel. In some embodiments, the solar panel is of a predetermined size and mounted on a pole configured to extend reach of the transmission signal waves emitted by the pocket-forming transmitter.

In some embodiments, the power source is configured to use alternative energy includes a wind turbine.

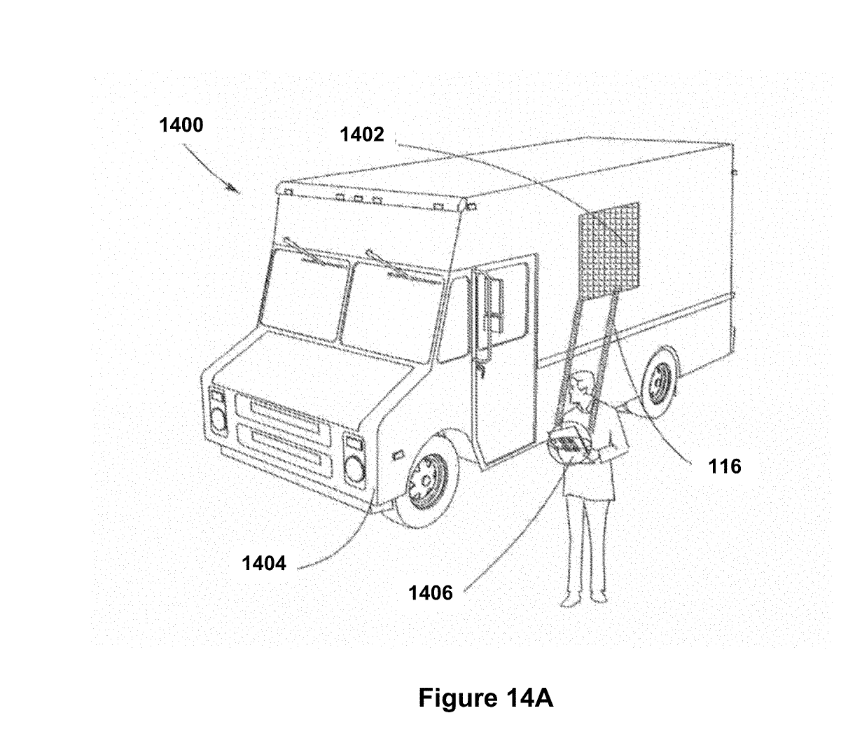

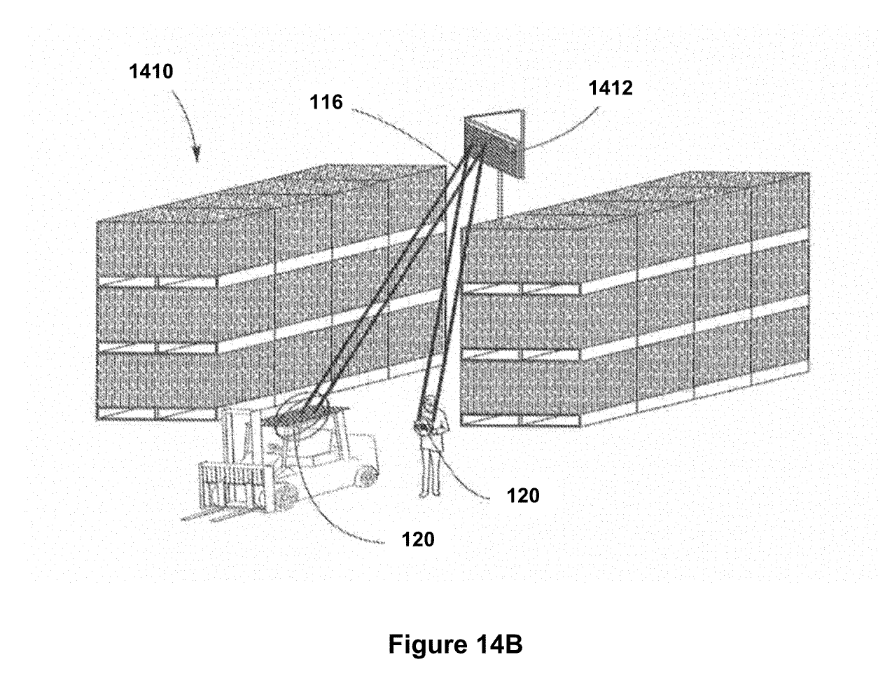

FIGS. 14A-14B illustrate wireless power transmission systems for logistic services, in accordance with some embodiments.

FIG. 14A shows a wireless power transmission system 1400 where a transmitter 1402 (e.g., an embodiment of the transmitter 102, FIG. 1) may be located on or within a delivery vehicle 1404, according to an embodiment. Delivery vehicle 1404 may be a postal truck, a pizza truck, armored truck for bank services and the like. Transmitter 1402 may use a diesel generator as power source, however, other power sources such as, alternator of vehicle 1404, photovoltaic cells, and the like may be employed too. Transmitter 1402 may generate and direct RF waves 116 (FIG. 1) towards the receivers embedded or attached to electronic devices such as laptops, GPS, radios, cellphones, tablets among others. In addition, transmitter 1402 in delivery vehicle 1404 may wirelessly extend the life of batteries in the previously mentioned devices during the operation.

Transmitter 1402 may be in a door, wall, top of the delivery vehicle 1404 and the like. Furthermore, other transmitter 1402 configurations may be used in dependency of the region and requirement, such requirement may include transmitter 1402 on telescopic mast for increasing range.

FIG. 14B shows warehouse 1410 where one or more transmitters 1412 may be located in walls or ceiling for powering and charging electronic devices, such electronic devices may include tablets, laptops, cellphones, radios, lifters, hoists and the like. Transmitter 1412 may be connected to an electrical grid which may operate as power source, other power sources may be employed too. Transmitter 1412 may generate and direct RF waves 116 towards the receivers 120 embedded or attached to electronic devices such as laptops, GPS, radios, cellphones, hoists, tablets among others. In addition, transmitter 1412 may wirelessly extend the life of batteries in the previously mentioned devices during the operation.

Transmitter 1412 may be in wall, ceiling of the warehouse 1410 and the like. Furthermore, other transmitter 1412 configurations may be used in dependency of the region and requirement, such requirement may include transmitter 1412 on telescopic mast for increasing range.

FIGS. 14A-14B illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 14A-14B.

Presented below is an example method of wirelessly delivering power to receivers used in logistic services.

In some embodiments, an example method includes: (i) communicating, by a receiver associated with the electronic logistics device, a power requirement for the electronic logistics device to a transmitter, (ii) receiving, by an antenna of the receiver, a pocket of energy generated in response to power transmission waves emitted by the transmitter, and (iii) converting, by a rectifying circuit of the receiver, the received pocket of energy into electricity to charge the electronic logistics device.

In some embodiments, the receiver includes a power converter and a communication component to establish communication with the transmitter when the electronic logistics device is within a predetermined distance from the pocket-forming transmitter.

In some embodiments, the communication component communicates with the transmitter through a transmission signal using a protocol selected from the group consisting of: BLUETOOTH®, WI-FI®, ZIGBEE®, or FM radio.

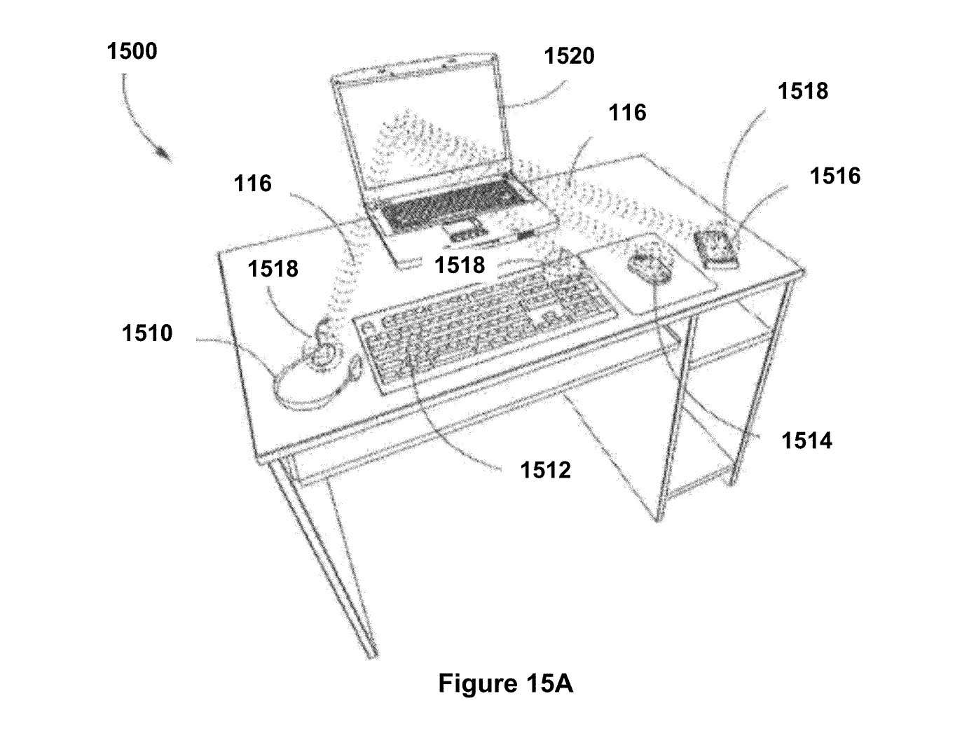

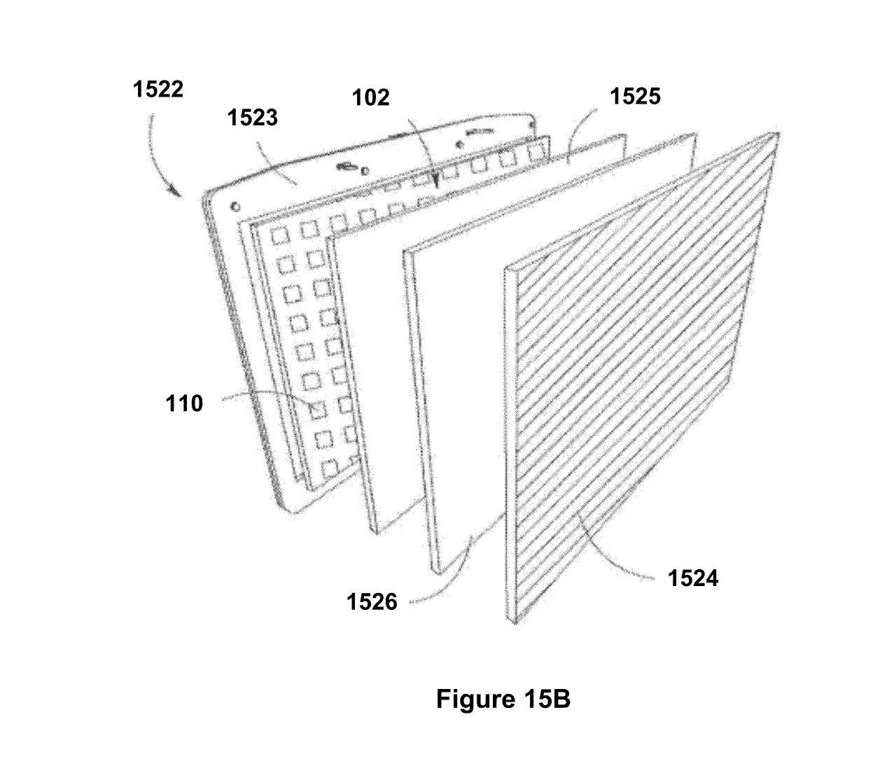

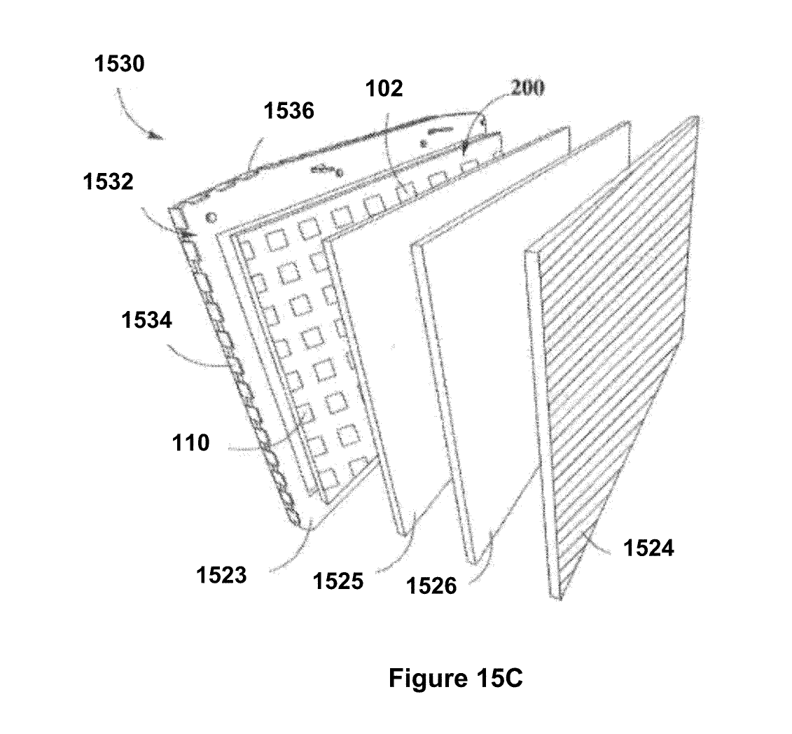

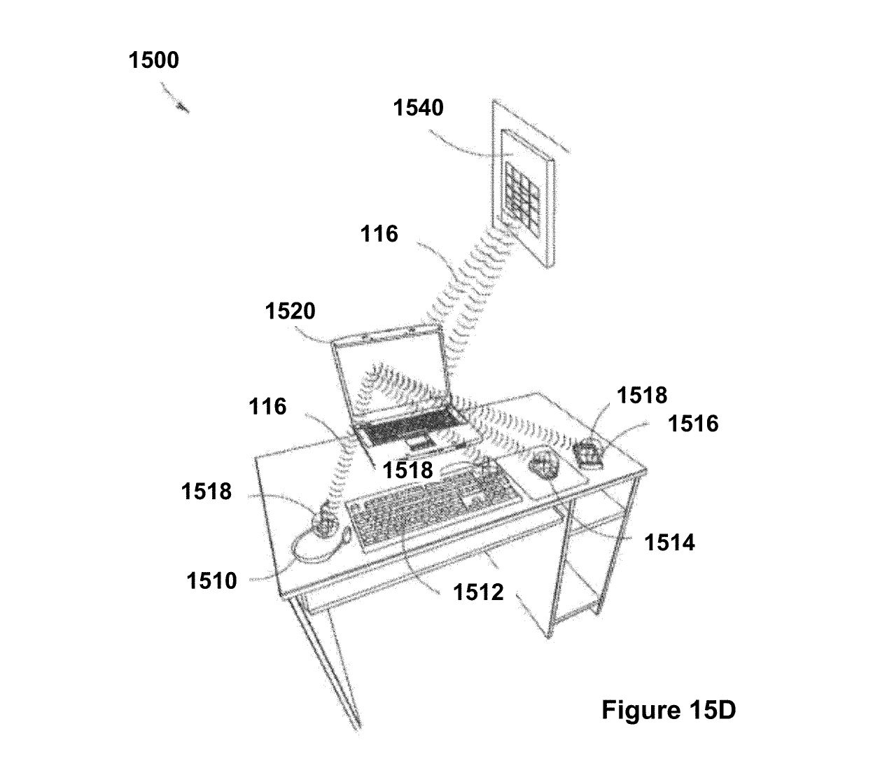

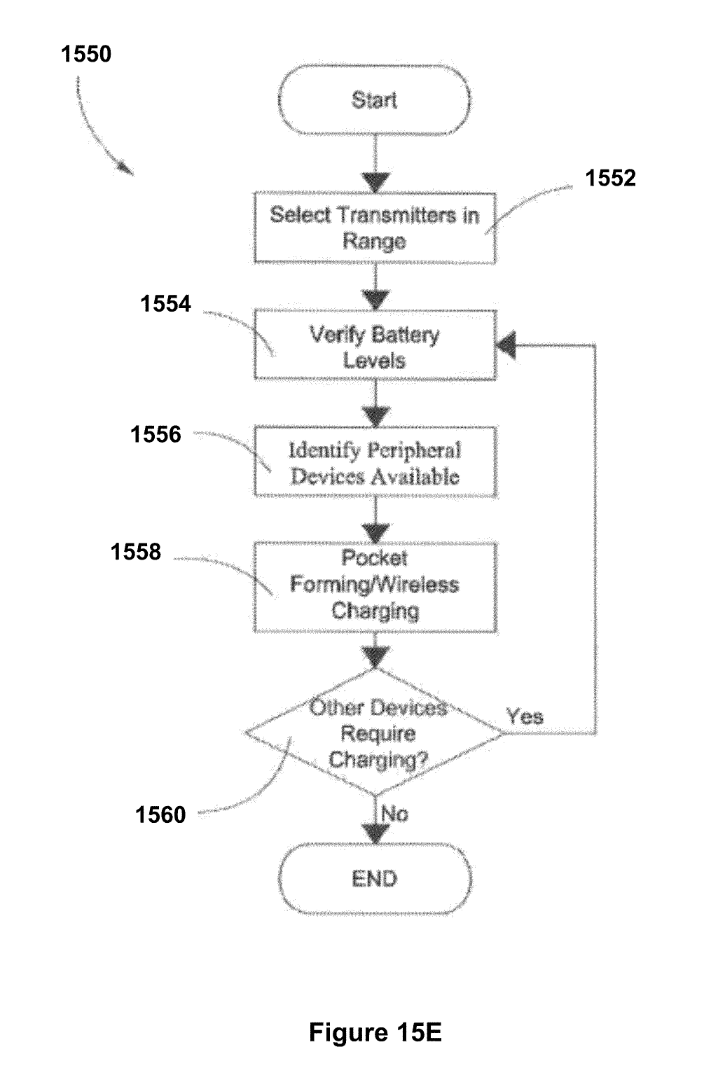

FIG. 15A is an illustration showing a wireless power transmission system 1500 used for charging one or more peripheral devices via a transmitter (e.g., an embodiment of the transmitter 102, FIG. 1) associated with a laptop computer (e.g., a laptop with an embedded transmitter and which may also include an embedded receiver 120, FIG. 1), in accordance with some embodiments. The peripheral devices may include a headset 1510, a keyboard 1512, a mouse 1514, and a smartphone 1516, among others. In some embodiments, these peripheral devices may operate wirelessly with laptop computer through BLUETOOTH communication, and may include rechargeable batteries that are charged using wirelessly delivery power, as described below.

A transmitter (which may be embedded within the laptop 1520) may transmit controlled RF waves 116 which may converge in 3D space to form a pocket of energy near one or more of the peripheral devices. These RF waves 116 may be controlled through phase and/or relative amplitude adjustments to form constructive and destructive interference patterns (pocket-forming). Pockets of energy 1518 may be formed as constructive interference patterns and may be 3Dimensional in shape, while null-spaces may be generated using destructive interference of RF waves. As explained above, respective receivers 120 embedded in the peripheral devices convert energy from the RF waves that have accumulated in the pockets of energy 1518 to usable power for charging or powering batteries in the peripheral devices.

In some embodiments, the laptop computer 1520 may be connected to a conventional wall outlet for charging its battery to suitable levels, while providing wireless power transmission to the peripheral devices.

FIG. 15B is an exploded view of a laptop screen 1522, showing components including an embedded wireless power transmitter 102 with transducer elements 110 (FIG. 1), in accordance with some embodiments. In some embodiments, the laptop screen 1522 may be formed of different layers, including a front transparent screen layer 1524, a polarized film layer 1526, a LED/LCD back-light layer 1525, and a frame 1523. In some embodiments, transmitter 102 may be integrated in the screen, specifically between LED/LCD back-light layer 1525 and frame 1523. As shown in FIG. 15B, the transmitter 102 may include a plurality of transducer elements 110 facing out of the screen. This configuration of transducer elements 110 may allow suitable transmission of RF waves towards the peripheral devices discussed above in reference to FIG. 15A. In other embodiments, the transmitter 102 may be embedded in circuitry elements or metal mesh (touchscreen versions) of the screen.

FIG. 15C is an exploded view of a laptop screen 1530, showing components including an embedded wireless power transmitter 102 with transducer elements 110 and an embedded wireless power receiver 1532 (e.g., an embodiment of receiver 120, FIG. 1), in accordance with some embodiments. The laptop screen 1530 may be formed of different layers, as described above in reference to FIG. 15B. In some embodiments, the transmitter 102 may be integrated between LED/LCD back-light layer 1525 and frame 1523, while receiver 1532 may be integrated along frame 1523. As shown in FIG. 15C, in some embodiments, transducer elements 110 of transmitter 102 may pointing out of the screen 1530, while sensor elements 1534 of receiver 1532 may be embedded around the edges of frame 1523 for allowing reception of RF waves from sources or transmitters at different locations.

The location and configuration of transmitter 102 and receiver 1532 in laptop computer screen 1530 may vary according to the application. In some embodiments, the receiver 1532 may be configured in a middle of the back of frame 1523 and may include high directional sensor elements 1536 that can be oriented towards a transmitter in proximity to the laptop computer 1520 for receiving suitable wirelessly power transmission that may be used to power the laptop 1520. In other embodiments, laptop computer screen 1530 may include a single transmitter 102 that may also operate as a receiver 120, in which case, transmitter 102 may use same transducer elements 110 for transmitting and receiving RF waves. That is, the transmitter embedded in laptop computer screen 1530 may switch between those transducer elements 110 receiving RF waves for charging a battery of the laptop or transmitting RF waves for charging batteries in peripheral devices. An algorithm executed by a microcontroller of the laptop may be used to control the switching between transmitting and receiving RF waves.

FIG. 15D is an illustration showing the wireless power transmission system 1500 of FIG. 15A, in which the laptop computer 1520 is also configured with an embedded receiver 120, so that the laptop 1520 may receive and transmit RF waves in a substantially simultaneous fashion, in accordance with some embodiments. In some embodiments, one or more separate transmitters 1540 may direct RF waves 116 towards edges of the laptop computer's screen where sensor elements of the embedded receiver may be integrated (not shown). In this way, pockets of energy may be captured by the sensor elements and utilized by the embedded receiver to charge a battery of the laptop 1520. Simultaneously, an embedded transmitter 102 (not shown), may direct RF waves towards one or more peripheral devices.

In some embodiments, transmitter 1540 may include a higher amperage power source such as a standard 120/220 volts AC house connection compared to transmitter 102 embedded in the laptop, which may obtain power from only from a battery of the laptop. This may allow the transmitter 1540 to have a wider wireless charging range as compared to the embedded transmitter of the laptop. In some embodiments, the various peripheral devices 1510, 1512, 1514, and 1516 may receive wirelessly delivered power from either or both of the transmitter 1540 and the embedded transmitter of the laptop. In some embodiments, an algorithm processed by a microcontroller of the laptop and/or the transmitter 1540 may coordinate wirelessly power delivery operations between the transmitters. For example, this algorithm may decide which transmitter should send RF waves to wirelessly charge peripheral devices, depending on proximity and/or energy levels of a battery in the laptop computer.

FIG. 15E is a flow diagram of a method of wireless power transmission that may be implemented for charging one or more peripheral devices using a laptop computer (e.g., the laptop discussed above in reference to FIGS. 15A-15D), in accordance with some embodiments.

Wireless power transmission process 1550 may begin by selecting one or more transmitters in range, at block 1552. One or more peripheral devices may require wireless charging, in which case, one or more transmitters in a room, or an embedded transmitter 102 of the laptop may be selected if they are within a suitable range. For example, if a smartphone is not within a suitable charging distance from the laptop (e.g., not in the table, or within 3-4 feet of the laptop), then a higher power transmitter 1540 may be selected for delivering wireless power. In some embodiments, a wireless charging distance for the embedded transmitter of the laptop may be within a range of about 1 to 3 meters, and if peripheral devices are outside this range, then they instead will be wirelessly charged by transmitter 1540.

The laptop may also include a software application that may provide information about distance, charging levels, efficiency, location, and optimum positioning of the laptop computer with respect to peripheral devices and transmitter 1540.

After selecting the transmitter within the optimal charging range, wireless power transmission process 1550 may continue by checking charge levels of the battery in the laptop, at block 1554. This check may be performed by a control module included in the laptop (not shown) or by a microcontroller included with the transmitted embedded in the laptop. In some embodiments, a charge level of the laptop must be above a certain threshold to allow the laptop to transmit wireless power. For example, minimum and maximum charging thresholds may be established at about 25% and 99% of total charge, respectively. That is, if battery charge is below the minimum threshold or 25%, then the laptop must be connected to a power outlet or it may receive wireless charging from transmitter 1540. When battery charge is at 99% or at least above 25%, the laptop 102 may transmit RF waves for charging peripheral devices that are within range.

Wireless power transmission process 1550 may continue at block 1556, where a communications component of the embedded transmitter or transmitter 698 may identify one or more peripheral devices that may require wireless charging. In some embodiments, priority charging orders are established and utilized to ensure that the one or more peripheral devices are charged in a particular order.

After the one or more peripheral devices are identified and charging priorities/parameters in the embedded transmitter or transmitter 1540 are set, transmission of RF waves towards designated peripheral devices can begin, at block 1558, where these RF waves may constructively interfere to generate pockets of energy proximate to the peripheral devices, which pockets of energy may be converted by respective embedded receivers to usable power for powering or charging the one or more peripheral devices, sequentially or simultaneously.

Using a communications component, the embedded transmitter of the laptop or transmitter 1540 on the wall may continuously check if there are other peripheral devices that may require wireless charging or powering, at block 1560. If new or additional peripheral devices are identified, then either transmitter may wirelessly charge the newly identified peripheral devices according to the established charging priorities, optimum ranges, battery levels and/or other parameters. If no further peripheral devices are recognized or need wireless charging, then wireless power transmission process 1550 may end.

FIGS. 15A-15E illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 15A-15E.

Presented below are example systems and methods of wirelessly delivering power to receivers using a transmitter coupled to an electronic device (e.g., a laptop).

In some embodiments, an example method includes, embedding a pocket-forming transmitter in a screen display of the computer system; transmitting power RF waves from the pocket-forming transmitter having a radio frequency integrated circuit, antenna elements, a microprocessor and communication circuitry; generating pockets of energy from the transmitter to converge in 3D space at predetermined locations; integrating a receiver having antenna elements and communication circuitry within the electronic device; and converting the pockets of energy from the transmitter to the integrated receiver to power the electronic device.

In some embodiments, the computer system is a laptop, notebook or nano-notebook. In some embodiments, computer system is a desktop computer, a tablet, iPad, iPhone, smartphone or other peripheral portable electronic devices.

In some embodiments, the computer system includes an embedded receiver whereby a separate transmitter in proximity to the computer system powers the computer system while the transmitter of the computer system wirelessly charges the electronic device.

In some embodiments, another example method includes, receiving, at a computer system that is coupled to a first transmitter (e.g., directly, mechanically coupled to), information identifying a location of a receiver device that requires charging, and the location is within a predetermined range of the computer system; in accordance with a determination that a charge level of the computer system is sufficient to allow the computer system to provide wireless power to the receiver device, transmitting a first set of power waves, via a plurality of antennas of the first wireless power transmitter, that converge proximate to the location of the receiver device to form a pocket of energy at the location; and while transmitting the first set of power waves that converge proximate to the location of the receiver device to form the pocket of energy at the location: (i) receiving, at the computer system, a second set of power waves from a second wireless power transmitter, distinct and separate from the first wireless power transmitter, and (ii) charging the computer system by converting energy from the second set of power waves into usable electricity.

In some embodiments, the first transmitter is integrated between a back-light layer and a frame of a screen display of the computer system.

In some embodiments, the first transmitter is embedded in a screen of the computer system.

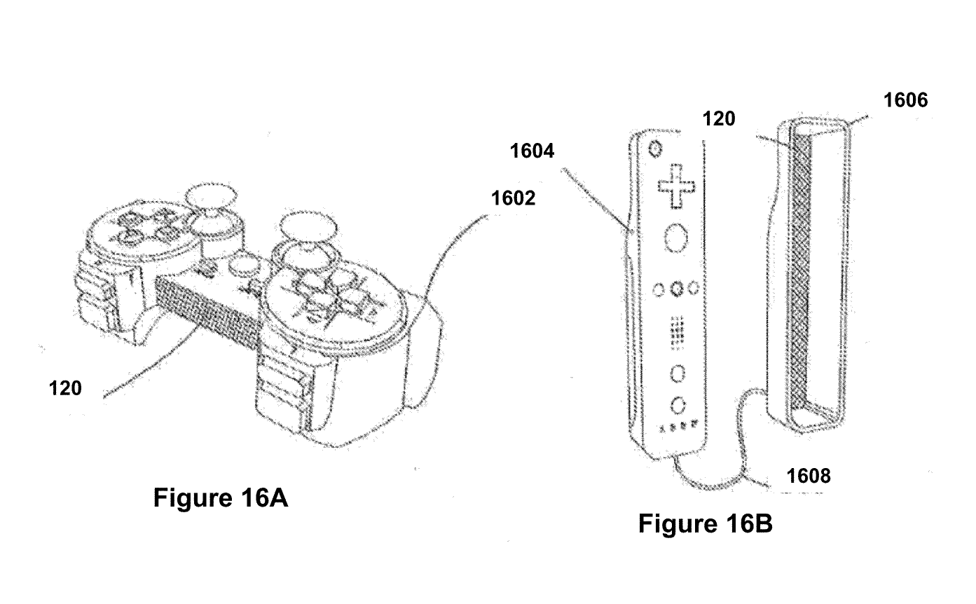

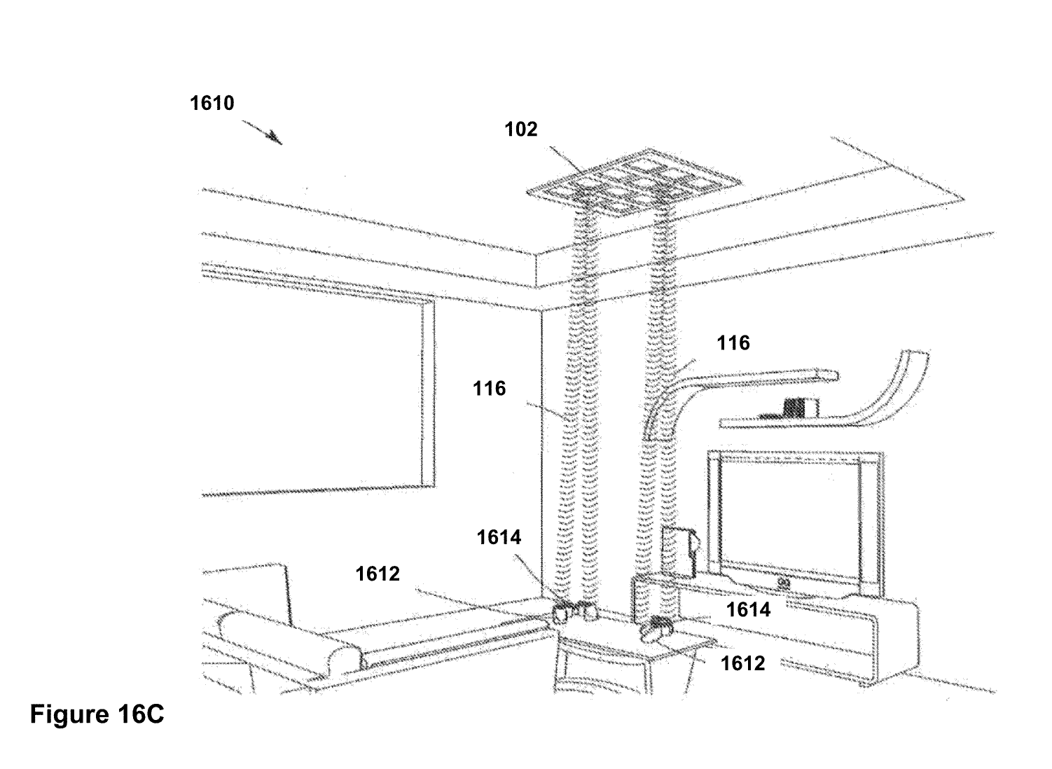

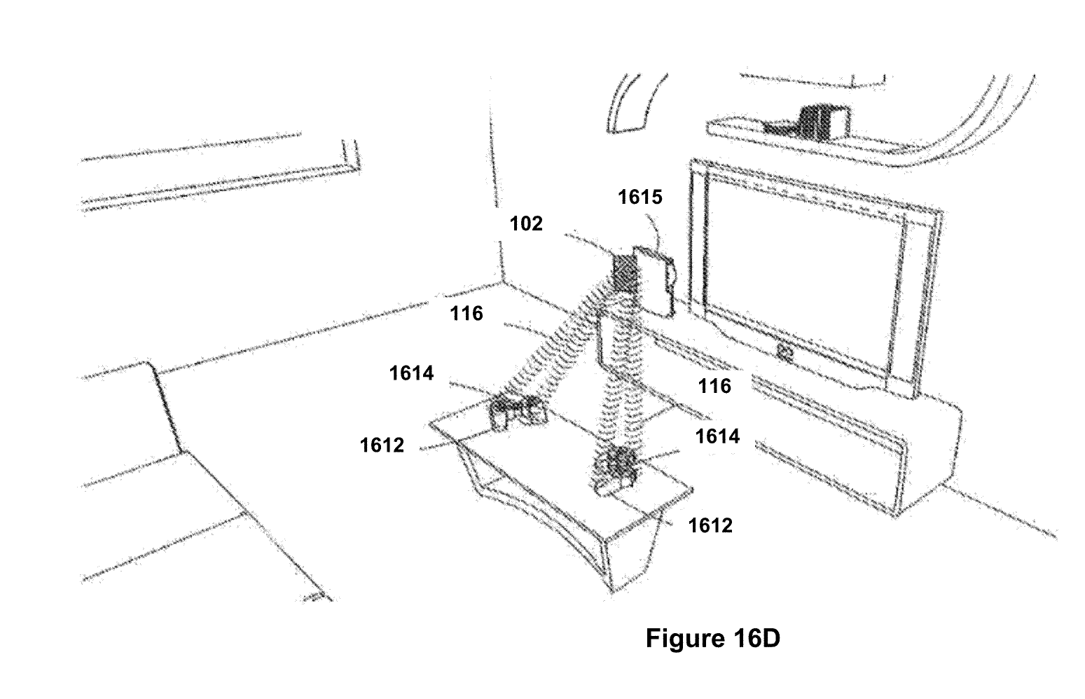

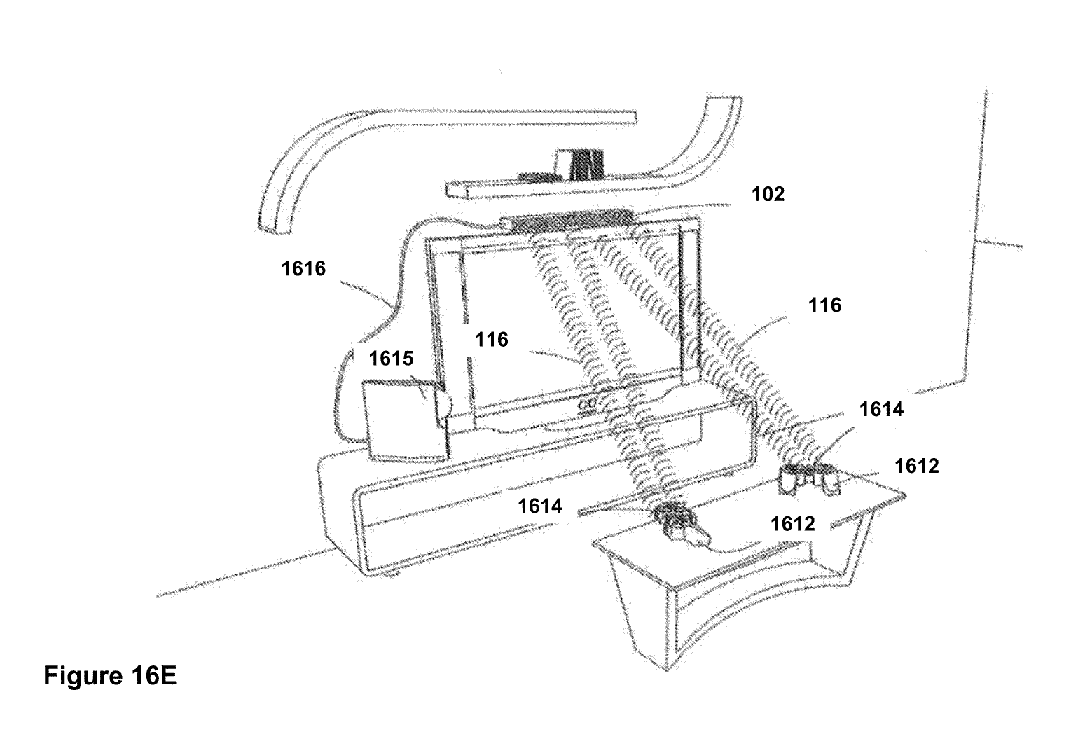

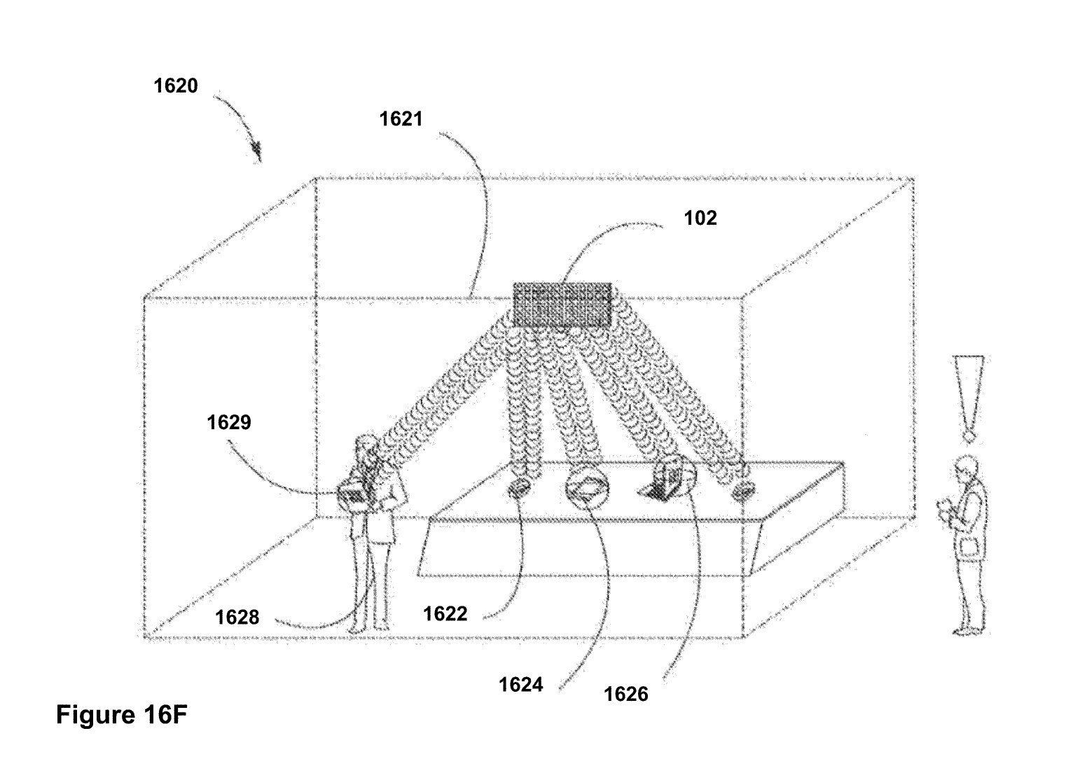

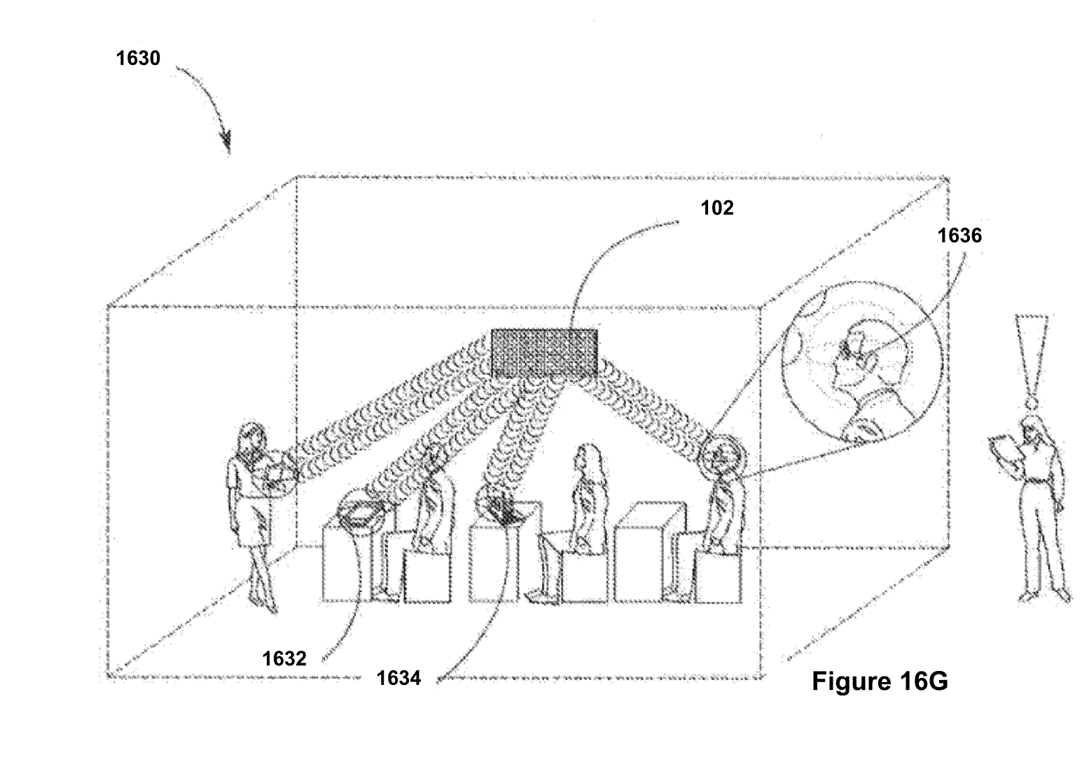

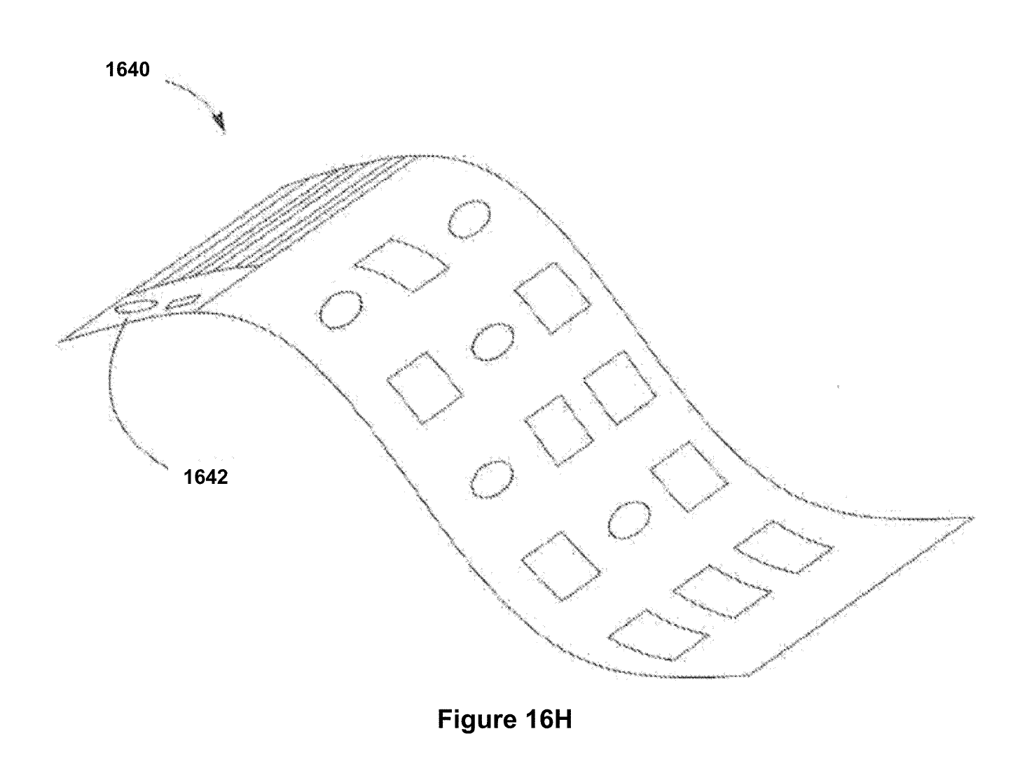

FIGS. 16A-16B are illustrations of game controllers that are coupled with wireless power receivers, in accordance with some embodiments. As shown in FIG. 16A, a receiver 120 may be integrated on a front side of the game controller 1602, and the receiver 120 may include an array of sensor elements strategically distributed to match the game controller's design.

In FIG. 16B, another game controller 1604 is shown and that controller includes a receiver 120 that is integrated with an additional case 1606 to provide wireless power receiver capabilities to the game controller 1604. Case 1606 may be made out of plastic rubber or any other suitable material for cases, and it may include an array of sensor elements located on the back side of the case, which number and type may be calculated according to the game controller design. Case may also be connected to game controller 1604 through a cable 1608, or in other embodiments, the case 1606 may be attached to a surface of the game controller 1604.

FIGS. 16C-16G illustrate various wireless power transmission systems in which power is wirelessly delivered to electronic devices using RF waves, in accordance with some embodiments.

FIG. 16C illustrates a wireless power delivery system 1610 that wirelessly transmits power to game controllers 1612, using pocket-forming. In some embodiments, transmitter 102 may be located at the ceiling of a living room pointing downwards, and may transmit controlled RF waves 116 which may converge in 3D space. The amplitude of the RF waves 116 may be controlled through phase and/or relative amplitude adjustments to form constructive and destructive interference patterns (pocket-forming), and produce controlled pockets of energy 1614. Receiver 120, embedded or attached to game controllers 1612, may then utilize energy from the pockets of energy for charging or powering an electronic device.

In FIG. 16D, the transmitter 102 is coupled with a game console 1615, and the receivers embedded within respective game controllers 1612 wirelessly receive RF waves from the transmitter 102 and then convert energy from the RF waves that has accumulated in pockets of energy 1614 into usable power.

In FIG. 16E, the transmitter 102 is coupled with a game console 1615 via a cable 1616 (such as a USB cable), and the receivers embedded within respective game controllers 1612 wirelessly receive RF waves from the transmitter 102 and then convert energy from the RF waves that has accumulated in pockets of energy 1614 into usable power. In some embodiments, the game console 1615 produces power along the cable 1616, and the transmitter uses that power to generate RF waves that are then transmitted to the game controllers 1612 for charging and powering purposes, as described above.

FIG. 16F illustrates a wireless power delivery system 1620 where various electronic devices, for example a smartphone 1622, a tablet 1624, and a laptop 1626 may receive power, through pocket-forming techniques (as described throughout this detailed description), utilizing a transmitter 102 at a predefined range 1621. In some embodiments, these devices may include embedded receivers 120 (or be otherwise operatively coupled to receivers) and capacitors for obtaining necessary power for performing their intended functions. In some embodiments the system 1620 may be utilized in retail stores where interaction between electronic devices (used for showcase) and potential buyers may be limited due to the presence of wired connections. A potential buyer 1628 may be interested in acquiring a tablet 1629 and, because the system 1620 has been implemented, the buyer 1628 may interact freely with the tablet 1629 before purchasing, but subject to certain restrictions. For example, were buyer 1628 to step out of the range at which transmitter 102 wirelessly delivers power, tablet 1629 may no longer operate (as can be seen in the rightmost part of FIG. 16F for another buyer). In some embodiments, the transmitter 102 may also detect when a tablet or other device travels outside of its range, and may then issue an alarm.

The wireless power delivery system of FIG. 16F may be applied to other settings, such as educational environments 1630, as shown in FIG. 16G. For example, in educational programs for developing or unprivileged cities, regions and countries, teachers and students may be provided with tablets, electronic readers, laptops or even virtual glasses for imparting and. taking notes during lectures. However, such equipment may be expensive. Therefore, measures for preventing unauthorized usage of such devices may be employed. For example, devices may be wired to school chairs so that they may not be taken outside classrooms. However, utilizing electronic devices with embedded wireless power receivers may improve the foregoing situation. In some embodiments, a transmitter 102 inside a classroom may provide wireless power, through pocket-forming techniques, to various electronic devices with embedded receivers and capacitors (not shown), for example an e-reader 1632, a laptop 1634, and virtual glasses 1636 which may be used by different users in the educational setting. The foregoing electronic devices may become inoperable outside the range of transmitter 102, as can be seen in the rightmost part of FIG. 16G.

FIG. 16H illustrates an improved rollable electronic paper display 1640 used to explain certain advantages of wireless power transmission systems, in accordance with some embodiments. In some embodiments, the display 1640 is produced using flexible organic light emitting diodes (FOLED). In some embodiments, the display 1640 may include at least one embedded receiver 1642 (e.g., an embodiment of the receiver 120 described herein) with a capacitor in one of its corners. Thus, the circuitry for providing power to rollable electronic paper display 1640 may be confined to only a fraction of its surface area, This may improve transparency of the rollable electronic paper display 1640. In other embodiments, an e-reader including the aforementioned receivers and capacitors, may diminish its weight considerably, as well as improve its display brightness. Currently, the weight of e-readers may be driven by their batteries, e.g., up to about 60% to about 80% of the total weight. However, by utilizing the structured described here, batteries may not be required to be as powerful, thereby reducing overall size and weight of the batteries, and in turn diminishing weight of e-readers. Moreover, by diminishing such weight considerably, e-readers can be made thinner. In some embodiments, previous volume used up for battery allocation, can be distributed to increase display capacity.

FIGS. 16A-16H illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 16A-16H.

Presented below are example methods of wirelessly delivering power to receivers in controllers and other devices.

In some embodiments, an example method of wirelessly supplying power to a game controller includes: (i) receiving, by a transmitter, a communication signal indicating a power requirement from a game controller; (ii) generating, by the transmitter, one or more power transmission waves in response to the communication signal from the game controller; (iii) controlling, by the transmitter, the generated power transmission waves, and the transmitter shifts a phase and a gain of a power transmission wave with respect to other power transmission waves based on the communication signal; and (iv) transmitting, by the transmitter, the one or more power transmission waves through at least two antennas coupled to the transmitter.

In some embodiments, the method further includes receiving, by the transmitter, an indication of power remaining in a battery coupled to the game controller and a location of the game controller.

In some embodiments, the game controller is coupled to a receiver, the receiver configured to receive a pocket of energy from the transmitter.

In some embodiments, the receiver includes a plurality of antennas adapted to be a part of an external cover of the game controller.

In some embodiments, another example method includes: (i) receiving, by a transmitter and from a receiver coupled with a game controller, a communication signal indicating a power requirement of the game controller; (ii) in response to receiving the communication signal from the receiver: determining a location of the game controller based on the communication signal; and generating, by the transmitter, a plurality of radio frequency (RF) power transmission waves; and (iii) controlling, by the transmitter, transmission of the generated plurality of RF power transmission waves through at least two antenna elements coupled to the transmitter, and the transmitter shifts a phase and a gain of a respective RF power transmission wave with respect to other respective RF power transmission waves so that the plurality of RF power transmission waves converges to form a constructive interference pattern in proximity to the determined location of the game controller.

In some embodiments, the receiver is coupled with the game controller via an external cover of the game controller, and the receiver includes a plurality of antennas adapted to be a part of the external cover of the game controller.

In some embodiments, the transmitter is a far-field transmitter.

In some embodiments, the method further includes, in response to receiving an additional communication signal from an additional receiver coupled to an additional game controller, and the additional receiver is distinct from the receiver and the additional game controller is distinct from the game controller: controlling, by the transmitter, transmission of an additional plurality of RF power transmission waves so that the additional plurality of RF power transmission waves converges to form an additional constructive interference pattern in proximity to a location of the additional game controller, and the location of the additional game controller is determined by the transmitter based on the additional communication signal.

In some embodiments, the transmitter is coupled with a game console, and generating the plurality of RF power transmission waves includes generating the plurality of RF power transmission waves using power received from the game console.

In some embodiments, an example method includes: (i) connecting a pocket-forming transmitter to a power source; (ii) generating RF waves from a RF circuit embedded within the transmitter; (iii) controlling the generated RF waves with a digital signal processor m the transmitter; (iv) transmitting the RF waves through antenna elements connected to the transmitter within a predefined range; and (v) capturing the RF waves formiug pockets of energy converging in 3D space at a receiver with antenna elements connected to the electronic device within the predefined range to convert the pockets of energy into a DC voltage for charging or powering the electronic device.

In some embodiments, the transmitter identifies each electronic device within the predefined range and delivers power to each approved electronic device through pocket-forming but disables, locks out and removes power from each electronic device when the approved electronic device is moved out of the range of the transmitter for security reasons.

In some embodiments, the transmitter identifies each receiver requesting power and then only powers approved electronic devices within the predefined range of the transmitter.

In some embodiments, the method further includes generating multiple pockets of energy from the pocket-forming transmitter to power or charge multiple, approved electronic devices in an educational setting within the predefined range of the transmitter. In some embodiments, the electronic devices in the educational setting are tablets, electronic readers, laptops, virtual glasses or smartphones provided wireless power through pocket-forming whenever in range of the transmitter but disabled whenever outside of the predefined range of the transmitter.

In some embodiments, another example method includes, transmitting, by a plurality of antennas of a transmitter, a plurality of power waves forming a constructive interference pattern at a location of a receiver, and the receiver is configured to receive power waves only from the transmitter when the receiver is within a predefined distance threshold from the transmitter; and detecting, based on communications signals received from the receiver, that the receiver has moved to a new location. In response to detecting that the receiver has moved to the new location, determining, by a controller of the transmitter, whether the new location of the receiver is within the predefined distance threshold; in response to determining by the controller of the transmitter that the new location is within the predefined distance threshold, adjusting, by the controller of the transmitter, the plurality of antennas such that transmission of the plurality of power waves forms a new constructive interference pattern at the new location of the receiver. The method further includes, in response to determining that the new location is not within the predefined distance threshold, providing, by the transmitter, an indication that the receiver is not within the predefined distance threshold, and the receiver is configured to be inoperable upon exceeding the predefined distance threshold from the transmitter.

In some embodiments, the transmitter: (i) identifies a plurality of receivers, including the receiver, as being within the predefined distance threshold; (ii) delivers power to each approved receiver of the plurality of receivers through one or more constructive interference patterns formed by convergence of power waves in proximity to each approved receiver; and (iii) ceases delivering power to a respective approved receiver when the respective approved receiver is moved out of the predefined distance threshold from the transmitter.

In some embodiments, providing the indication includes issuing an alarm.

In some embodiments, the method further includes, in response to determining by the controller of the transmitter that the new location is within the predefined distance threshold, determining, based on the communications signals received from the receiver, an optimum time and location for forming the new constructive interference pattern at the new location of the receiver.

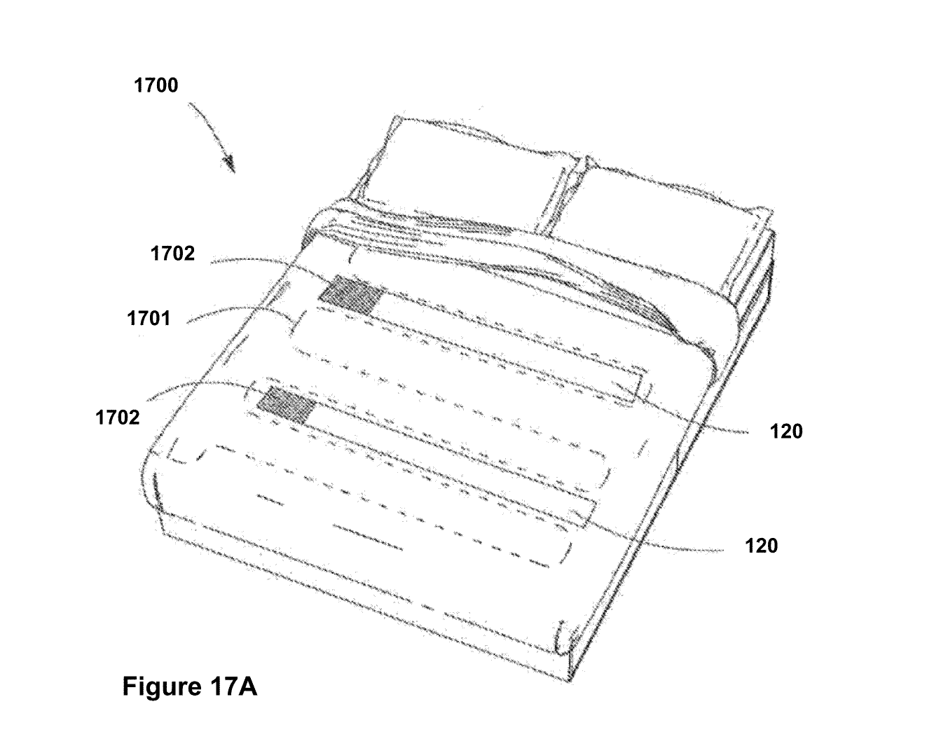

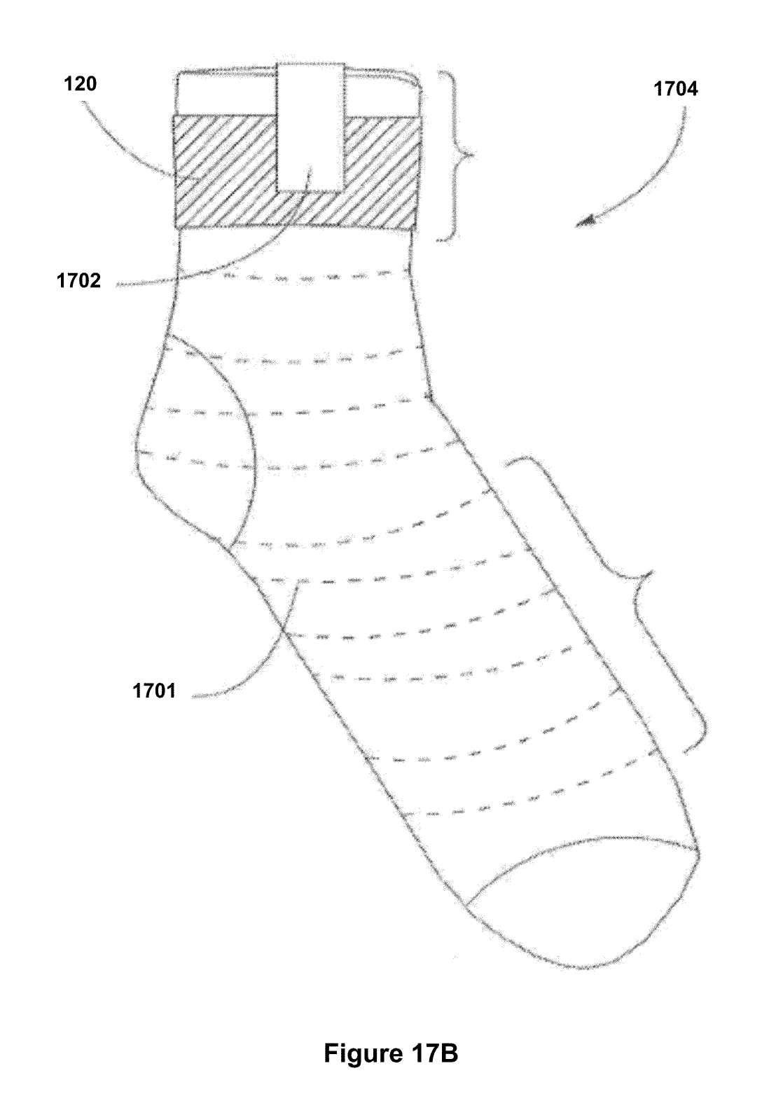

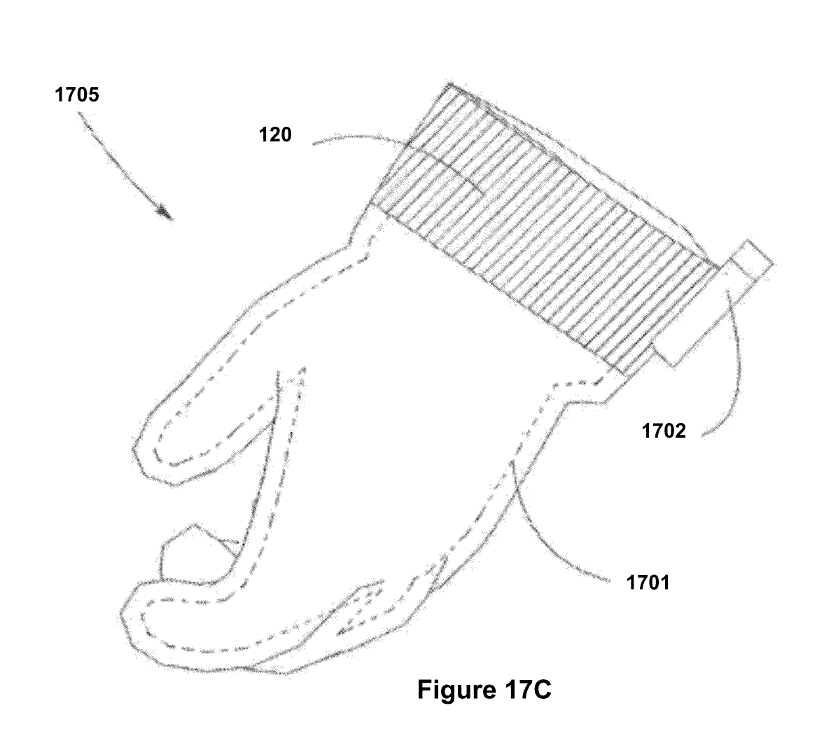

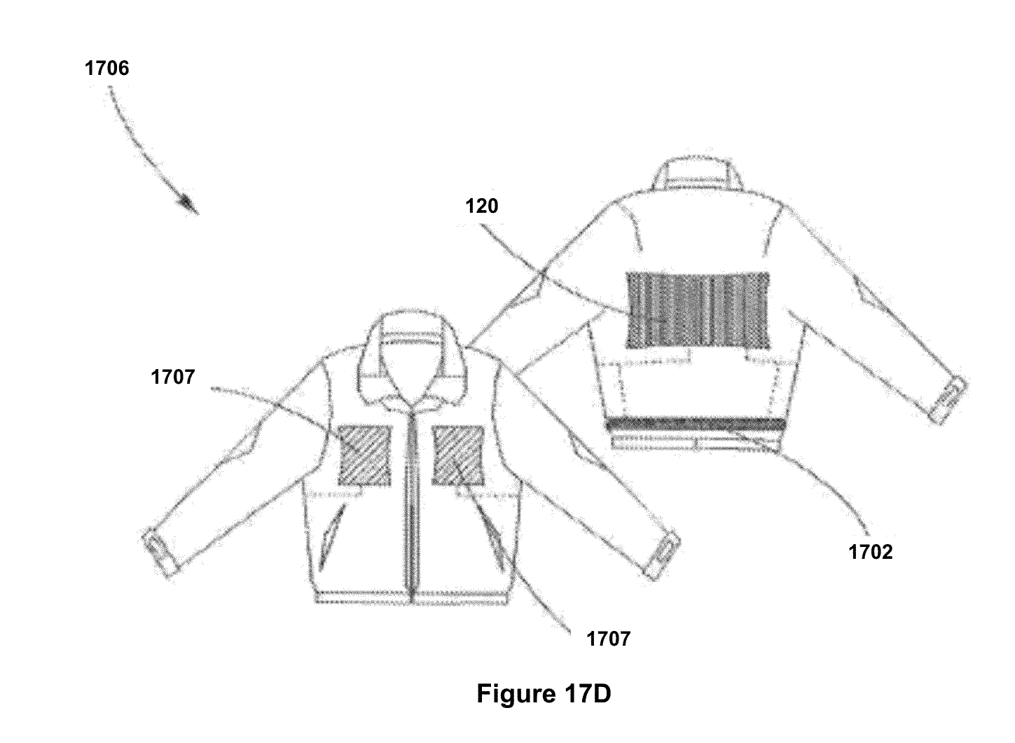

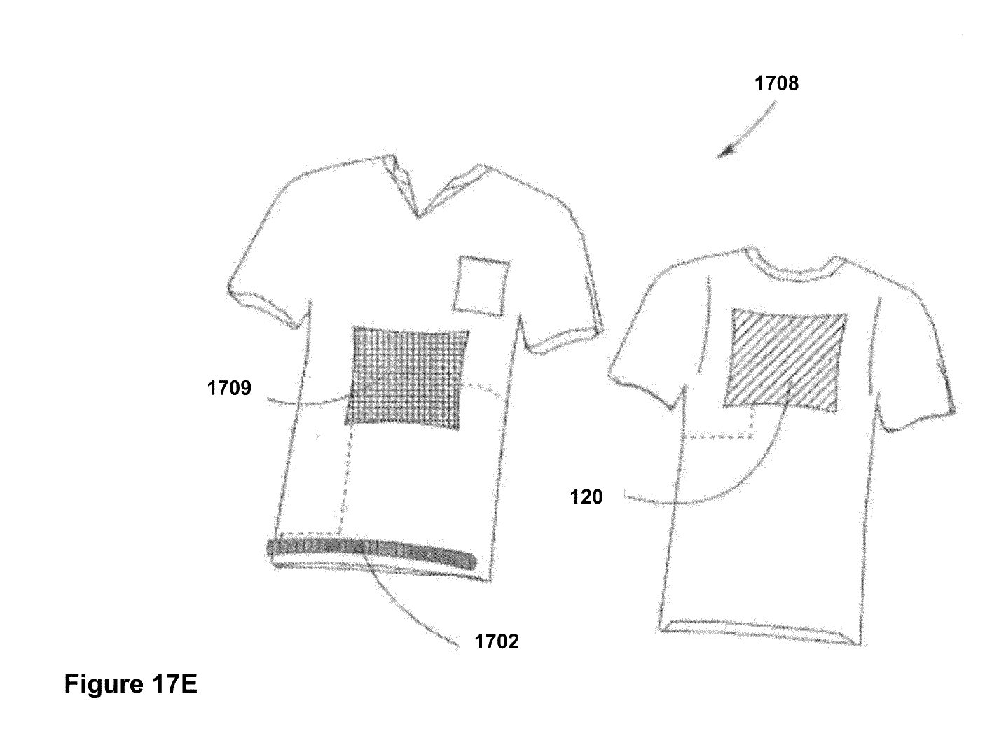

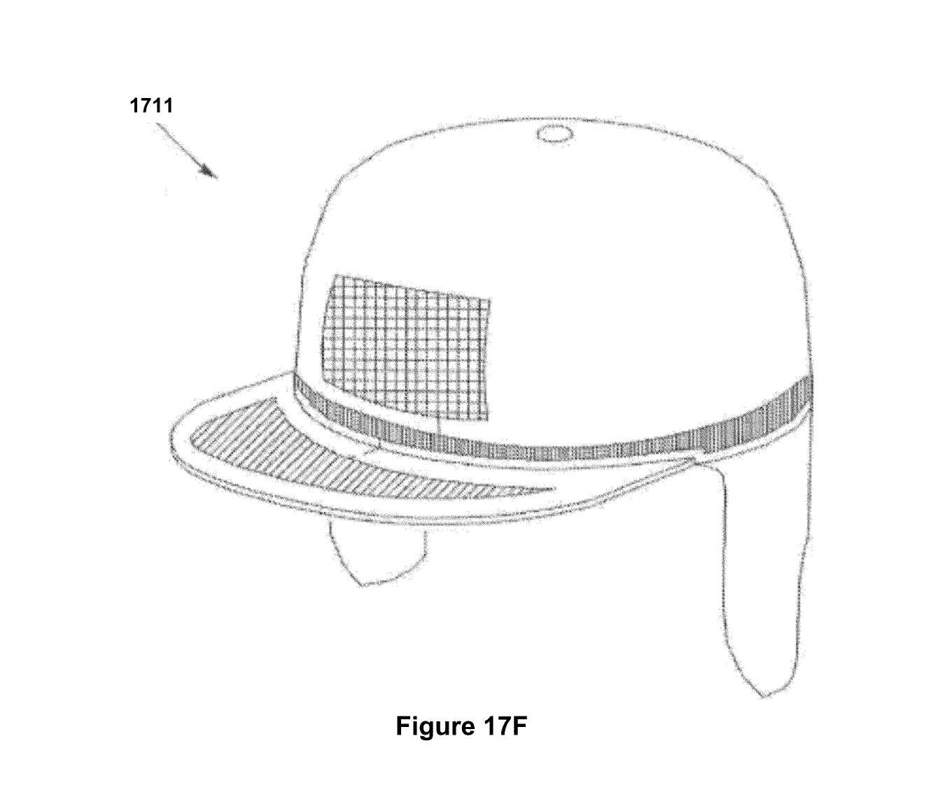

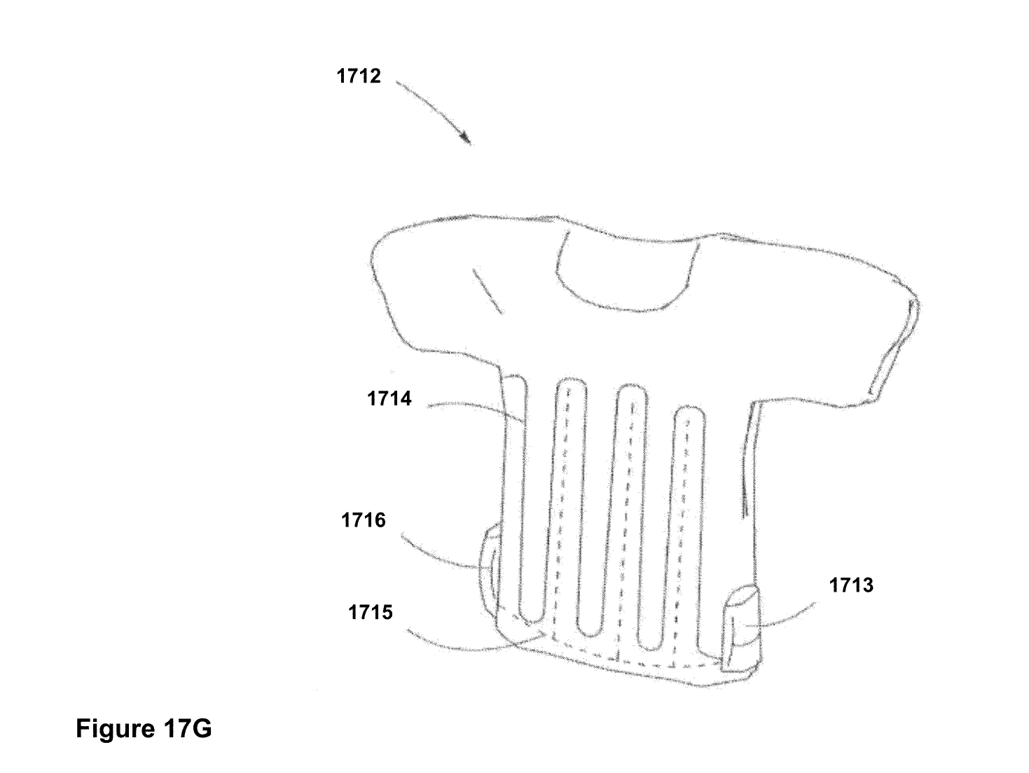

FIGS. 17A-17G illustrate various articles (e.g., heating blanket, heating sock, heating glove, warming jacket, shirt, cap, and cooling shirt) with embedded wireless power receivers, in accordance with some embodiments.

In particular, FIG. 17A shows a heating blanket 1700, according to an embodiment, which includes a heating circuit 1701, receivers 120 flexible batteries 1702; FIG. 17B illustrates a heating sock 1704 with a heating circuit 1701, a receiver 120 and flexible rechargeable batteries 1702; FIG. 17C shows a heating glove 1705 with a heating circuit 1701, a receiver 120 and batteries 1702; FIG. 17D illustrates a heating jacket 1706 that includes heating patches 1707, a receiver 120 and flexible batteries 1702; FIG. 17E shows a shirt 1708 with a display 1702, a receiver 120, and flexible batteries 1702; FIG. 17F illustrates a cap 1711 with a display, a receiver, and flexible batteries; and FIG. 17G shows a cooling shirt 1712 with a cooling liquid reservoir 1713, cooling tubes 1714, sensor wiring 1715, and case 1716 (in some embodiments, case 1716 may include a battery, a receiver and a pump for controlling the flow of cooling liquid through cooling tubes 1714).

In some embodiments the articles of clothing with embedded receivers may operate at 7.4V and may be powered or charged wirelessly (as described herein).

In example #1 a portable electronic heating jacket that may operate at 7.4V may be powered or charged. In this example, a transmitter 102 may be used to deliver pockets of energy onto heating jacket, in a process similar to the one depicted in FIG. 1. Transmitter 102 may have a single array of 8×8 of flat panel antennas where all the antenna elements may operate in the same frequency band. Flat antennas may occupy less volume than other antennas, hence allowing a transmitter 102 to be located at small and thin spaces, such as, walls, mirrors, doors, ceilings and the like. In addition, flat panel antennas may be optimized for operating to long distances into narrow hall of wireless power transmission, such feature may allow operation of portable devices in long areas such as, train stations, bus stations, airports and the like. Furthermore, flat panel antennas of 8×8 may generate smaller pockets of energy than other antennas since its smaller volume, this may reduce losses and may allow more accurate generation of pockets of energy. In this way, heating jacket may be charged without being plugged and even during use. Heating jacket may include a receiver (e.g., an embodiment of receiver 120, FIG. 1) coupled to antenna elements; the optimal amount of antenna elements that may be used with receivers for heating jacket may vary from about 10° F. to about 200° F., being most suitable about 50° F.; however, the amount of antennas within receivers may vary according to the design and size of heating jacket. Antenna elements may be made of different conductive materials such as cooper, gold, and silver, among others. Furthermore, antenna elements may be printed, etched, or laminated onto any suitable non-conductive flexible substrate and embedded in heating jacket.

In example #2 a portable electronic heating socks, that may operate at 7.4V may he powered or charged. In this example, a transmitter 102 may be used to deliver pockets of energy onto receivers 120 embedded on heating socks following a process similar to the one depicted in FIG. 1.

FIGS. 17A-17G illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 17A-17G.

Presented below are example methods of wirelessly delivering power to receivers in clothing.

In some embodiments, an example method includes: (i) receiving, by a transmitter, a communication of a power requirement of a temperature regulating component coupled to an article of clothing; (ii) generating, by the transmitter, a plurality of power transmission waves to form a pocket of energy in response to the power requirement; (iii) controlling, by the transmitter, generated power transmission waves to provide phase shifting and gain shifting with respect to other power transmission waves; and (iv) transmitting, by the transmitter, the power transmission waves through at least two antennas coupled to the transmitter.

In some embodiments, the pocket of energy is received by a receiver associated to the temperature regulating component, the receiver being configured to be coupled to the article of clothing.

In some embodiments, the temperature regulating component includes an electrical resistance heater configured to dissipate the electrical energy as heat within the article of clothing.

In some embodiments, the temperature regulating component includes a sensor coupled to the article of clothing, the sensor configured to determine the temperature of the article of clothing.

In some embodiments, the receiver includes a plurality of antennas, a power converter, and a communications component configured to communicate with the transmitter.

In some embodiments, the receiver communicates to the transmitter information including a temperature of the article of clothing and an indication of the power level of the temperature regulating component.

In some embodiments, an example receiver includes: (i) an antenna configured to receive a pocket of energy formed by a convergence of power transmission waves from a transmitter; and (ii) a rectifying circuit configured to convert the received pocket of energy into electricity to charge a temperature regulating component associated with the article of clothing, the temperature regulating component being configured to alter temperature of the article of clothing to desired temperature.

In some embodiments, the temperature regulating component includes an electrical resistance heater configured to dissipate the electrical energy as heat within the article of clothing.

In some embodiments, the temperature regulating component includes a sensor coupled to the article of clothing, the sensor configured to determine the temperature of the article of clothing.

In some embodiments, another example wireless power receiver embedded in an article of clothing includes: (i) a flexible antenna forming a pattern in the article of clothing, the flexible antenna being configured to receive radio frequency (RF) wireless power waves from a far-field wireless power transmitter, and some of the RF wireless power waves constructively interfere at the flexible antenna and some RF wireless power waves destructively interfere near the flexible antenna; (ii) a rectifying circuit coupled to the flexible antenna, the rectifying circuit being configured to rectify the received RF wireless power waves into a direct current; (iii) a temperature regulating component coupled to the rectifying circuit, the temperature regulating component being configured to alter a temperature of the article of clothing to a desired temperature using the direct current, and the temperature regulating component includes a sensor coupled to the article of clothing, the sensor configured to determine the temperature of the article of clothing; and (iv) a communications component in communication with the far-field wireless power transmitter, the communications component being configured to communicate information to the far-field wireless power transmitter, including the temperature of the article of clothing determined by the sensor.

In some embodiments, the temperature regulating component further includes an electrical resistance heater configured to dissipate the direct current as heat within the article of clothing.

FIGS. 18A-18B are illustrations of medical devices with wireless power receivers coupled thereto, in accordance with some embodiments.

FIGS. 18A-18B are illustrations of medical devices with wireless power receivers coupled thereto, in accordance with some embodiments. For example, FIG. 18A shows a blood glucose meter 1801 that includes a receiver 120. FIG. 18B shows a portable medical electronic device such as a portable ultrasound machine 1802 that includes multiple receivers 120, coupled to both a front and side portion of the device 1802.

The above described may not be limited to portable electronic medical devices shown in FIGS. 18A-18B. Receiver 120 may also be included in a plurality of medical electronic devices such as infrared electronic thermometer, electronic pads like tablets, blood pressure monitor, blood glucose meter, pulse oximeter, and ECG among others. The number and type of sensor elements are calculated according the medical electronic device's design.

FIGS. 18C-18E are illustrations of wireless power transmission systems for wirelessly delivering power to medical devices, in accordance with some embodiments.

FIGS. 18C-18D show wireless power delivery system 1810, in accordance with some embodiments. Transmitter 102 may be located at the ceiling of a room pointing downwards, and may transmit controlled RF waves 116 which may converge in 3D space to form pockets of energy. A receiver 120, embedded or attached to portable electronic medical device 1812, may then convert energy that has accumulated by constructively interfering RF waves at pockets of energy 1811 for charging or powering these devices.

FIG. 18E illustrates a wireless power delivery system 1820 for wirelessly providing power to wireless sensors 1822, which may be used for measuring physiological parameters of a patient. In some embodiments, multiple transmitters 102 attached or embedded to medical devices 1824 may provide controlled RF waves 116 to wireless sensors 951.

In some embodiments, the wireless power delivery techniques for health care environments may even be utilized in rooms in which a patient has a pacemaker, as the RF waves will not interfere or damage functioning of those types of devices because electromagnetic fields are not generated when using RF waves to wirelessly deliver power.

FIGS. 18A-18E illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 18A-18E.

Presented below are example methods of wirelessly delivering power to receivers in medical devices.

In some embodiments, an example method of wireless transmission of power to an electronic medical device or a sensor.

In some embodiments, an example method of wireless power receipt by an electronic medical device includes: (i) communicating, by a receiver associated with the electronic medical device, a power requirement and an identifier for the electronic medical device to a transmitter, the identifier being data uniquely associated with the electronic medical device; (ii) receiving, by an antenna of the receiver, a pocket of energy formed by converging power transmission waves; and (iii) converting, by a rectifying circuit of the receiver, the received pocket of energy into electricity to charge the electronic medical device.

In some embodiments, the electronic medical device is a sensor configured to record medical information from a patient. In some embodiments, the electronic medical device is configured to record a blood glucose level from a patient. In some embodiments, the electronic medical device is configured to communicate an electronic medical record with a medical professional.

In some embodiments, the receiver is configured to transmit information to a medical professional located remotely from the electronic medical device.

In some embodiments, the receiver communicates information (e.g., instructions) to a transmitter of the power transmission waves to determine an optimum time and location for receiving a pocket of energy from the transmitter.

In some embodiments, an example method of wireless transmission of power to an electronic medical device or a sensor includes: (i) generating pocket forming power radio frequency (RF) signals from a RF circuit embedded within a transmitter connected to a power source; (ii) generating communication signals from a communication circuit embedded within the transmitter, and the transmitter includes a communication antenna configured to transmit and receive communications signals to and from a receiver coupled to an electronic device, and the electronic device is a medical device or a sensor; (iii) controlling the generated power RF signals and the communication signals with a digital signal processor coupled to the transmitter; and (iv) transmitting the power RF signals by at least two antennas electrically connected to the RF circuit within the transmitter. An antenna of the receiver is configured to capture energy from the pocket of energy produced by the pocket-forming power RF signals in converging in 3D space, and the receiver is configured to convert the energy into a DC voltage for charging or powering the medical device or the sensor coupled to the receiver. The method further includes: (v) transmitting, by the communication circuit of the transmitter, instructions in the communication signals to the receiver to generate location data, power requirements, and timing data; and (vi) receiving, by the communication circuit, the communications signals from the receiver, and the communication signals received from the receiver provide an optimum time and location data indicating the location associated with the electronic device coupled to the receiver for converging the power RF signals to form the pocket of energy in 3D space at the location.

In some embodiments, the pocket-forming transmitter is centrally located in a recovery room, operating room, patient room, emergency room or common area of a hospital for charging the electronic medical device or the sensor.

In some embodiments, the at least two antennas of the transmitter are located on a ceiling in a room, for charging the electronic device.

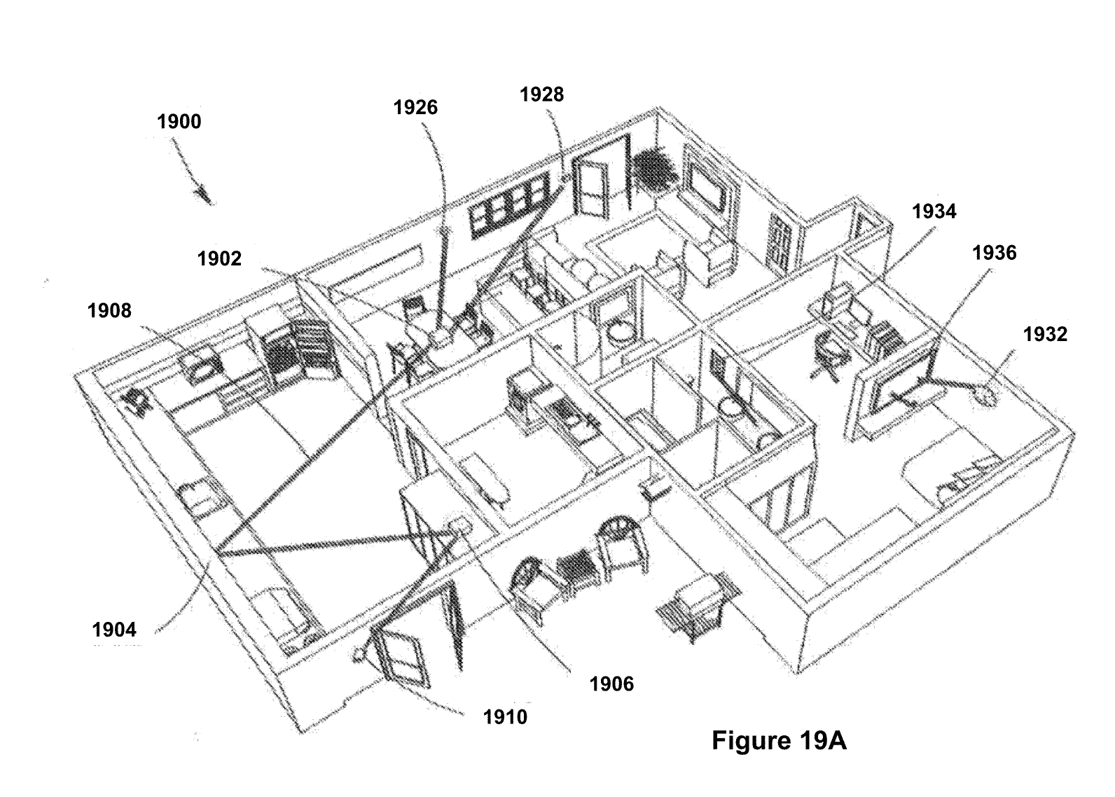

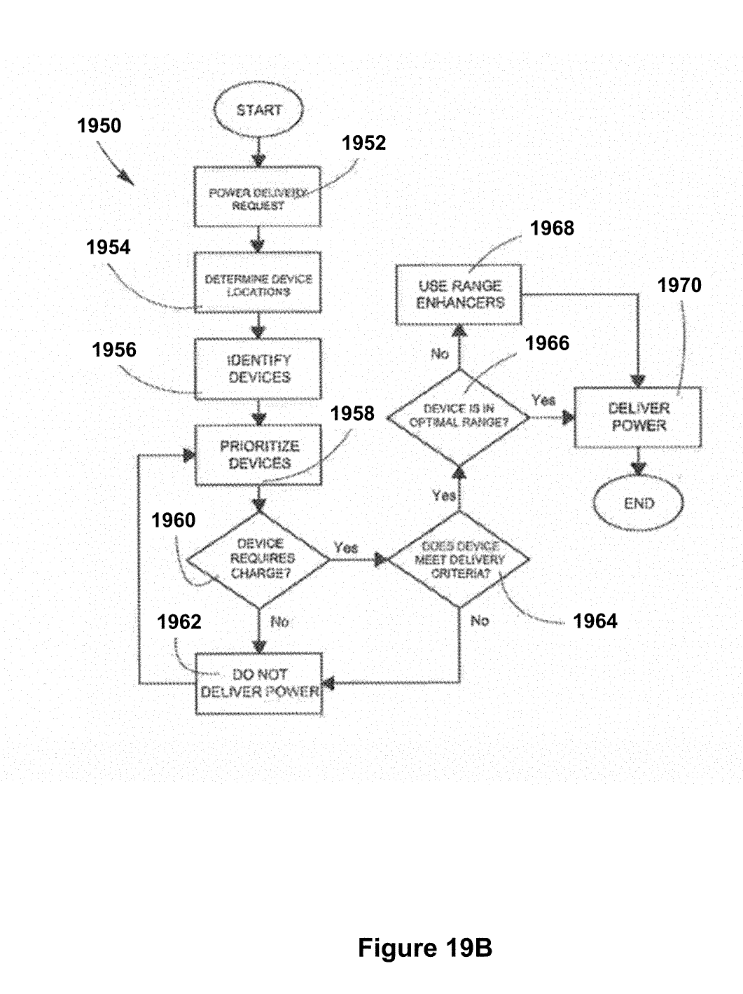

FIG. 19A is an illustration of a house configured with a number of wireless power transmitters and receivers, in accordance with some embodiments.

FIG. 19A depicts a wireless powered house 1900, which may include a plurality of transmitters 102 (e.g., instances of the transmitter 102, FIG. 1) connected to a single base station 1902, which may also include a main transmitter. In some embodiments, base station 1902 manages wireless power delivery to mobile and non-mobile devices in wireless powered house 1900 (additional details regarding base stations are provided above). Additionally, transmitters 102 may be embedded into a plurality of electronic devices and objects in wireless powered house 1900.

Base station 1902 may enable communication between every transmitter 102 and receivers 120 in wireless powered house 1900. Furthermore, wireless powered house 1900 may include a variety of range enhancers, which may increase range of wireless power transmission, such range enhancers may include: reflectors 1904 and wireless repeaters 1906, Reflectors 1904 may be included in several places of the wireless powered house 1900, such as curtains, walls, floor, and ceiling among others. Wireless repeaters 1906 may include a receiver 120 and a transmitter 192 for re-transmitting power. FIG. 19A illustrates an example for using reflectors 1904 and wireless repeaters 1906, where a CCTV camera 1910 requires charge, but it is too far for receiving power at an optimal efficiency. However, base station 1902 may trace a trajectory for RF waves 1908 which may imply less loses and includes the use of reflectors 1904 that may be embedded in the walls and a wireless repeater 1906, which may receive the reflected RF waves 1908 and re-transmits these to the CCTV camera 1910 with higher power than the received.

In some embodiments, base station 1902 may send RF waves 1908 to any device in wireless powered house 1900, these devices may include static devices such as: smoke detectors 1926, digital door locks 1928, CCTV cameras 1910, wall clocks 1932 among others devices that requires wired powered connections. The lack of cables for powering such devices may reduce work time for installing and maintaining those devices. Furthermore, walls, ceilings and floors need not be drilled for installing cables.

Device locations may be updated automatically by base station 1902, which may set a communication channel between each device, regardless if it is a mobile or non-mobile device. Some devices such as mirrors 1934 may allow a transmitter 102 to be embedded therein in order to charge small devices and disposable devices in the bathroom and/or in the bedroom. Such devices may include: Electric razors, electric toothbrushes, lamps, massagers, UV-Sterilizers among others. Therefore, mirror 1934 may significantly reduce wired chargers for each electric device in bathrooms and bedrooms.

Similarly to mirror 1934, televisions 1936 may include transmitters 102 for powering and charging mobile and non-mobile devices.

Base station 1902 may establish areas where wireless power transmission may have specialized protocols, these areas may include infirmary, children rooms, room for pregnant and other regions where devices may be sensitive to radio frequency waves but not to RF waves 1908. Some areas may represent a permanent null space, where no pockets of energy are generated. Furthermore, some receivers 120 may possess the same specialized protocols regardless their location in wireless powered house 1900. Such devices may include electric knives, drills, and lighters among others. Therefore, each device may be restricted to a specific area and to a specific user, thus, safety in wireless powered house 1900 may be higher. Hence, children may not be exposed or in proximity to harmful hardware and thieves may not be able to use stolen equipment outside the wireless powered house 1900.

FIG. 19B is a flow diagram of an example routine that may be utilized by a microcontroller of a base station in a wireless powered house to control wireless power transmission, in accordance with some embodiments.

Routine 1950 may begin when any transmitter 102 in wireless powered house 1900 receives a power delivery request Step 1902 from receiver 120. Subsequently, at determine device locations Step 1904, a receiver 102 may send a signal via BLUETOOTH, RF waves, infrared among others to the closest transmitter 102. Then, transmitter 102 may determine location of receiver 120 in wireless powered house 1900. After this procedure, at identify devices Step 1954 receiver 120 may send a signature signal to the closest transmitter 102, such signal may be coded using suitable techniques such as delay encoding, orthogonal frequency-division multiplexing (OFDM), code division multiplexing (CDM) or other suitable binary coding for identifying a given electronic device including receiver 106. At this step, micro-controller may obtain information from receiver 120 such as type of device, manufacturer, serial number, total power required. Then, micro-controller in base station 1902 may proceed to authenticate where it may evaluate the signature signal sent by receiver 120. Micro-controller may proceed to a decision. If receiver 120 is not authorized to receive power, micro-controller may decide to block it. If receiver 120 is authorized, it may receive charge based on his assigned priority, such value is determined at prioritize devices Step 1558, such value may be set by the user preferences and charge level of the equipment, such charge level may be determined in device requires charge Step 1560. If the device does not requires charge, transmitter 102 may not charge it at do not deliver power Step 1562. Furthermore, such device may be listed as low priority to charge during prioritize devices Step 1558.

In addition, if multiple receivers 120 are requiring power, micro-controller may deliver power equally to all receivers 120 or may utilize a priority status for each receiver 120. In some embodiments, the user may choose to deliver more power to its smartphone, than to its gaming device. In other cases, the user may decide to first power its smartphone and then its gaming device. Furthermore, smoke detectors 1926, digital door locks 1928, CCTV cameras 1910 among others similar devices, may have the highest priority.

When the receiver 120 is authorized to receive charge, it has to meet some criteria at does device meet delivery criteria Step 1564. The foregoing powering criteria may depend on the electronic device requiring power and/or based in user preferences. For example, smartphones may only receive power if are not being used, or maybe during usage but only if the user is not talking through it or maybe during usage as long as WI-FI is not compromised among other such criteria. In the case of a user custom profile, the user may specify the minimum battery level its equipment can have before delivering power, or the user may specify the criteria for powering his or her device among other such options. In addition, in wireless powered house 1900, some devices may possess some special criteria, as described in FIG. 19A; such devices may be required to operate in specific rooms. Such devices may include drillers, electric knives, lighters, electric screwdrivers, saws, among others. Furthermore, some devices may require some user authentication, which may be achieved through password verification or biometric authentication. These two criteria may be used in combination for a maximum level of safety. Such combination may generate a single criterion related to parental control protocol, which may also include manage of power intensity for toys and operation areas for them.

Alternatively, micro-controller may also record data on a processor on transmitter 102. Such data may include powering statistics related to how often does a device require power, at what times is the device requesting power, how long it takes to power the device, how much power was delivered to such device, the priority status of devices, where is the device mostly being powered (for example at home or in the workplace). In addition, such statistics could be uploaded to a cloud based server so that the user can look at all such statistics. Thus, the aforementioned statistics can help micro-controller decide when to stop delivering power to such a user.

Continuing, does device meet delivery criteria? Step 1564, micro-controller in base station 1902 may determine if receiver 120 is within the optimal range from the closest transmitter 102, such analysis may be carried out at device is in optimal range? Step 1566. If receiver 120 is within the optimal range, then transmitter 102 may deliver power at deliver power Step 1970, if receiver 120 is out of the optimal range, then micro-controller may use reflectors 1904 and wireless repeaters 1906 for increasing the optimal range, such operation may be performed at use range enhancers Step 1968. Subsequently, receiver 120 may receive charge at deliver power Step 1970.

FIGS. 19A-19B illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 19A-19B.

Presented below are example systems and methods of wirelessly delivering power to receivers in a wirelessly powered house.

An example method includes receiving, by a base station, a communication of a power requirement for an electronic device coupled to a receiver, and the base station is coupled to a plurality of transmitters, and activating, by the base station, a transmission of a plurality of power transmission waves from at least one of the plurality of transmitters to form a pocket of energy converging proximate to at least one receiver to charge the electronic device.

In some embodiments, the method further includes controlling, by the base station, each of the plurality of transmitters to deliver a pocket of energy at a determined time and location to charge of the electronic device through the at least one receiver.

In some embodiments, the method further includes determining, by the base station, priority among a plurality of electronic devices to receive, through the at least one receiver, the pocket of energy from at least one of the plurality of transmitters.

In some embodiments, the method further includes communicating, by the base station, with the at least one receiver and the plurality of transmitters through a communication signal using a protocol selected from the group consisting of: BLUETOOTH®, WI-FI, ZIGBEE®, or FM radio.

In some embodiments, the pocket of energy is regulated by utilizing adaptive pocket-forming.

In some embodiments, an example charging apparatus includes a base station coupled to a power source; and a first communication component coupled to the base station and configured to transmit information to a plurality of transmitters and a plurality of receivers, each of the plurality of transmitters comprising: (i) an antenna configured to transmit power transmission waves that converge to become a pocket of energy; and (ii) a second communication component configured to communicate with the base station and at least one of the plurality of receivers.

In some embodiments, the base station is configured to receive information from at least one of the plurality of receivers, the information including an identification, a location, and an indication of the power level of at least one of the plurality of electronic devices associated to the at least one of the plurality of receivers.

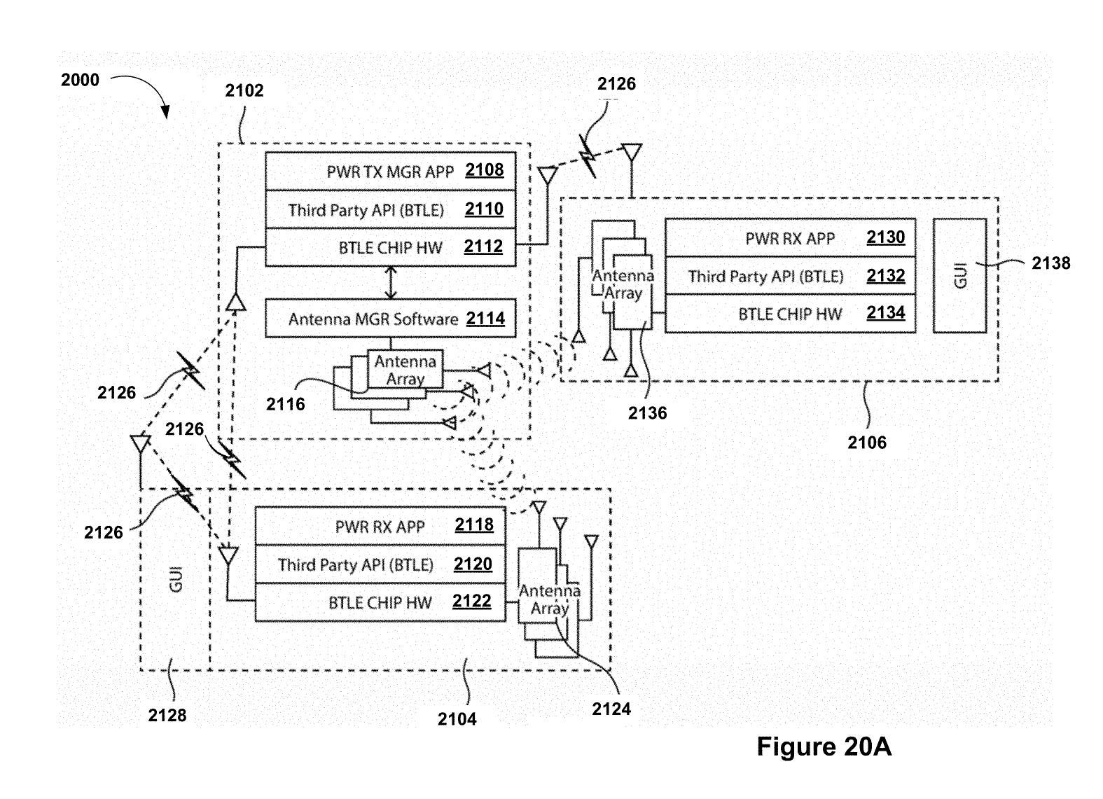

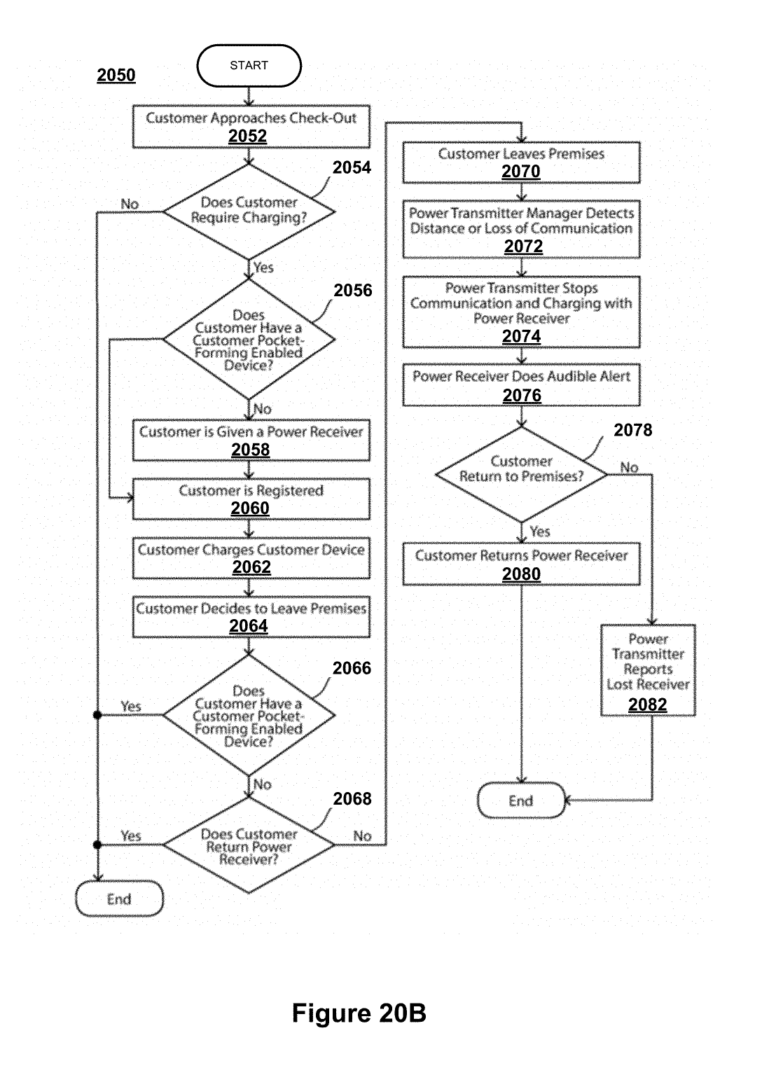

FIG. 20A shows a system architecture 2000 for a wireless power network, according to an embodiment. System architecture 2000 may enable the registration and communication controls between wireless power transmitter 2102 and one or more wireless power receivers (e.g., an embodiment of the receiver 120, FIG. 1) within a wireless power network. Wireless power receivers may include covers 2104 and customer pocket-forming enabled devices 2106.

In one embodiment, wireless power transmitter 2102 (e.g., an embodiment of the transmitter 102, FIG. 1) may include a microprocessor that integrates a power transmitter manager app 2108 (PWR TX MGR APP), and a third party application programming interface 2110 (Third Party API) for a BLUETOOTH Low Energy chip 2112 (BTLE CHIP HW). Wireless power transmitter 102 may also include an antenna manager software 2114 (Antenna MGR Software) to control an RF antenna array 2116 that may be used to transmit controlled Radio Frequency (RF) waves which may converge in 3D space. These RF waves may be controlled through phase and/or relative amplitude adjustments to form constructive and destructive interference patterns (pocket-forming). Pockets of energy may form at constructive interference patterns that may be 3Dimensional in shape whereas null-spaces may be generated at destructive interference patterns. Pockets of energy may be formed on wireless power receivers (covers and customer pocket-forming enabled devices 2106). In some embodiment, BLUETOOTH Low Energy chip 2112 may be another type of wireless protocol such as WiFi or the like.

Power transmitter manager app 2108 may include a database (not shown), which may store system status, configuration, or relevant information from wireless power receivers such as, identifiers, voltage ranges, location, signal strength and/or any relevant information from a wireless power receivers.

Power transmitter manager app 2108 may call third party application programming interface 2110 for running a plurality of functions such as start a connection, end a connection, and send data among others. Third party application programming interface 2110 may command BLUETOOTH Low Energy chip 2112 according to the functions called by power transmitter manager app 2108.

Third party application programming interface 2110 at the same time may call power transmitter manager app 2108 through a callback function which may be registered in the power transmitter manager app 2108 at boot time. Third party application programming interface 2110 may have a timer callback that may go for ten times a second, and may send callbacks every time a connection begins, a connection ends, a connection is attempted, or a message is received.

Covers 2104 may include a power receiver app 2118 (PWR RX APP), a third party application programming interface 2120 (Third party API) for a BLUETOOTH Low Energy chip 2122 (BTLE CHIP HW), and a RF antenna array 2124 which may be used to receive and utilize the pockets of energy sent from wireless power transmitter 2102.

Power receiver app 2118 may call third party application programming interface 120 for running a plurality of functions such as start a connection, end the connection, and send data among others. Third party application programming interface 2120 may have a timer callback that may go for ten times a second, and may send callbacks every time a connection begins, a connection ends, a connection is attempted, or message is received.

Covers 2104 may be paired to a wireless device such as a smartphone, or tablet among others via a BTLE connection 2126 by using a graphical user interface (GUI 2128) that may be downloaded from any suitable application store and may run on any suitable operating system such as iOS and Android, among others. Covers 2104 may also communicate with wireless power transmitter 2102 via a BTLE connection 2126 to send important data such as an identifier for the device as well as battery level or charge status information, antenna voltage, any other hardware status, software status, geographic location data, or other information that may be of use for the wireless power transmitter 2102.

In other embodiments, GUI 2128 may also be installed on a wireless device (smartphones or tablets) that may not have the cover 2104. GUI 2128 may perform operations to communicate with power transmitter manager app 2108 via BTLE connection 2126 or any other wireless communication protocols such as Wi-Fi, and LAN among others. In this embodiment, GUI management app still performs the same function as previously described, to manage or monitor the wireless power transmission system.

Customer pocket-forming enabled devices 2106 may refer to a wireless device such as smartphones, tablets, or any of the like that may include an integrated wireless power receiver circuit for wireless power charging (e.g., receiver 120, FIG. 1). Customer pocket-forming enabled devices 2106 may include a power receiver app 2130 (PWR RX APP), and a third party application programming interface 2132 (Third Party API) for a BLUETOOTH Low Energy chip 2134 (BTLE CHIP HW). Customer pocket-forming enabled devices 2106 may also include an RF antenna array 2136 which may receive and utilize pockets of energy sent from wireless power transmitter 2102. GUI 2138 may be downloaded from any suitable application store and may run on any suitable operating system such as iOS and Android, among others.

Power receiver app 2130 may call third party application programming interface 2132 for running a plurality of functions such as start a connection, end the connection, and send data among others. Third party application programming interface 2132 may have a timer callback that may go for ten times a second, and may send callbacks every time a connection begins, a connection ends, a connection is attempted, or message is received.

Customer pocket-forming enabled devices 2106 may also communicate with wireless power transmitter 2102 via a BTLE connection 2126 to send important data such as an identifier for the device as well as battery level information, antenna voltage, geographic location data, or other information that may be of use for the wireless power transmitter 2102.

FIG. 20B shows a flowchart for an off-premises alert method 2500 for wireless power receivers in a wireless power network.

The wireless power network may include one or more wireless power transmitter and multiple wireless power receivers that may be either a cover or a customer pocket-forming enabled devices.

Method 2050 may include automated software embedded on a wireless power receiver that may be triggered every time a wireless power receiver is turned on.

In one embodiment, method 2050 may start at step 2052 when a customer goes into a shop and approaches the check-out. Then, at step 2054, an employee of the shop that may be at the counter may ask the customer if he or she requires charging for the customer's device. If the customer does not require charging for his or her device, then the process ends. If the customer does require charging, the employee may ask the customer if his or her device has a customer pocket-forming enabled device, at step 2056. If the customer's device is not a pocket forming enabled device, then at step 2058, the customer is given a power receiver device, also referred as a cover, and the employee may use a GUI to register the given cover at step 2060. Likewise, if the customer does have a pocket-forming enabled device, the employee may use a GUI to register the customer pocket-forming enabled device at step 2060. Then, at step 2062, customer may charge his or her device for the time they need charge. Next, at step 2064, the customer may decide to leave the premises. Then, at step 2066, if the customer has a customer pocket-forming enabled device, the customer may just leave the premises and the process ends. However, if the customer has a power receiver or cover, then the customer may return the cover and leave the premises or he or she may forget to return the cover, at step 2068.

If customer forgets to return the cover, he or she may leave the premises at step 2070. Subsequently, at step 2072, when the customer is at a certain distance away from the store, the power transmitter manager at the store may detect the distance or loss of communication with the power receiver or cover lent to the customer. In other embodiments, the power receiver detects no communication with the power transmitter manager for a minimum amount of time. Then, at step 2074, the power transmitter manager may stop communication with and charging the power receiver. The power receiver, then at step 2076, may generate an audible alert that the customer may hear as he or she goes further from the store. Subsequently, at step 2078, the customer may decide to whether return to premises or not. If customer returns to premises, then at step 2080, customer may return the power receiver. If customer decides to not return to premises, then at step 2082, power transmitter reports details of the lost receiver such as when, where, and receiver's ID among others, to the system management server or the remote information service that are both part of the wireless power transmission system's network.

### EXAMPLES

In example #1 a customer enters a coffee shop and buys a cup of coffee. At checkout, the costumer asks for power to charge a smartphone. The customer's smartphone includes a suitable GUI for interacting with a wireless power network. A power receiver or cover with an embedded power receiver is associated with the customer, by an employee using a GUI device, and the cover is given to the customer. Then, the smartphone is paired with a power receiver or cover. The smartphone starts receiving power from the power transmitter as long as the customer stays in the coffee shop. After some time, the smartphone reaches a desired level of charge and the customer leaves the coffee shop. Subsequently, when the customer is at a certain distance away from the coffee shop, the power transmitter manager may detect the distance or loss of communication with the power receiver or cover lent to the customer, and then stop charging and communication with the power receiver. Then, the power receiver or cover may generate an audible alert that may increase in volume as the customer gets further from the coffee shop. The customer then hears the alert and returns to the coffee shop to return the power receiver or cover.

FIGS. 20A-20B illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 20A-20B.

Presented below are example systems and methods of wirelessly delivering power to receivers in off-premises alert systems.

In some embodiments, an apparatus includes an antenna array, configured to receive pocket-forming energy in three-dimensional space from a transmitter (e.g., transmitter 102, FIG. 1), a power receiver (e.g., a receiver 120, FIG. 1) operatively coupled to the antenna array, the power received further being configured to be coupled to a device. and communications for wirelessly communicating data to the transmitter and the device. In some embodiments, the power receiver is configured to detect an absence of least one of (i) pocket-forming energy and (ii) data communication from the transmitter, and the power receiver is configured to generate an alarm based on the detected absence.

In some embodiments, the data includes registration data indicating an identity of at least one of (i) the device and (ii) a user associated with the device.

In some embodiments, the communications is configured to transmit registration data to the transmitter prior to the receipt of pocket forming energy in the antenna array.

In some embodiments, the power receiver is configured to generate the alarm after a predetermined time period after the detected absence.

In some embodiments, the alarm is an audible alarm, and the power receiver is configured to increase the volume of the audible alarm over a time period.

In some embodiments, the communicated data includes at least one of identification data for the device, device battery level data, device charge status data, antenna voltage data, device hardware status data, device software status data and geographic location data.

In some embodiments, the power receiver is configured to modify the generated alarm based on the geographic location data.

In some embodiments, a method includes (i) configuring a device to receive pocket-forming energy in three dimensional space in an antenna array from a transmitter via a power receiver configured to be coupled o the device, (ii) wirelessly communicating data from communications coupled to the power receiver to the transmitter and the device, (iii) detecting, via the power receiver, an absence of least one of (a) pocket-forming energy and (b) data communication from the transmitter, and (iv) generating an alarm via the power receiver for the device based on the detected absence.

In some embodiments, the data includes registration data indicating an identity of at least one of (i) the device and (ii) a user associated with the device.

In some embodiments, the registration data is communicated to the transmitter prior to the receipt of pocket forming energy in the antenna array.

In some embodiments, the alarm is generated after a predetermined time period after the detected absence.

In some embodiments, the alarm is an audible alarm, and the alarm is modified to increase the volume of the audible alarm over a time period.

In some embodiments, the communicated data includes at least one of identification data for the device, device battery level data, device charge status data, antenna voltage data, device hardware status data, device software status data and geographic location data.

In some embodiments, the generated alarm is modified based on the geographic location data.

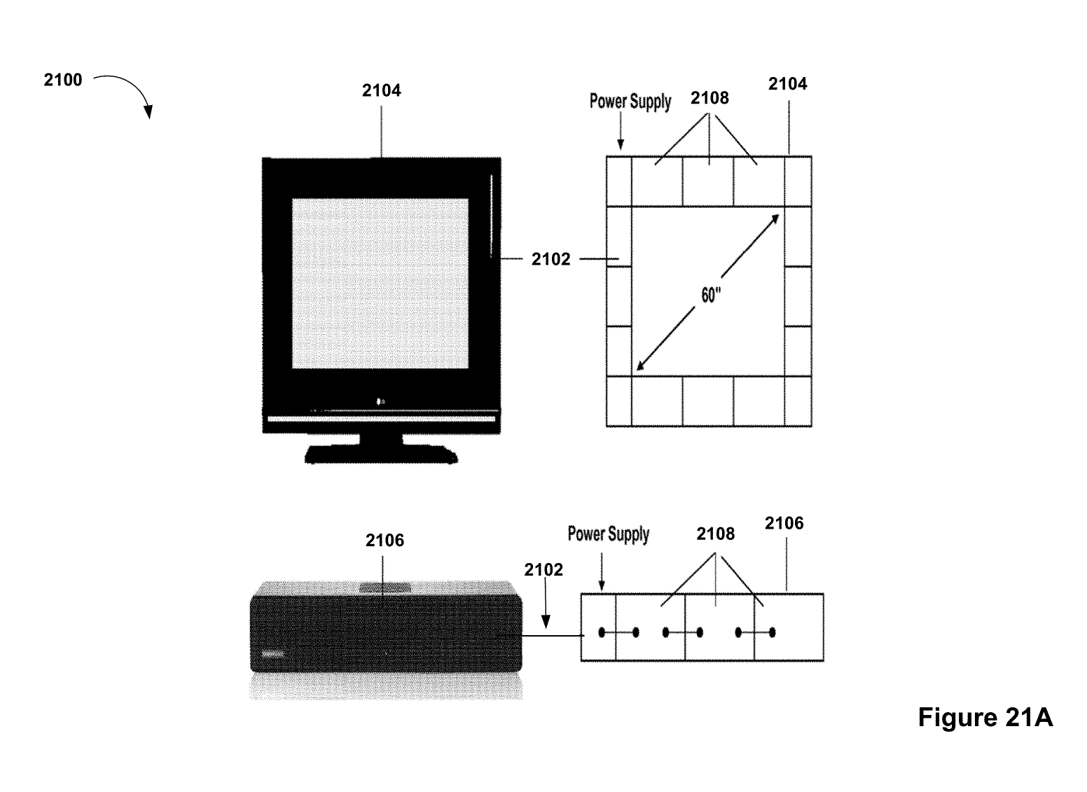

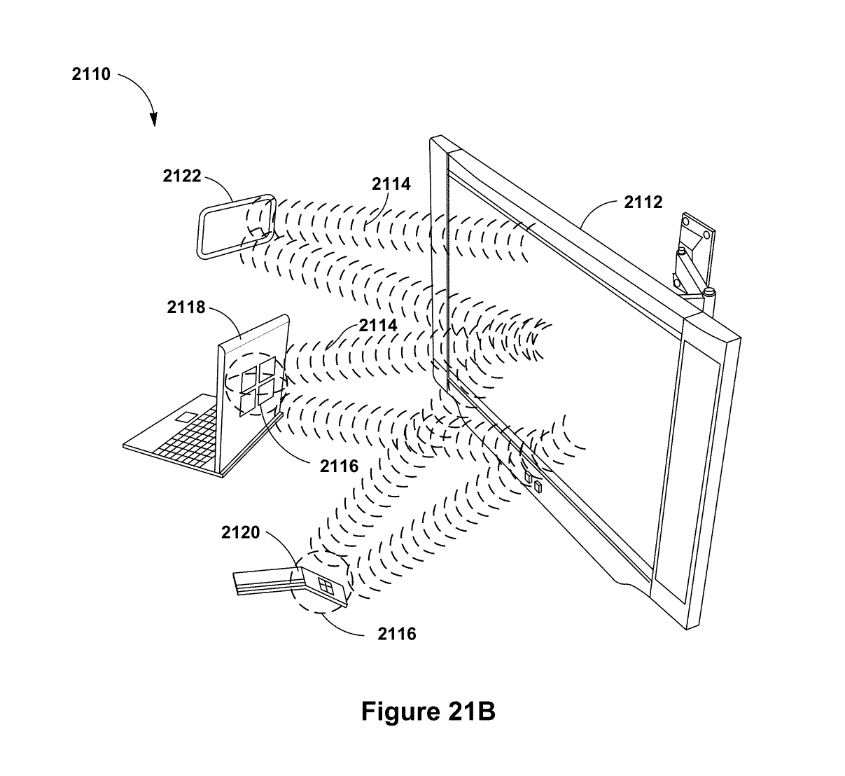

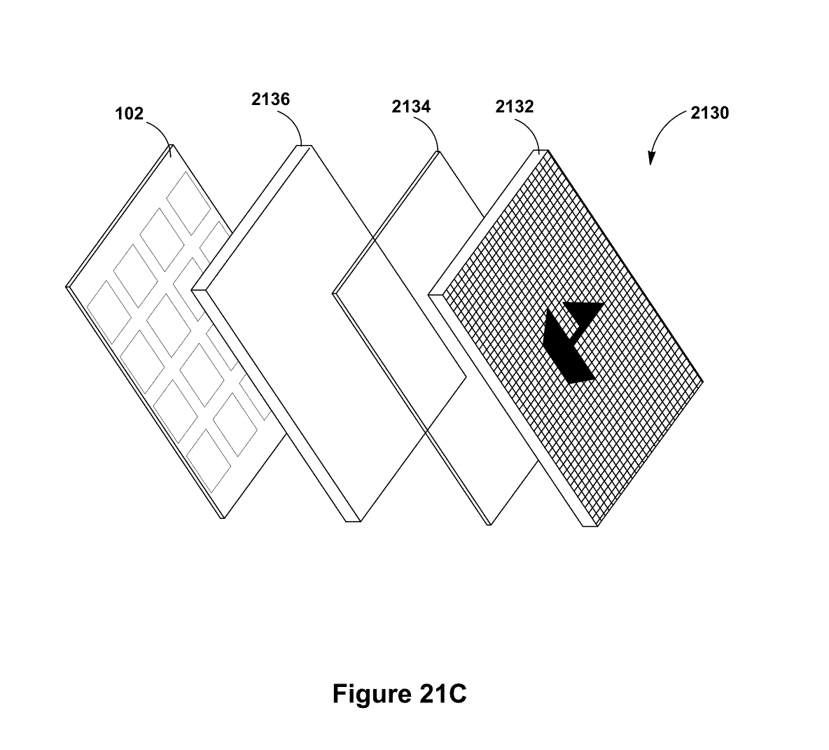

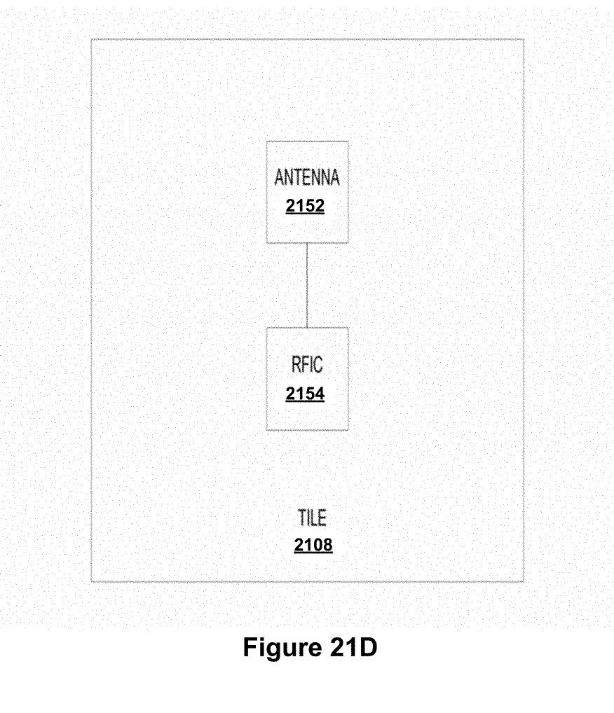

FIG. 21A depicts a diagram of architecture 2100 for incorporating transmitter 2102 (e.g., an embodiment of the transmitter 102, FIG. 1) into different devices. For example, the flat transmitter 2102 may be applied to the frame of a television 2104 or across the frame of a sound bar 2106. Transmitter 2102 may include multiple tiles 2108 with antenna elements and RFICs in a flat arrangement. The RFIC may be directly embedded behind each antenna elements; such integration may reduce losses due the shorter distance between components.

Tiles 2108 can be coupled to any surface of any object. Such coupling can be via any manner, such as fastening, mating, interlocking, adhering, soldering or others. Such surface can be smooth or rough. Such surface can be of any shape. Such object can be a stationary object, such as a building portion or an appliance, or a movable object, whether self-propelled, such as a vehicle, or via another object, such as handheld. Tiles 2108 can be used modularly. For example, tiles 2108 can be arranged to form any 2d or 3d shape, whether open or closed, symmetrical or asymmetrical. In some embodiments, tiles 2108 can be arranged in a figure shape, or a device/structure shape, such as a tower. Tiles 2108 can be configured to couple to each other, such as via interlocking, mating, fastening, adhering, soldering, or others. Tiles 2108 can be configured to operate independently of each other or dependently on each other, whether synchronously or asynchronously. In some embodiments, tiles 2108 are configured to be fed serially or in parallel, whether individually or as a group. Tiles 2108 can be configured to output from at least one side, such as top, lateral, or bottom. Tiles 2108 can be rigid, flexible, or elastic. In some embodiments, at least one other component, whether digital, analog, mechanical, electrical or non-electrical, can be positioned between at least two of tiles 2108. In some embodiments, at least one of tiles 1650 can be run via a hardware processor coupled to a memory.

Tiles 2108 can be used for heat map technology, as described herein. For example, transmitter 2102 includes multiple tiles 2108 with antenna elements and RFICs in a flat arrangement, where transmitter 2102 can facilitate heat map creation for a group of tiles 2108, such as for a particular receiver (e.g., an embodiment of the receiver 120, FIG. 1), such as when tiles 2108 send BLE identifiers for heat map generation. In some embodiments, the group of tiles 2108 is defined via tiles 2108 positioned within a specified distance, such as how many tiles 2108 positioned within a specified distance are sending out signals, scanning an area, and receiving receiver input, such as locational input. Note that such performance can occur simultaneously under different communication protocols as well, such BLE® and ZIGBEE®. In some embodiments, at least two groups of tiles 2108 perform different tasks. In some embodiments, a group of tiles 2108 includes two tiles, such as when the two tiles are each eight inches long by two inches wide. In some embodiments, an entire array can run along a perimeter of television 2104, where the array includes via a plurality of tiles 2108 arranged in or functioning as a plurality of groups of tiles 2108 as each of such groups might obtain a different heat map, as described herein, which can be subsequently analyzed together to obtain a better grand scale heat map understanding. Accordingly, a plurality of heat map sets can exists without being reconciled with each other as each of the heat map sets can include different information. For example, a first heat map can be associated with a first device and a second heat map associate with a second device, different from the first device.

For example, a television 2104 may have a bezel around a television 2104, comprising multiple tiles 2108, each tile comprising of a certain number of antenna elements. For example, if there are 20 tiles 2108 around the bezel of the television 2104, each tile 2108 may have 24 antenna elements and/or any number of antenna elements.

Note that tiles 2108 are positioned or configured to avoid signal interference with television 2104 or wiring coupled to television 2104. Alternatively or additionally, television 2104 can be shielded against such signal interference. Similar configurations can be applied to sound bar 2106 or any other type of speaker, whether a standalone speaker or a component of a larger system. However, also note that such tiles 2108 can be arranged on any device, whether a standalone device or a component of a larger system, whether electronic or non-electronic.

In tile 2108, the phase and the amplitude of each pocket-forming in each antenna element may be regulated by the corresponding RFIC in order to generate the desired pocket-forming and transmission null steering. RFIC singled coupled to each antenna element may reduce processing requirement and may increase control over pocket-forming, allowing multiple pocket-forming and a higher granular pocket-forming with less load over microcontroller, thus, a higher response of higher number of multiple pocket-forming may be allowed. Furthermore, multiple pocket-forming may charge a higher number of receivers and may allow a better trajectory to such receivers.

RFIC may be coupled to one or more microcontrollers, and the microcontrollers may be included into an independent base station or into the tiles 2108 in the transmitter 2102. A row or column of antenna elements may be connected to a single microcontroller. In some implementations, the lower number of RFICs present in the transmitters 2102 may correspond to desired features such as: lower control of multiple pocket-forming, lower levels of granularity and a less expensive embodiment. RFICs connected to each row or column may allow reduce costs by having fewer components because fewer RFICs are required to control each of the transmitters 2104. The RFICs may produce pocket-forming power transmission waves by changing phase and gain, between rows or columns.

In some implementations, the transmitter 2102 may use a cascade arrangement of tiles 2108 comprising RFICs that may provide greater control over pocket-forming and may increase response for targeting receivers. Furthermore, a higher reliability and accuracy may be achieved from multiple redundancies of RFICs.

In one embodiment, a plurality of PCB layers, including antenna elements, may provide greater control over pocket-forming and may increase response for targeting receivers. Multiple PCB layers may increase the range and the amount of power that could be transferred by transmitter 2102. PCB layers may be connected to a single microcontroller or to dedicated microcontrollers. Similarly, RFIC may be connected to antenna elements.

A box transmitter 2102 may include a plurality of PCB layers inside it, which may include antenna elements for providing greater control over pocket-forming and may increase response for targeting receivers. Furthermore, range of wireless power transmission may be increased by the box transmitter 2102. Multiple PCB layers may increase the range and the amount of RF power waves that could be transferred or broadcasted wirelessly by transmitter 2102 due the higher density of antenna elements. PCB layers may be connected to a single microcontroller or to dedicated microcontrollers for each antenna element. Similarly, RFIC may control antenna elements. The box shape of transmitter 2102 may increase action ratio of wireless power transmission. Thus, box transmitter 2102 may be located on a plurality of surfaces such as, desks, tables, floors, and the like. In addition, box transmitter may include several arrangements of PCB layers, which may be oriented in X, Y, and Z axis, or any combination these.

In some embodiments, sound bar 2106 is elongated, such as by being four feet long and two inches high. Such shaping provides a provision of tiles 2108 along a longitudinal axis of sound bar 2106 such that at least some of tiles 2108 are able to send or receive signals, as described herein, in a surrounding manner.

FIG. 21B illustrates an example embodiment of a television (TV) system outputting wireless power. Some elements of this figure are described above. Thus, same reference characters identify identical and/or like components described above and any repetitive detailed description thereof will hereinafter be omitted or simplified in order to avoid complication.

A wireless power transmission 2100 that includes pocket-forming is described. The transmission 2110 entails a TV system 2112 transmitting a plurality of controlled wireless power waves 2114 converging in multidimensional space. The TV system 2112 uses a transmitter, as described herein, such as transmitter 102, to output waves 2114, such as in any direction, such as frontal or lateral or backward or upward or downward. The transmitter can be powered via the TV system 2112 or another power source, such as a battery, whether coupled to or not to the TV system 2112. Alternatively or additionally, the transmitter can power the TV system 2112 or the transmitter and TV system 2112 are powered independently of each other, such as from two different power sources, such as a battery and mains electricity. Waves 2114 are controlled through phase and/or relative amplitude adjustments to form constructive and destructive interference patterns, such as pocket-forming. Pockets of energy 2116 are formed at constructive interference patterns of waves 2114 and are 3Dimensional in shape, whereas null-spaces are generated at destructive interference patterns of waves 2114. A receiver, as described herein, such as receiver 120, utilizes pockets of energy 2116 produced by pocket-forming for charging or powering an electronic device, for example a laptop computer 2118, a mobile phone 2120, a tablet computer 2122 or any electrical devices at least within reach or a defined range from TV system 2112, such as about 20 feet in a specific direction, an arc comprising a peak height distance of about 20 feet, or a radius of 20 feet, and thus effectively providing wireless power transmission 2110. In some embodiments, adaptive pocket-forming may be used to regulate power on electronic devices. In some embodiments, TV system 2112 includes a speaker or a sound bar, whether as described herein, or of another type. In some embodiments, TV system 2112 includes a remote control unit, which can include a receiver, as described herein, configured to receive wireless power from TV system 2112, as described herein.

FIG. 21C illustrates an example embodiment of an internal structure of a TV system. Some elements of this figure are described above. Thus, same reference characters identify identical and/or like components described above and any repetitive detailed description thereof will hereinafter be omitted or simplified in order to avoid complication.

An internal structure view 2130 depicts TV system 2112 with a transmitter, as described herein. TV system 2112 includes a plurality of components. TV system 2112 includes a front transparent screen layer 2132, a polarized film layer 2134, and an LED/LCD backlight layer 2136. TV system 2112 additionally include transmitter 102, as described herein. In another embodiment, transmitter 102 may be integrated within at least one of layers 2132, 2134, 2136 instead of as a separate layer.

In other embodiments, most of the circuitry of transmitter 102 is placed inside TV system 2112, with antenna elements 1106 placed around the edges of TV system 3002. In other embodiments, antenna elements are placed on the outside surface of a back portion of TV system 2112. In yet further embodiments, antenna elements can be printed micro-antennas which can be built-in on TV system 2112 display area. Such printed-antennas can be produced with well-known in the art photolithographic or screen printing techniques. Such antennas can be beneficial because they can be printed at tinny scales which render them invisible to the human eye. Note that TV system can be of any type, such as a liquid crystal display (LCD), a plasma, a cathode ray, or others.

FIG. 21D illustrates an example embodiment of a tile architecture. Some elements of this figure are described above. Thus, same reference characters identify identical and/or like components described above and any repetitive detailed description thereof will hereinafter be omitted or simplified in order to avoid complication.

A tile 2108 (FIG. 21A) includes an antenna 2152 and an RFIC 2154 coupled to antenna 2152, as described herein. Tile 2108 can be structure in any way as described herein. Tile 2108 operates are described herein. Although tile 2108 is shaped in a rectangular shape, in other embodiments, tile 2108 can be shaped differently, whether in an open shape or a closed shape. For example, tile 2108 can be shaped as a star, a triangle, a polygon, or others.

FIGS. 21A-21D illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 21A-21D.

Presented below are example systems for wirelessly delivering power to receivers using transmitters in various devices.

In some embodiments, an example system for wireless power transmission includes: (i) a sound bar frame; and (ii) a plurality of tiles positioned along the sound bar frame. At least one of the tiles includes an antenna and a radio frequency integrated circuit (RFIC) coupled to the antenna and the RFIC is configured to engage the antenna such that the antenna emits a plurality of wireless power waves defining a pocket of energy.

In some embodiments, an example system for wireless power transmission includes: (i) a display frame; and (ii) a plurality of tiles positioned along the sound bar frame. At least one of the tiles includes an antenna and a radio frequency integrated circuit (RFIC) coupled to the antenna and the RFIC is configured to engage the antenna such that the antenna emits a plurality of wireless power waves defining a pocket of energy.

In some embodiments, an example system for wireless power transmission includes: (i) a speaker enclosure; and (ii) a plurality of tiles positioned along the sound bar frame. At least one of the tiles includes an antenna and a radio frequency integrated circuit (RFIC) coupled to the antenna and the RFIC is configured to engage the antenna such that the antenna emits a plurality of wireless power waves defining a pocket of energy.

In some embodiments, the tiles are configured to operate dependent on each other.

In some embodiments, the tiles are configured to operate independent of each other.

In some embodiments, the sound bar frame includes an external face, and the tiles are coupled to the external face. In some embodiments, the display frame includes an external face, and the tiles are coupled to the external face. In some embodiments, the speaker enclosure includes an external face, and the tiles are coupled to the external face.

In some embodiments, the sound bar frame includes an internal face, and the tiles are coupled to the internal face. In some embodiments, the display frame includes an internal face, and the tiles are coupled to the internal face. In some embodiments, the speaker enclosure includes an internal face, and the tiles are coupled to the internal face.

In some embodiments, the sound bar frame includes the tiles. In some embodiments, the display frame includes the tiles. In some embodiments, the speaker enclosure includes the tiles.

In some embodiments, the system further includes a display, and the display frame frames the display, and the tiles define a closed shape, and the closed shape encloses the display. Moreover, in some embodiments, the display is configured to receive power from a first power source, and the at least one of the tiles is configured to receive power from a second power source, and the first power source and the second power source are one power source.

In some embodiments, the system further includes a speaker, where the sound bar frame encloses the speaker, the tiles define a closed shape, and the closed shape encloses the speaker. In some embodiments, the speaker is configured to receive power from a first power source, where the at least one of the tiles is configured to receive power from a second power source. The first power source and the second power source are one power source.

In some embodiments, the system further includes a speaker, and the speaker enclosure encloses the speaker, and the tiles define a closed shape, and the closed shaped encloses the speaker. Moreover, in some embodiments, the speaker is configured to receive power from a first power source, and the at least one of the tiles is configured to receive power from a second power source, and the first power source and the second power source are one power source.

In some embodiments, the system further includes a controller coupled to the RFIC in the at least one of the tiles, where the controller is positioned off the tiles.

In some embodiments, the tiles are in contact with each other. In addition, in some embodiments, the tiles are coupled to each other. Alternatively, in some embodiments, the tiles avoid contact with each other.

In some embodiments, the tiles define a row. Alternatively or in addition, in some embodiments, the tiles define a column.

In some embodiments, the tiles are powered serially. In some embodiments, the tiles are powered in parallel.

In some embodiments, tiles identify a path via which the pocket of energy is defined.

In some embodiments, the tiles are part of an antenna array.

In some embodiments, the tiles define the pocket of energy.

In some embodiments, the at least one of the tiles includes a controller coupled to the RFIC, and the controller is configured to control the RFIC.

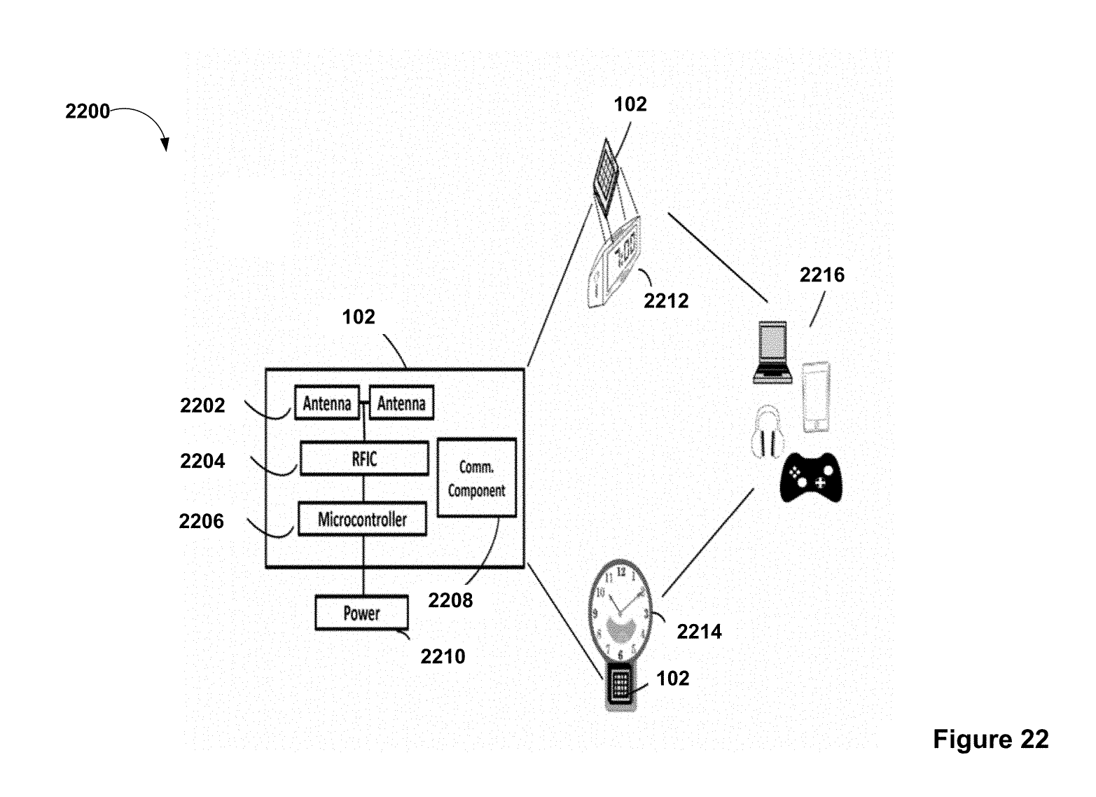

FIG. 22 illustrates a transmitter integrated with a timing device. In some embodiments, a timing device capable of wireless power transmission includes a housing comprising: a transmitter 102 configured to generate a plurality of wireless power transmission waves, the transmitter 102 comprising: a plurality of antennas 2202 (e.g., an embodiment of antennas 110, FIG. 1) configured to transmit the wireless power transmission waves in response to a communication signal indicating a power requirement of an electronic device; a digital signal processor 2204 configured to control the plurality of wireless power transmission waves in order to form a pocket of energy in a plurality of predetermined regions in a space; and a communication component 2208 configured to communicate with a receiver (e.g., receiver 120, FIG. 1) coupled to the electronic device; a time display 2212 on a surface of the housing; and a power source 2210 coupled to the transmitter 102 and the time display 2212. The time display 2212 can be from a digital clock, or an analog clock 2214, or couple to a transmission of time from a component associated with the transmitter 102.

In some embodiments, a method for wireless transmission of power to an electronic device from a timing device includes establishing, by a transmitter associated with the timing device, a connection with a power source, the timing device being configured to house the transmitter and a time display; receiving, by the timing device, a reference time obtained from an atomic clock; presenting, by the timing device, the reference time on a time display of the timing device; providing, by the timing device, the reference time to a processor of the transmitter; generating, by the transmitter associated with the timing device, a plurality of wireless power transmission waves to form a pocket of energy; receiving, by the transmitter associated with the timing device, a transmission of a power requirement and location of an electronic device through a receiver associated with the electronic device; and transmitting, by the transmitter associated with the timing device, the plurality of wireless power transmission waves using a plurality of antennas in order to form a pocket of energy in a plurality of predetermined regions at the receiver in response to the received transmission.

FIG. 22 illustrates examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIG. 22.

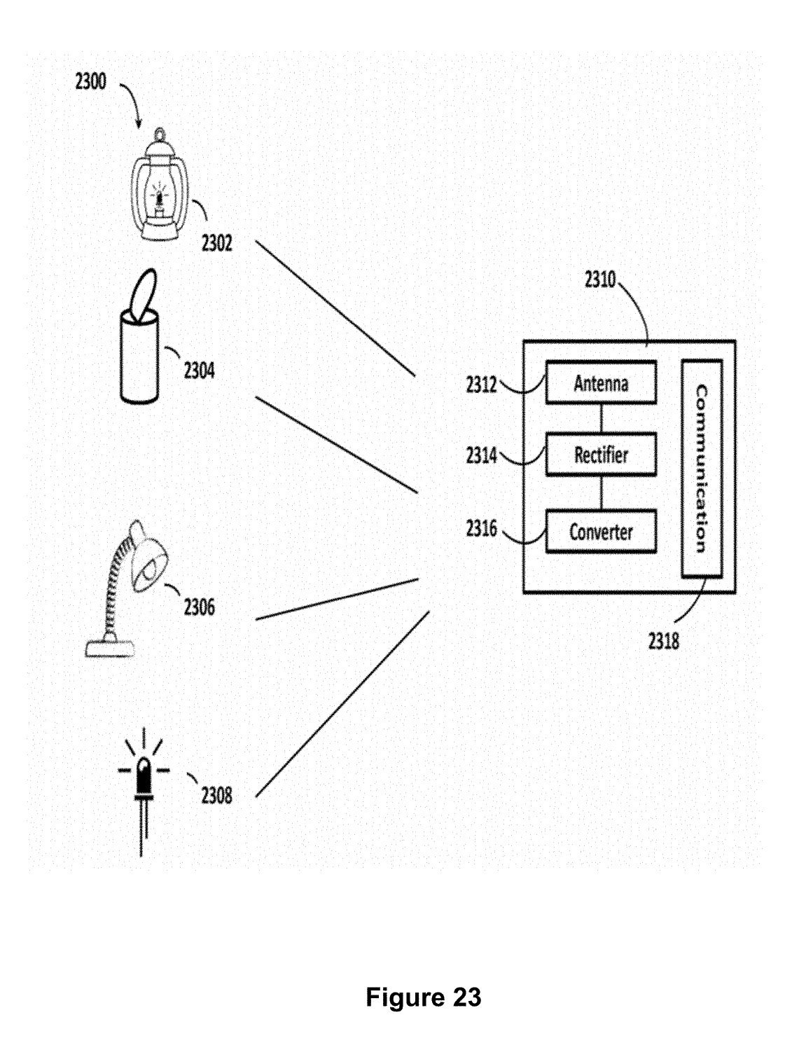

FIG. 23 illustrates an example embodiment of lighting devices, such as a lantern 2302, a flameless candle 2304, a desk lamp 2306, or a LED lighting device 2308, coupled to a receiver (e.g., an embodiment of the receiver 120, FIG. 1), where the receiver 2302 may be used for receiving wireless power transmission from a transmitter (e.g., an embodiment of the transmitter 102, FIG. 1). Each lighting device may include a light generating component (e.g., LED bulb, halogen bulb, or other bulb, diode, or capacitor) coupled to a battery or other power source. Receiver 2310 may be embedded in these devices or otherwise coupled to the lighting devices. In some implementations, the receiver 2310 may include one or more antenna elements 2312. The number, spacing and type of antenna elements 2312 may be calculated according to the design, size and/or type of external battery. The receiver 2310 also includes other components such as a rectifier 2314, an electric current converter 2316, and a communications component 2318 that includes a communication circuit associated with a communication antenna. In some implementations, terminating the transmission of power from the transmitter will result in turning off all the lighting devices that were powered by the wireless power from the transmitter. In some implementations, the receipt of power at the receiver may be terminated. In some implementations, a string of lighting devices may be connected through a single receiver system.

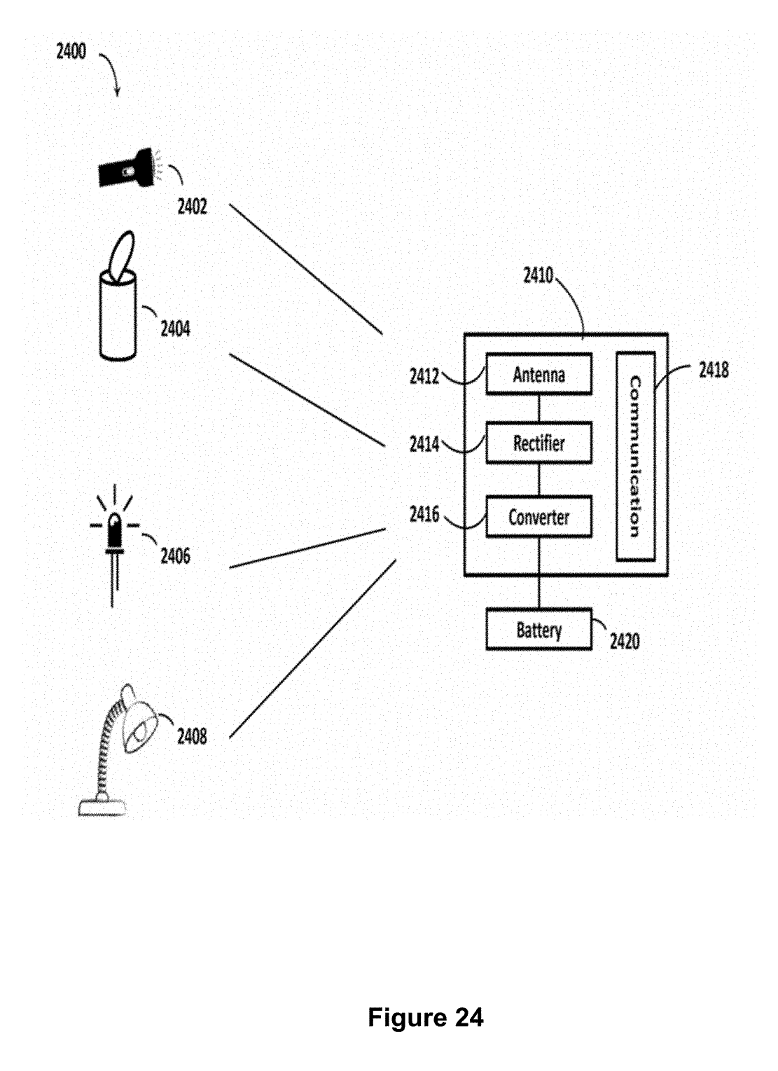

FIG. 24 illustrates an example embodiment of lighting devices, such as a flashlight 2402, a flameless candle 2404, a LED lighting device 2406, or a desk lamp 2408, coupled to a receiver 2410 (e.g., an embodiment of the receiver 120, FIG. 1), where the receiver 2410 may be used for receiving wireless power transmission from a transmitter (e.g., an embodiment of the transmitter 102, FIG. 1). Receiver 2410 may be coupled to a battery 2420 that is associated with the lighting devices, either as an embedded or built-in battery or an external one. In some implementations, the receiver 2410 may include one or more antenna elements 2412. The number, spacing and type of antenna elements 2412 may be calculated according to the design, size and/or type of external battery. The receiver 2410 also includes other components such as a rectifier 2414, an electric current converter 2416, and a communications component 2418 including a communication circuit associated with a communication antenna.

FIGS. 23 and 24 illustrate examples of or relate to the wireless power transmission environment 100 described above with reference to FIG. 1. For the sake of brevity, certain details related to techniques for wirelessly delivering power described above in reference to FIG. 1 are not repeated here, as one of skill in the art will appreciate that these techniques apply to the embodiments of FIGS. 23 and 24

Presented below are example devices for and methods of wirelessly delivering power to receivers using transmitters in various lighting devices.

In some embodiments, a lighting device with a wireless power transmission receiver includes a receiver coupled to the lighting device, the receiver comprising: (i) an antenna element configured to receive one or more power transmission waves converging to form a pocket of energy and generate an electrical current by harvesting energy from the one or more power transmission waves, and the electrical current is in an alternating current form of electricity; (ii) a rectifier coupled to the antenna element and configured to rectify the alternating current form of electricity into a direct current form of electricity; and (iii) a power converter coupled to the rectifier and configured to generate a constant voltage output of electrical current in the form of direct current, and the power converter is communicatively coupled to the lighting device, and and the receiver provides the direct current to the lighting device.

In some embodiments, the receiver is integrated into the lighting device.

In some embodiments, the lighting device is portable.

In some embodiments, the lighting device is selected from the group consisting of: a lantern, a lamp, a flameless candle, and a LED device.

In some embodiments, the receiver further includes one or more communications components configured to transmit a communication signal to a transmitter, and the communication signal identifies the receiver to the transmitter and indicates the location of the receiver relative to the transmitter.

In some embodiments, the lighting device further includes a battery coupled to the lighting device. Furthermore, in some embodiments, the battery is configured to function as a sole source of power for the lighting device. Alternatively, in some embodiments, the battery is configured to be a back-up source of power for the lightening device. In some embodiments, the battery is removably coupled to the lighting device. The battery may be integrated into the lighting device.

In some embodiments, an example method of providing wireless power to a lighting device includes interfacing, by an antenna element of a receiver associated with a lighting device, with a pocket of energy defined via a plurality of wireless power transmission waves; producing, by the antenna element of the receiver, electrical energy having an alternating current form based on the pocket of energy; and rectifying, by a rectifier of the receiver, the alternating current form of electricity into a direct current form of electricity, and the rectifier is coupled to the antenna element. The method further includes converting, by a power converter of the receiver, the direct current form of electricity to a constant voltage output of electrical current, and the power converter is coupled to the rectifier; and providing, by the power converter of the receiver, the electrical energy to power the lighting device.

Features of the present invention can be implemented in, using, or with the assistance of a computer program product, such as a storage medium (media) or computer readable storage medium (media) having instructions stored thereon/in which can be used to program a processing system to perform any of the features presented herein. The storage medium (e.g., memory 106) can include, but is not limited to, high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 106 optionally includes one or more storage devices remotely located from the CPU(s) 104. Memory 106, or alternatively the non-volatile memory device(s) within memory 106, includes a non-transitory computer readable storage medium.

Stored on any one of the machine readable medium (media), features of the present invention can be incorporated in software and/or firmware for controlling the hardware of a processing system (such as the components associated with the transmitters 102 and/or receivers 120), and for enabling a processing system to interact with other mechanisms utilizing the results of the present invention. Such software or firmware may include, but is not limited to, application code, device drivers, operating systems, and execution environments/containers.

Communication systems as referred to herein (e.g., communications component 112, FIG. 1) optionally communicate via wired and/or wireless communication connections. Communication systems optionally communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. Wireless communication connections optionally use any of a plurality of communications standards, protocols and technologies, including but not limited to radio-frequency (RF), radio-frequency identification (RFID), infrared, radar, sound, Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), ZIGBEE, wideband code division multiple access (W-CDMA), code division multiple access (CDMA), time division multiple access (TDMA), BLUETOOTH, Wireless Fidelity (WI-FI) (e.g., IEEE 102.11a, IEEE 102.11ac, IEEE 102.11ax, IEEE 102.11b, IEEE 102.11g and/or IEEE 102.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of wirelessly transmitting power, comprising:
receiving, by a communications radio of a wireless power transmitter, a communication signal from a communications radio of a wireless power receiver, the communication signal including data used to determine a location of the wireless power receiver;
determining, by a processor of the wireless power transmitter, a location of the wireless power receiver based, at least in part, on the data included in the communication signal; and
in response to determining that the location of the wireless power receiver is within a wireless power transmission range of the transmitter:
transmitting, by antennas of the wireless power transmitter, radio frequency (RF) power transmission waves towards the wireless power receiver, the RF power transmission waves converging to form controlled constructive interference patterns and destructive interference patterns in proximity to the location of the wireless power receiver, wherein the destructive interference patterns form a null space that surrounds the controlled constructive interference patterns and the controlled constructive interference patterns are received by an antenna of the wireless power receiver.

2. The method of claim 1, wherein:
the wireless power transmitter is coupled to a power source of a vehicle;
electrical current from the power source is used by the transmitter to generate the RF power transmission waves; and
the wireless power receiver is located inside a passenger compartment of the vehicle.

3. The method of claim 1, wherein:
the wireless power transmitter is disposed within a toolbox; and
the wireless power receiver is coupled to a cordless power tool.

4. The method of claim 1, wherein the wireless power transmitter is connected to a power source and a telescoping mast of a mobile vehicle, the telescoping mast extending in a vertical direction above the mobile vehicle.

5. The method of claim 1, wherein:
the wireless power transmitter is coupled to a wind turbine; and
electrical current from the wind turbine is used by the transmitter to generate the RF power transmission waves.

6. The method of claim 1, wherein:
the wireless power transmitter is coupled to a gaming counsel; and
the wireless power receiver is coupled to a game controller.

7. A wireless power transmitter comprising:
a communications radio;
antennas;
one or more processors;
memory; and
one or more programs stored in the memory and configured for execution by the one or more processors, the one or more programs comprising instructions for:
receiving, by the communications radio, a communication signal from a communications radio of a wireless power receiver, the communication signal including data used to determine a location of the wireless power receiver;
determining, by the one or more processors of the wireless power transmitter, a location of the wireless power receiver based, at least in part, on the data included in the communication signal; and
in response to determining that the location of the wireless power receiver is within a wireless power transmission range defined by the transmitter:
transmitting, by the antennas, radio frequency (RF) power transmission waves towards the wireless power receiver, the RF power transmission waves converging to form controlled constructive interference patterns and destructive interference patterns in proximity to the location of the wireless power receiver, wherein the destructive interference patterns form a null space that surrounds the controlled constructive interference patterns and the controlled constructive interference patterns are received by an antenna of the wireless power receiver.

8. A non-transitory computer-readable storage medium, storing one or more programs configured for execution by one or more processors of a wireless power transmitter, the one or more programs including instructions, which when executed by the one or more processors cause the wireless power transmitter to:
receive, by a communications radio of the wireless power transmitter, a communication signal from a communications radio of a wireless power receiver, the communication signal including data used to determine a location of the wireless power receiver;
determine, by a processor of the wireless power transmitter, a location of the wireless power receiver based, at least in part, on the data included in the communication signal; and
in response to determining that the location of the wireless power receiver is within a wireless power transmission range defined by the transmitter:
transmit, by antennas of the wireless power transmitter, radio frequency (RF) power transmission waves towards the wireless power receiver, the RF power transmission waves converging to form controlled constructive interference patterns and destructive interference patterns in proximity to the location of the wireless power receiver, wherein the destructive interference patterns form a null space that surrounds the controlled constructive interference patterns and the controlled constructive interference patterns are received by an antenna of the wireless power receiver.
